(19) United States
(12) Patent Application Publication
(10) Pub. No.: US 2025/0344761 A1
(43) Pub. Date: Nov. 13, 2025

(54) REFILLING DEVICE AND METHOD

(71) Applicant: NICOVENTURES TRADING LIMITED, London (GB)

(72) Inventors: Howard ROTHWELL, London (GB); David PHASEY, London (GB); Gemma POLLOCK, London (GB); Tom FRENCH, London (GB); Rod MITCHELL, London (GB); Joseph Peter SUTTON, London (GB)

(21) Appl. No.: 18/688,997

(22) PCT Filed: Aug. 30, 2022
(86) PCT No.: PCT/GB2022/052212

§ 371 Date: Mar. 4, 2024

(30) Foreign Application Priority Data
Sep. 3, 2021 (GB) 2112585.1
Sep. 3, 2021 (GB) 2112588.5
Sep. 3, 2021 (GB) 2112590.1
Nov. 10, 2021 (GB) 2116140.1

(51) Int. Cl. A24F 15/015; B65B 3/04; B65B 43/54

(52) U.S. Cl. CPC A24F 15/015; B65B 3/04; B65B 43/54

(57) ABSTRACT

A refilling device for refilling an article from a reservoir includes an article interface configured to receive the article, a reservoir interface configured to receive the reservoir, a plunger configured, in use, to engage with the reservoir, and a motor configured to drive a cam mechanism coupled to each of the article interface, the reservoir interface and the plunger such that, in use, the article, the reservoir and the plunger move in a coordinated manner such that aerosol-generating material is transferred from the reservoir to the article.

### RELATED APPLICATIONS

The present application is a National Phase entry of PCT Application PCT/GB2022/052212 filed Aug. 30, 2022, which claims priority to GB Application No. 2112588.5 filed Sep. 3, 2021, GB Application No. 2112590.1 filed Sep. 3, 2021, GB Application No. 2112585.1 filed Sep. 3, 2021 and GB Application No. 2116140.1 filed Nov. 10, 2021, each of which is hereby incorporated by reference in their entirety.

### TECHNICAL FIELD

The present invention relates to a refilling device for an article of an aerosol provision system and a method of refilling an article of an aerosol provision system. The present invention also relates to a refilling device for electronic aerosol provision systems, the refilling device having an article interface. The present disclosure also relates to apparatus for liquid sensing in refillable articles for electronic aerosol provision systems

### BACKGROUND

Electronic aerosol provision systems such as electronic cigarettes (e-cigarettes) generally contain an aerosol-generating material, such as a reservoir of a source liquid containing a formulation, typically including nicotine, or a solid material such as a tobacco-based product, from which an aerosol is generated for inhalation by a user, for example through heat vaporization. Thus, an aerosol provision system will typically comprise an aerosol generator, e.g. a heating element, arranged to aerosolize a portion of aerosol-generating material to generate an aerosol in an aerosol generation region of an air channel through the aerosol provision system. As a user inhales on the device and electrical power is supplied to the aerosol generator, air is drawn into the device through one or more inlet holes and along the air channel to the aerosol generation region, where the air mixes with the vaporized aerosol generator and forms a condensation aerosol. The air drawn through the aerosol generation region continues along the air channel to a mouthpiece, carrying some of the aerosol with it, and out through the mouthpiece for inhalation by the user.

It is common for aerosol provision systems to comprise a modular assembly, often having two main functional parts, namely an aerosol provision device and an article. Typically the article will comprise the consumable aerosol-generating material and the aerosol generator (heating element), while the aerosol provision device part will comprise longer-life items, such as a rechargeable battery, device control circuitry and user interface features. The aerosol provision device may also be referred to as a reusable part or battery section and the article may also be referred to as a consumable, disposable/replaceable part, cartridge or cartomiser.

The aerosol provision device and article are mechanically coupled together at an interface for use, for example using a screw thread, bayonet, latched or friction fit fixing. When the aerosol-generating material in an article has been exhausted, or the user wishes to switch to a different article having a different aerosol-generating material, the article may be removed from the aerosol provision device and a replacement article may be attached to the device in its place. Alternatively, some articles are configured such that, after the aerosol-generating material in the article has been exhausted, the article can be refilled with more aerosol-generating material, thereby allowing the article to be reused. In this example, the user is able to refill the article using a separate reservoir of aerosol-generating material. The aerosol-generating material used to refill the article may be the same or different to the previous aerosol-generating material in the article, thereby allowing the user to change to a different aerosol-generating material without purchasing a new article.

Refilling the article with aerosol-generating material extends the life of the article as its use is no longer limited by the volume or amount of aerosol-generating material that the article can hold. As a result, the use of the article may be limited by other factors, such as the life of individual components within the article. Continuous use of the article may therefore result in degradation or fault developing in components within the article. The article may therefore become less reliable, the operation of the article less predictable or the article may stop working entirely, each of which has a negative impact on the user experience.

Electronic aerosol provision systems, which are often configured as so-called electronic cigarettes, can have a unitary format with all elements of the system in a common housing, or a multi-component format in which elements are distributed between two or more housings which can be coupled together to form the system. A common example of the latter format is a two-component system comprising a device and an article. The device typically contains an electrical power source for the system, such as a battery, and control electronics for operating elements in order to generate aerosol. The article, also referred to by terms including cartridge, cartomiser, consumable and clearomiser, typically contains a storage volume or area for holding a supply of aerosolizable material from which the aerosol is generated, plus an aerosol generator such as a heater operable to vaporize the aerosolizable material. A similar three-component system may include a separate mouthpiece that attaches to the article. In many designs, the article is designed to be disposable, in that it is intended to be detached from the device and thrown away when the aerosolizable material has been consumed. The user obtains a new article which has been prefilled with aerosolizable material by a manufacturer and attaches it to the device for use. The device, in contrast, is intended to be used with multiple consecutive articles, with a capability to recharge the battery to allow prolonged operation.

While disposable articles, which may be called consumables, are convenient for the user, they may be considered wasteful of natural resources and hence detrimental to the environment. An alternative design of article is therefore known which is configured to be refilled with aerosolizable material by the user. This reduces waste, and can reduce the cost of electronic cigarette usage for the user. The aerosolizable material may be provided in a bottle, for example, from which the user squeezes or drips a quantity of material into the article via a refilling orifice on the article. However, the act of refilling can be awkward and inconvenient, since the items are small and the volume of material involved is typically low. Alignment of the juncture between bottle and article can be difficult, with inaccuracies leading to spillage of the material. This is not only wasteful, but may also be dangerous. Aerosolizable material frequently contains liquid nicotine, which can be poisonous if it makes contact with the skin.

Therefore, refilling units or devices have been proposed, which are configured to receive a bottle or other reservoir of aerosolizable material plus a refillable cartridge, and to automate the transfer of the material from the former to the latter. Alternative, improved or enhanced features and designs for such refilling devices are therefore of interest.

Various approaches are described herein which seek to help address or mitigate some of the issues discussed above.

### SUMMARY

The disclosure is defined in the appended claims.

In accordance with some embodiments described herein, there is provided a refilling device for refilling an article from a reservoir. The refilling device comprises an article interface configured to receive the article, a reservoir interface configured to receive the reservoir, a plunger configured, in use, to engage with the reservoir, and a motor configured to drive a cam mechanism coupled to each of the article interface, the reservoir interface and the plunger such that, in use, the article, the reservoir and the plunger move in a coordinated manner such that aerosol-generating material is transferred from the reservoir to the article.

The refilling device can also comprise a nozzle block between the article interface and the reservoir interface. The coordinated manner can comprise (1) the article interface moving towards the nozzle block, (2) the reservoir interface moving towards the nozzle block, and (3) the plunger engaging and pushing on a surface of the reservoir. Step (1) can happen before step (2) and step (2) can happen before step (3).

The nozzle block can be integrated with one of the article interface or the reservoir interface. The nozzle block can comprise a syringe configured to facilitate the transfer of aerosol-generating material from the reservoir to the article via the nozzle block. The cam mechanism can be configured to move the plunger in a reciprocating motion comprising a first direction and a second direction opposite the first direction, wherein the plunger moves in the first direction towards the nozzle block to cause aerosol-generating material to be transferred from the reservoir to the syringe, and the plunger moves in the second direction away from the nozzle block to cause aerosol-generating material to be transferred from the syringe to the article. The nozzle block can also comprise a three-way check value to control the transfer of aerosol-generating material into and out of the syringe.

The cam mechanism can comprise a cam plate. The motor can be connected to the cam plate by a lead screw. The plunger can be fixed to the cam plate such at that the plunger moves with the cam plate. The reservoir interface and article interface can be respectively coupled to the cam plate by pins and linkages. The cam plate and the pins can be configured such that the cam plate can move whilst the reservoir interface and article interface are both stationary. The cam plate and the pins and linkages can be configured such that the cam plate can move whilst the reservoir interface and article interface are both stationary.

The plunger can be integrated with the reservoir interface.

The refilling device can further comprise refilling control circuitry configured to control the motor. The refilling control circuitry can be configured to control the motor in response to detecting the article has been received by the article interface and detecting the reservoir has been received by the reservoir interface. The refilling control circuitry can be configured to alter a speed of the motor based on the position of the plunger.

In accordance with some embodiments described herein, there is provided a method of refilling an article of an aerosol provision system. The method comprises receiving the article, receiving a reservoir, and controlling a motor configured to drive a cam mechanism to move the article, the reservoir and a plunger in a coordinated manner such that aerosol-generating material is transferred from the reservoir to the article.

There is also provided a computer readable storage medium comprising instructions which, when executed by a processor, performs the above method.

In accordance with some embodiments described herein, there is provided a refilling device for refilling an article of an aerosol provision system comprises an article interface configured to receive the article, a reservoir interface configured to receive the reservoir and a nozzle block located between the article interface and the reservoir interface. The nozzle block comprises a filling nozzle configured to facilitate the transfer of aerosol-generating material from the reservoir to the article, and a venting nozzle configured to facilitate the transfer of air from the article as aerosol-generating material is transferred from the reservoir to the article. The nozzle block is configured such that, in use, the filling nozzle engages with the article in response to the reservoir engaging with the nozzle block.

The nozzle block may be configured to be removable from the refilling device. The refilling device may comprise a nozzle block interface configured to receive the nozzle block.

To facilitate the transfer of aerosol-generating material from the reservoir to the article, the filling nozzle can be configured to engage with a filling valve on the article. The filling nozzle can be configured to engage with the filling by pushing into the filling valve, and piecing the filling valve.

A first end of the filling nozzle can be configured to engage with the article, and a second end of the filling nozzle opposite the first end configured to engage with the reservoir.

The venting nozzle can be configured to engage with the article in response to the reservoir engaging with the nozzle block. The venting nozzle can be configured to engage with a venting valve on the article.

A first end of the venting nozzle can be configured to engage with the article, and a second end of the venting nozzle opposite the first end can be open.

The nozzle block can also comprise a housing configured to at least partially contain the filling nozzle and the venting nozzle. The housing can comprise a flange configured to extend beyond a first end of the filling nozzle and a first end of the venting nozzle such that first end of the filling nozzle and the first end of the venting nozzle are located inside the housing. The housing can also comprise a second flange configured to extend beyond a second end of the filling nozzle and a second end of the venting nozzle such that second end of the filling nozzle and the second end of the venting nozzle are located inside the housing.

The nozzle block can also comprise a moveable component configured to interact with the housing to expose at least a portion of the filling nozzle and at least a portion of the venting nozzle. The nozzle block can also comprise a biasing element configured to bias the movable component such that the portion of the filling nozzle and the portion of the venting nozzle are enclosed by the moveable component. The nozzle block can comprise an interlock configured to prevent the moveable component being moved when the nozzle block is separate from the refilling device. The refilling device can also comprise a pin configured to engage with interlock to allow the moveable component to move.

The venting nozzle can be configured to engage with the article before the filling nozzle engages with the article.

The filling nozzle has a larger cross-sectional area than the venting nozzle. The filling nozzle can be longer than the venting nozzle. The filling nozzle and the venting nozzle can be concentric.

In accordance with some embodiments described herein, there is provided a method of refilling an article of an aerosol provision system. The method comprises receiving the article, receiving a reservoir, engaging a filling nozzle of a nozzle block with the article in response to the reservoir engaging with the nozzle block, facilitating the transfer of aerosol-generating material from the reservoir to the article using the filling nozzle, and facilitating the transfer of air from the article using a venting nozzle of the nozzle block as aerosol-generating material is transferred from the reservoir to the article.

There is also provided a computer readable storage medium comprising instructions which, when executed by a processor, performs the above method.

According to an aspect of some embodiments described herein, there is provided a refilling device for refilling an article from a reservoir, the refilling device configured to perform a refilling action for moving fluid along a fluid conduit from the reservoir to a storage area in the article, and comprising: an article interface for receiving an article of an aerosol provision system for coupling with the fluid conduit, the article having a storage area for fluid; and a retainer configured to engage with an article received in the article interface to retain the article in the article interface during at least part of the refilling action.

According to a further aspect of some embodiments described herein, there is provided a refilling device for refilling an article from a reservoir, comprising: an article interface for receiving an article of an aerosol provision system, the article having a storage area for fluid; and a capacitive sensor configured to measure a capacitance of at least part of the article when the article is received in the article interface; wherein the capacitive sensor comprises at least one capacitor plate comprising an elastically compressible element and a flexible conductive layer on a surface of the elastically compressible element.

According to a further aspect of some embodiments described herein, there is provided a refilling device for refilling an article from a reservoir, comprising: an article interface for receiving an article of an aerosol provision system, the article having a storage area for fluid; and a capacitive sensor configured to measure a capacitance of at least part of the article when the article is received in the article interface; wherein the capacitive sensor comprises at least one deformable capacitor plate associated with the article interface in order that the deformable capacitor plate is deformed by the article received in the article interface such that the deformable capacitor plate conforms to a shape of the outer surface of the article.

These and further aspects of the certain embodiments are set out in the appended independent and dependent claims. It will be appreciated that features of the dependent claims may be combined with each other and features of the independent claims in combinations other than those explicitly set out in the claims. Furthermore, the approach described herein is not restricted to specific embodiments such as set out below, but includes and contemplates any appropriate combinations of features presented herein. For example, a refilling device for electronic aerosol provision systems may be provided in accordance with approaches described herein which includes any one or more of the various features described below as appropriate. For example, apparatus and methods for liquid sensing in refillable articles for electronic aerosol provision systems may be provided in accordance with approaches described herein which includes any one or more of the various features described below as appropriate.

These aspects and other aspects will be apparent from the following detailed description. In this regard, particular sections of the description are not to be read in isolation from other sections.

### BRIEF DESCRIPTION OF DRAWINGS

Embodiments of the invention will now be described, by way of example only, with reference to accompanying drawings, in which:

FIG. 1 is a schematic diagram of an aerosol provision system;

FIG. 2 is a schematic diagram of an example article for use in the aerosol provision system illustrated in FIG. 1;

FIG. 3 is a schematic diagram of an example refilling device and a reservoir for refilling the article illustrated in FIG. 2;

FIG. 4 is a schematic diagram of a further example refilling device for refilling the article illustrated in FIG. 2;

FIGS. 5A to 5C are schematic diagrams of the refilling device illustrated in FIG. 4;

FIG. 6 is a further schematic diagram of the refilling device illustrated in FIG. 4;

FIG. 7 is a schematic diagram of the cam plate illustrated in FIG. 6;

FIG. 8 is a flow chart of a method of refilling an article;

FIGS. 9A to 9D are schematic diagrams of nozzle blocks of the refilling device illustrated in FIG. 4;

FIG. 10 is a flow chart of a method of refilling an article;

FIG. 11 shows a simplified schematic cross-section through an example electronic aerosol provision system to which embodiments of the present disclosure are applicable;

FIG. 12 shows a simplified schematic representation of a refilling device in which embodiments of the present disclosure can be implemented;

FIG. 13 shows a simplified schematic cross-sectional view of parts in an example refilling device including a reservoir and an article refillable from the reservoir;

FIG. 14 shows a simplified cross-sectional view of the parts of the example of FIG. 13, coupled together to form a fluid flow path for refilling;

FIG. 15 shows a simplified cross-sectional view of a first example article interface of a refilling device according to embodiments of the present disclosure;

FIG. 16 shows a perspective view of a second example article interface of a refilling device according to embodiments of the present disclosure;

FIG. 17 shows a simplified cross-sectional side view of a third example article interface of a refilling device according to embodiments of the present disclosure;

FIG. 17A shows a simplified cross-sectional view of a modification to the FIG. 17 example article interface, according to embodiments of the present disclosure;

FIG. 18 shows a simplified cross-sectional side view of a fourth example article interface of a refilling device according to embodiments of the present disclosure;

FIG. 19 shows a simplified cross-sectional side view of a fifth example article interface of a refilling device according to embodiments of the present disclosure;

FIG. 20 shows a simplified cross-sectional front view of a sixth example article interface of a refilling device according to embodiments of the present disclosure;

FIG. 21 shows a simplified cross-sectional view of a seventh example article interface of a refilling device according to embodiments of the present disclosure; and

FIG. 22 shows a simplified cross-sectional view of an eighth example article interface of a refilling device according to embodiments of the present disclosure; and

FIG. 23 shows a simplified cross-sectional view of a ninth example article interface of a refilling device according to embodiments of the present disclosure.

FIG. 24 shows a simplified schematic cross-section through an example electronic aerosol provision system in which embodiments of the present disclosure can be implemented;

FIG. 25 shows a simplified schematic representation of a refilling device to which embodiments of the present disclosure area applicable;

FIG. 26 shows a schematic side view of an example capacitor plate of an embodiment of the present disclosure, in an uncompressed state;

FIG. 27 shows a schematic side view of the capacitor plate of FIG. 26 in a compressed state;

FIG. 28A shows a schematic plan view of a further example capacitor plate of an embodiment of the present disclosure;

FIG. 28B shows a schematic top view of an alternative example of the capacitor plate of FIG. 28A;

FIG. 28C shows a schematic top view of a further alternative example of the capacitor plate of FIG. 28A;

FIG. 29 shows a schematic plan view of a still further example capacitor plate of an embodiment of the present disclosure;

FIG. 30 shows an exploded perspective view of a yet further example capacitor plate of an embodiment of the present disclosure; and

FIGS. 31 to 34 shows simplified schematic views of various example capacitive sensors in refilling devices according to embodiments of the present disclosure.

### DETAILED DESCRIPTION

Aspects and features of certain examples and embodiments are discussed/described herein. Some aspects and features of certain examples and embodiments may be implemented conventionally and these are not discussed/described in detail in the interests of brevity. It will thus be appreciated that aspects and features of articles and systems discussed herein which are not described in detail may be implemented in accordance with any conventional techniques for implementing such aspects and features.

The present disclosure relates to aerosol provision systems, which may also be referred to as aerosol provision systems, such as e-cigarettes. Throughout the following description the term “e-cigarette” or “electronic cigarette” may sometimes be used, but it will be appreciated this term may be used interchangeably with aerosol provision system and electronic aerosol provision system. The systems are intended to generate an inhalable aerosol by vaporization of a substrate (aerosol-generating material) in the form of a liquid or gel which may or may not contain nicotine. Additionally, hybrid systems may comprise a liquid or gel substrate plus a solid substrate which is also heated. The solid substrate may be for example tobacco or other non-tobacco products, which may or may not contain nicotine. The terms “aerosol-generating material” and “aerosolizable material” as used herein are intended to refer to materials which can form an aerosol, either through the application of heat or some other means. The term “aerosol” may be used interchangeably with “vapor”.

As noted above, aerosol provision systems (e-cigarettes) often comprise a modular assembly including both a reusable part (aerosol provision device) and a replaceable (disposable) or refillable cartridge part, referred to as an article. Systems conforming to this type of two-part modular configuration may generally be referred to as two-part systems or devices. It is also common for electronic cigarettes to have a generally elongate shape. For the sake of providing a concrete example, certain embodiments of the disclosure described herein comprise this kind of generally elongate two-part system employing refillable cartridges. However, it will be appreciated the underlying principles described herein may equally be adopted for other electronic cigarette configurations, for example modular systems comprising more than two parts, as devices conforming to other overall shapes, for example based on so-called box-mod high performance devices that typically have a more boxy shape.

As used herein, the terms “system” and “delivery system” are intended to encompass systems that deliver a substance to a user, and include non-combustible aerosol provision systems that release compounds from an aerosolizable material without combusting the aerosolizable material, such as electronic cigarettes, tobacco heating products, and hybrid systems to generate aerosol using a combination of aerosolizable materials, and articles comprising aerosolizable material and configured to be used within one of these non-combustible aerosol provision systems. According to the present disclosure, a “non-combustible” aerosol provision system is one where a constituent aerosol generating material of the aerosol provision system (or component thereof) is not combusted or burned in order to facilitate delivery to a user. In some embodiments, the delivery system is a non-combustible aerosol provision system, such as a powered non-combustible aerosol provision system. In some embodiments, the non-combustible aerosol provision system is an electronic cigarette, also known as a vaping device or electronic nicotine delivery (END) system, although it is noted that the presence of nicotine in the aerosol generating material is not a requirement. In some embodiments, the non-combustible aerosol provision system is a hybrid system to generate aerosol using a combination of aerosolizable materials, one or a plurality of which may be heated. Each of the aerosolizable materials may be, for example, in the form of a solid, liquid or gel and may or may not contain nicotine. In some embodiments, the hybrid system comprises a liquid or gel aerosol generating material and a solid aerosol generating material. The solid aerosol generating material may comprise, for example, tobacco or a non-tobacco product.

Typically, the non-combustible aerosol provision system may comprise a non-combustible aerosol provision device and an article (consumable) for use with the non-combustible aerosol provision device. However, it is envisaged that articles which themselves comprise a means for powering an aerosol generator or aerosol generating component may themselves form the non-combustible aerosol provision system. In some embodiments, the non-combustible aerosol provision device may comprise a power source and a controller. The power source may, for example, be an electric power source. In some embodiments, the article for use with the non-combustible aerosol provision device may comprise an aerosol generating material, an aerosol generating component (aerosol generator), an aerosol generating area, a mouthpiece, and/or an area for receiving and holding aerosol generating material.

In some systems the aerosol generating component or aerosol generator comprises a heater capable of interacting with the aerosolizable material so as to release one or more volatiles from the aerosolizable material to form an aerosol. However, the disclosure is not limited in this regard, and applies also to systems that use other approaches to form aerosol, such as a vibrating mesh.

In some embodiments, the article for use with the non-combustible aerosol provision device may comprise aerosolizable material or an area for receiving aerosolizable material. In some embodiments, the article for use with the non-combustible aerosol provision device may comprise a mouthpiece. The area for receiving aerosolizable material may be a storage area for storing aerosolizable material. For example, the storage area may be a reservoir. In some embodiments, the area for receiving aerosolizable material may be separate from, or combined with, an aerosol generating area.

As used herein, the term “component” may be used to refer to a part, section, unit, module, assembly or similar of an electronic cigarette or similar device that incorporates several smaller parts or elements, possibly within an exterior housing or wall. An aerosol provision system such as an electronic cigarette may be formed or built from one or more such components, such as an article and a device, and the components may be removably or separably connectable to one another, or may be permanently joined together during manufacture to define the whole system. The present disclosure is applicable to (but not limited to) systems comprising two components separably connectable to one another and configured, for example, as an article in the form of an aerosolizable material carrying component holding liquid or another aerosolizable material (alternatively referred to as a cartridge, cartomiser, pod or consumable), and a device having a battery or other power source for providing electrical power to operate an aerosol generating component or aerosol generator for creating vapor/aerosol from the aerosolizable material. A component may include more or fewer parts than those included in the examples.

As described above, the present disclosure relates to (but it not limited to) refilling devices for articles of aerosol provision systems, such as e-cigarettes and electronic cigarettes. The present disclosure also relates to aerosol provision systems and components thereof that utilize aerosolizable material in the form of a liquid or a gel which is held in a storage area such as a reservoir, tank, container or other receptacle comprised in the system, or absorbed onto a carrier substrate. An arrangement for delivering the material from the reservoir for the purpose of providing it to an aerosol generator for vapor/aerosol generation is included. The terms “liquid”, “gel”, “fluid”, “source liquid”, “source gel”, “source fluid” and the like may be used interchangeably with terms such as “aerosol-generating material”, “aerosolizable substrate material” and “substrate material” to refer to material that has a form capable of being stored and delivered in accordance with examples of the present disclosure.

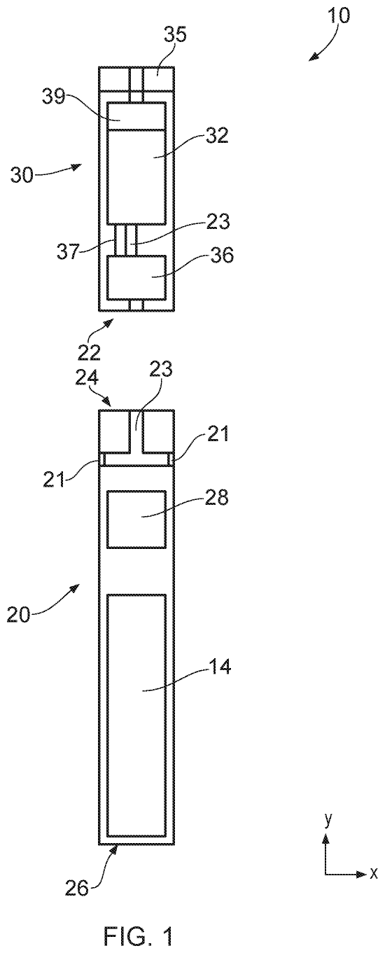

FIG. 1 is a highly schematic diagram (not to scale) of an example aerosol provision system 10, such as an e-cigarette, to which embodiments are applicable. The aerosol provision system 10 has a generally cylindrical shape, extending along a longitudinal or y axis as indicated by the axes (although aspects of the invention are applicable to e-cigarettes configured in other shapes and arrangements), and comprises two main components, namely an aerosol provision device 20 and an article 30.

The aerosol provision device 20 and article 30 each comprise an interface 22, 24 such that the aerosol provision device 20 and article 30 are mechanically coupled for use. As described above, the interfaces may comprise a screw thread, bayonet, latched or friction fit fixing, wherein the interface 24 on the aerosol provision device 20 and the interface 24 on the article 30 each comprise a complementary fitting or fixture to enable the aerosol provision device 20 and article 30.

The article 30 comprises or consists of aerosol-generating material 32, part or all of which is intended to be consumed during use by a user. An article 30 may comprise one or more other components, such as an aerosol-generating material storage area 39, an aerosol-generating material transfer component 37, an aerosol generation area, a housing, a wrapper, a mouthpiece 35, a filter and/or an aerosol-modifying agent.

An article 30 may also comprise an aerosol generator 36, such as a heating element, that emits heat to cause the aerosol-generating material 32 to generate aerosol in use. The aerosol generator 36 may, for example, comprise combustible material, a material heatable by electrical conduction, or a susceptor. It should be noted that it is possible for the aerosol generator 36 to be part of the aerosol provision device 20 and the article 30 then may comprise the aerosol-generating material storage area 39 for the aerosol-generating material 32 such that, when the article 30 is coupled with the aerosol provision device 20 via the interfaces 22, 24, the aerosol-generating material 32 can be transferred to the aerosol generator 36 in the aerosol provision device 20.

Aerosol-generating material is a material that is capable of generating aerosol, for example when heated, irradiated or energized in any other way. The aerosol-generating material 32 may, for example, be in the form of a solid, liquid or gel which may or may not contain an active substance and/or flavorants. In some embodiments, the aerosol-generating material 32 may comprise an “amorphous solid”, which may alternatively be referred to as a “monolithic solid” (i.e. non-fibrous). In some embodiments, the amorphous solid may be a dried gel. The amorphous solid is a solid material that may retain some fluid, such as liquid, within it. In some embodiments, the aerosol-generating material 32 may for example comprise from about 50 wt %, 60 wt % or 70 wt % of amorphous solid, to about 90 wt %, 95 wt % or 100 wt % of amorphous solid.

The aerosol-generating material comprises one or more ingredients, such as one or more active substances and/or flavorants, one or more aerosol-former materials, and optionally one or more other functional materials such as pH regulators, coloring agents, preservatives, binders, fillers, stabilizers, and/or antioxidants.

The active substance as used herein may be a physiologically active material, which is a material intended to achieve or enhance a physiological response. The active substance may for example be selected from nutraceuticals, nootropics, and psychoactives. The active substance may be naturally occurring or synthetically obtained. The active substance may comprise for example nicotine, caffeine, taurine, theine, vitamins such as B6 or B12 or C, melatonin, cannabinoids, or constituents, derivatives, or combinations thereof. The active substance may comprise one or more constituents, derivatives or extracts of tobacco, cannabis or another botanical.

In some embodiments, the active substance comprises nicotine. In some embodiments, the active substance comprises caffeine, melatonin or vitamin B12.

The aerosol provision device 20 includes a power source 14, such as a battery, configured to supply electrical power to the aerosol generator 36. The power source 14 in this example is rechargeable and may be of a conventional type, for example of the kind normally used in electronic cigarettes and other applications requiring provision of relatively high currents over relatively short periods. The battery 14 may be recharged through the charging port (not illustrated), which may, for example, comprise a USB connector.

The aerosol provision device 20 includes device control circuitry 28 configured to control the operation of the aerosol provision system 10 and provide conventional operating functions in line with the established techniques for controlling aerosol provision systems such as electronic cigarettes. The device control circuitry (processor circuitry) 28 may be considered to logically comprise various sub-units/circuitry elements associated with different aspects of the electronic cigarette's operation. For example, depending on the functionality provided in different implementations, the device control circuitry 28 may comprise power source control circuitry for controlling the supply of electrical power from the power source 14 to the aerosol generator 36, user programming circuitry for establishing configuration settings (e.g. user-defined power settings) in response to user input, as well as other functional units/circuitry associated functionality in accordance with the principles described herein and conventional operating aspects of electronic cigarettes. It will be appreciated the functionality of the device control circuitry 28 can be provided in various different ways, for example using one or more suitably programmed programmable computer(s) and/or one or more suitably configured application-specific integrated circuit(s)/circuitry/chip(s)/chipset(s) configured to provide the desired functionality.

The aerosol provision device 20 includes one or more air inlets 21. In use, as a user inhales on the mouthpiece 35, air is drawn into the aerosol provision device 20 through the air inlets 21 and along an air channel 23 to the aerosol generator 36, where the air mixes with the vaporized aerosol-generating material 32 and forms a condensation aerosol. The air drawn through the aerosol generator 36 continues along the air channel 23 to a mouthpiece 35, carrying some of the aerosol with it, and out through the mouthpiece 35 for inhalation by the user. Alternatively, the one or more air inlets 21 may be included on the article 30, such that the air channel 23 is entirely contained within the article 30.

By way of a concrete example, the article 30 comprises a housing (formed, e.g., from a plastics material), an aerosol-generating material storage area 39 formed within the housing for containing the aerosol-generating material 32 (which in this example may be a liquid which may or may not contain nicotine), an aerosol-generating material transfer component 37 (which in this example is a wick formed of e.g., glass or cotton fibres, or a ceramic material configured to transport the liquid from the reservoir using capillary action), an aerosol-generating area containing the aerosol generator 36, and a mouthpiece 35. Although not shown, a filter and/or aerosol modifying agent (such as a flavor imparting material) may be located in, or in proximity to, the mouthpiece 35. The aerosol generator 36 of this example comprises a heater element formed from an electrically resistive material (such as NiCr8020) spirally wrapped around the aerosol-generating material transfer component 37, and located in the air channel 23. The area around the heating element and wick combination is the aerosol-generating area of the article 30.

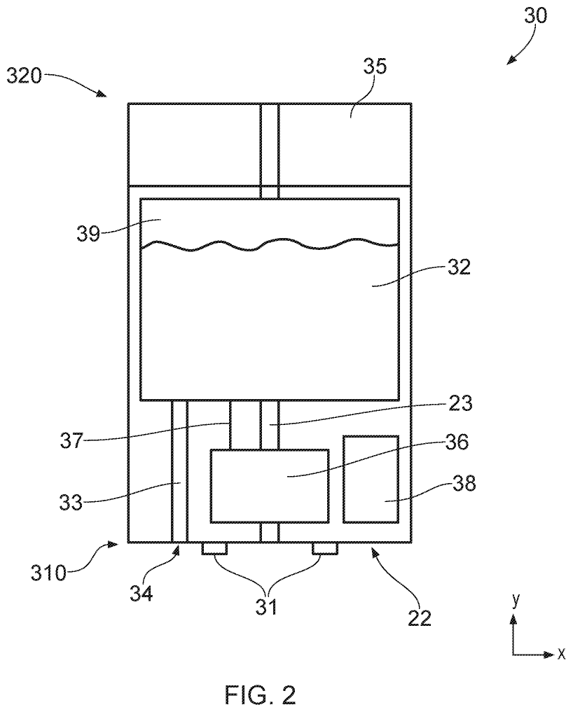

FIG. 2 is a schematic diagram of an example article 30 for use in the aerosol provision system 10 illustrated in FIG. 1, where the same reference signs have been used for like elements between the article 30 illustrated in FIG. 1 and the article 30 illustrated in FIG. 2. As per the article 30 illustrated in FIG. 1, the article 30 illustrated in FIG. 2 includes an aerosol-generating material storage area 39 for storing an aerosol-generating material 32, an aerosol-generating material transfer component 37, an aerosol generation area containing an aerosol generator 36, and a mouthpiece 35.

The article 30 illustrated in FIG. 2 is configured to be refilled and reused. In other words, the aerosol-generating material storage area 39 of the article 30 illustrated in FIG. 2 can be refilled with aerosol-generating material 32 once some or all of the aerosol-generating material 32 contained in the aerosol-generating material storage area 39 has been exhausted or depleted. To facilitate the refilling or replenishment of aerosol-generating material 32, the article 30 has a refilling tube 33 extending between the aerosol-generating material storage area 39 and the exterior or an outer surface of the housing of the article 30, thereby creating a refilling orifice 34. Aerosol-generating material 32 can then be inserted into the aerosol-generating material storage area 39 via the refilling orifice 34 and refilling tube 33. It will be appreciated, however, that such a configuration of a refilling tube 33 and a refilling orifice 34 is not essential, and the article 30 may comprise any other suitable means of facilitating the refilling of the aerosol-generating material storage area 39 with aerosol generating material 32.

The refilling orifice 34 and/or the refilling tube 33 may be sealable, for example with a cap, one-way valve or septum valve, in order to ensure that aerosol-generating material 32 does not leak out of the refilling orifice 34. In other words, the refilling orifice 34 can comprise a cap, one-way valve or septum valve. Although the refilling orifice 34 is illustrated in FIG. 2 as being on the same end or surface 310 of the article 30 as the air channel 23 and interface 22 with the aerosol provision device 20, this is not essential. The refilling orifice 34 may be located at the end 320 of the article 30 comprising the mouthpiece 35, for example proximate to the outlet of the air channel 23 on the mouthpiece 35, such that the refilling tube 33 extends between the end 320 of the article 30 comprising the mouthpiece 35 and the aerosol-generating material storage area 39. In this case, the article 30 does not necessarily need to be separated from the aerosol-generating device 20 in order to refill the article 30 with aerosol-generating material 32, as the refilling orifice 34 is not obstructed by the aerosol-generating device 20 when the article 30 is coupled with the aerosol provision device 20 via the interfaces 22, 24.

The article 30 illustrated in FIG. 2 also comprises article control circuitry 38 configured to control the operation of the article 30 and store parameters and/or data associated with the article 30. The parameters associated with the article 30 may include, for example, a serial number and/or stock keeping unit (SKU) for the article 30 or other means of identifying the article 30 and/or the type of the article 30, a date of manufacture and/or expiry of the article 30, an indication of the number of times the article 30 has been refilled, the capacity of the aerosol-generating material storage area 39 and/or the amount of aerosol-generating material remaining in the aerosol-generating material storage area 39. The parameters associated with the article 30 may include data relating to the aerosol-generating material stored in the aerosol-generating material storage area 39, such as one or more ingredients, the concentration and/or amount of the ingredients and/or one or more flavorants within the aerosol-generating material. As described above in relation to the device control circuitry 28, the article control circuitry 38 can be provided in various different ways, for example using one or more suitably programmed programmable computer(s) and/or one or more suitably configured application-specific integrated circuit(s)/circuitry/chip(s)/chipset(s) configured to provide the desired functionality. For example, the article control circuitry 38 may comprise a microcontroller unit (MCU) or a system on chip (SoC).

The article 30 illustrated in FIG. 2 also comprises one or more connectors 31, such as contact electrodes, connected via electrical wiring to the aerosol generator 36 and the article control circuitry 38. In use, the article 30 is coupled to the aerosol-generating device 20 and the connectors 31 mate with connectors on the aerosol-generating device, thereby allowing electrical power and electrical current to be supplied from the battery 14 of the aerosol-generating device 20 to the aerosol generator 36 and the article control circuitry 38. As illustrated in FIG. 2, the one or more connectors 31 can be located at the same end 310 of the article 30 as the interface 22. Alternative, the one or more connectors 31 may form part of the interface 22 or be located on a different surface of the article 30 to the interface 22, for example a side wall of the article 30 proximate to the end 310 with the interface. It will be appreciated that the one or more connectors 31 can be located on any surface of the article 30 so as to provide a complementary fixture or fitting with equivalent connectors 22 on the aerosol provision device 20 and/or refilling device 40 as described in more detail below.

FIG. 3 is a schematic diagram of a refilling device 40 for an article of an aerosol provision system, such as the article 30 illustrated in FIG. 2, and a reservoir 50. The reservoir 50 is a disposable/replaceable part which contains aerosol-generating material 52. The refilling device 40 facilitates the transfer of the aerosol-generating material 52 from a reservoir 50 couplable to the refilling device to an article 30 couplable to the refilling device in order to refill or replenish the aerosol-generating material storage area 39 of the article 30 with aerosol-generating material. In other words, the refilling device 40 described herein is a refilling apparatus for an article 30 of an aerosol provision system 10. The article 30 can then be reused as part of the aerosol provision system 10 described above, whilst the reservoir 50 can be disposed of when the aerosol-generating material 52 within the reservoir 50 has been depleted. This allows a single article 30 to be refilled using one or more reservoirs, thereby increasing the number of uses of a single article 30.

The refilling device 40 illustrated in FIG. 3 can be considered a desktop refilling device 40. A desktop refilling device is a refilling device designed for regular use at a single location on or near a desk, table or other solid surface due to its size and power requirements. For example, desktop refilling device 40 can comprise an external power supply, such as a mains power or supply to which the refilling device 40 can be coupled, attached or otherwise connected. The refilling device 40 may also comprise an internal power source, such as a battery, configured to supply electrical power to the components of the refilling device 40 in the event that the external power supply is not available or unexpectedly cuts out in the middle of operation.

As illustrated in FIG. 3, the refilling device 40 can also comprise a flat surface 410 to facilitate storage of the desktop refilling device on another flat surface, such as a desk, table or other solid surface. This allows the desktop refilling device 40 to rest stably and level on another surface. The flat surface 410 may comprise a non-slip mat or coating in order to prevent the desktop refilling device from being knocked or pushed. The non-slip mat may be made of rubber or any other suitable material with a high coefficient of friction. More generally, the desktop refilling device 40 illustrated in FIG. 3 has the flat surface 410 at a first end of the refilling device 40 and a second surface 420 at a second end of the refilling device 40. The second end is opposite the first end, such that a major axis or length of the refilling device 40 extends between the first end and the second end. When the first end and flat surface 410 are placed or otherwise located on a horizontal surface (e.g. aligned with x-axis in FIG. 3), the major axis or length of the refilling device 40 extends in a vertical direction (aligned with the y-axis in FIG. 3) between the first end and the second end. The flat surface 410 can therefore be considered as the base, bottom or foot of the refilling device 40 whilst the second surface 420 can be considered the top or upper surface of the refilling device 40.

As illustrated in FIG. 3, the refilling device 40 comprises an article interface 42 configured to receive the article 30. The article interface 42 may comprise a slot, tray, opening or aperture on the refilling device 40 into or onto which the article 30 is placed or coupled. Alternatively the article interface 42 may comprise a lead or other cable which is attachable or otherwise connectable to the article 30. Although one article interface 42 is illustrated in FIG. 3, the refilling device 40 may comprise more than one article interface 42, for example three, five or ten, depending on the specific design of the refilling device 40. In this case, two or more of the article interfaces 42 may be different such that the refilling device 40 is capable of receiving different types of article, or two or more of the article interfaces 42 may be the same such that the refilling device 40 is capable of receiving multiple articles of the same type.

As illustrated in FIG. 3, the article interface 42 is configured to receive the article 30 when the article 30 is separated from the aerosol provision device 20. As set out above with reference to FIG. 1, when used as an aerosol provision system 10, the aerosol provision device 20 and article 30 are mechanically coupled together via interfaces 22, 24. The article interface 42 is configured such that, before the article 30 is received by the article interface 42, the article is detached, disconnected or otherwise separated from the aerosol provision device 20 such that only the article 30 is received by the article interface 42 (in other words, the aerosol provision system 20 is not received by the article interface 42). This means that the aerosol provision device 20 is not required in order for the article 30 to be refilled with aerosol generating material 32.

The refilling device 40 also comprises one or more reservoir interfaces 46 configured to receive a reservoir 50. In the same fashion as described above in relation to the article interface 42, each of the reservoir interfaces 46 may comprise a slot, tray, opening or aperture on the refilling device 40 into or onto which the reservoir 50 is placed or coupled. Alternatively, each reservoir interface 46 may comprise a lead or other cable which is attachable or otherwise connectable to the reservoir 50. Although two reservoir interfaces 46 are illustrated in FIG. 3, this is not essential and the refilling device 40 may comprise fewer or more reservoir interfaces 46, for example one, three, five or ten, depending on the specific design of the refilling device 40.

As illustrated in FIG. 3, the one or more reservoir interfaces 46 can be located above the article interface 42. In other words the one or more reservoir interfaces 46 are located at a higher position than the article interface 42 such that, in use, the transfer of aerosol-generating material 52 from the reservoir 50 to the article 30 is gravity assisted, thereby reducing the energy required to transfer aerosol-generating material 52. The x-axis shown in FIG. 3 aligns with a horizontal direction and the y-axis shown in FIG. 3 aligns with a vertical direction. A first end of the refilling device 40 comprises the flat surface 410 to allow the refilling device is located on a horizontal surface. As illustrated in FIG. 3, the one or more reservoir interfaces 46 are located further (in other words, a greater distance along the major axis or length of the refilling device 40) from the flat surface 410 than the above the article interface 42. This ensures that, when the flat surface 410 is placed on another flat surface (such as a horizontal surface), such as in the case of a desktop refilling device as described above, the flat surface 410 aligns with the x-axis (or horizontal direction), and the one or more reservoir interfaces 46 are located at a higher position than the article interface 42.

The refilling device 40 also comprises refilling control circuitry 48 configured to control the operation of the refilling device 40. In particular, the refilling control circuitry 48 is configured to facilitate the transfer of aerosol-generating material 52 from a reservoir 50 to the article 30. As described above in relation to the device control circuitry 28, the refilling control circuitry 48 can be provided in various different ways, for example using one or more suitably programmed programmable computer(s) and/or one or more suitably configured application-specific integrated circuit(s)/circuitry/chip(s)/chipset(s) configured to provide the desired functionality. For example, the refilling control circuitry 48 may comprise a microcontroller unit (MCU) or a system on chip (SoC).

The refilling device 40 also comprises a housing 400 which contains and encloses the components of the refilling device 40. As illustrated in FIG. 3, the article interface 42 and the one or more reservoir interfaces 46 are located inside the housing 400 of the refilling device. The article interface 42 is therefore configured to enclose the article 30 and the one or more reservoir interfaces 46 configured to enclose the reservoir 50 inside the housing 400 of the refilling device 40 during the transfer of aerosol-generating material 52 from the reservoir 50 to the article 30. The article interface 42 and/or the reservoir interfaces 46 may comprise a door, cover or flap which can be shut when the article 30 and reservoir 50 are respectively received by the article interface 42 and the one or more reservoir interfaces 46 such that the article 30 and the reservoir 50 are fully contained within or otherwise enclosed by the housing 400 of the refilling device 40.

As described above, the reservoir 50 comprises aerosol-generating material 52 for transferring, by the refilling device 40, to the article 30 in order to refill or replenish the aerosol-generating material 32 in the aerosol-generating material storage area 39 of the article 30.

The reservoir 50 illustrated in FIG. 3 also comprises reservoir control circuitry 58 configured to control the reservoir 50 and store parameters and/or data associated with the reservoir 50. The parameters associated with the reservoir 50 may include, for example data indicative of an amount of aerosol-generating material 52 stored in the reservoir 50, data relating to the aerosol-generating material 52 stored in the reservoir 50, such as one or more ingredients, the concentration and/or amount of the ingredients and/or one or more flavorants within the aerosol-generating material 52. The data may also comprise an identifier, such as a serial number and/or SKU for the reservoir 50 or other means of identifying the reservoir 50 and/or the type of the reservoir 50, and a date of manufacture and/or expiry of the reservoir 50. As described above in relation to the device control circuitry 28, the reservoir control circuitry 58 can be provided in various different ways, for example using one or more suitably programmed programmable computer(s) and/or one or more suitably configured application-specific integrated circuit(s)/circuitry/chip(s)/chipset(s) configured to provide the desired functionality. For example, the reservoir control circuitry 58 may comprise a microcontroller unit (MCU) or a system on chip (SoC). Alternatively, the reservoir control circuitry 58 may comprise a code printed onto the reservoir, such as a barcode or QR code, or an NFC chip or other form of passive tag.

The reservoir 50 can have a volume of 10 ml or more, for example 20 ml, 50 ml or 100 ml. In other words, the reservoir is configured to contain 10 ml or more of aerosol-generating material 52 when the reservoir 50 is filled with aerosol generating material 52. At least one of the one or more reservoir interfaces 46 is then configured to receive a reservoir with a volume of 10 ml or more.

The reservoir 50 can also have a larger volume than the article 30. For example, the volume of the reservoir can be at least 5 times greater than the volume of the article, for example 10 times, 20 times or 50 times greater. In other words, the reservoir is configured to contain, when filled with aerosol-generating material 52, a volume of aerosol-generating material 52 at least 5 times greater than the aerosol-generating material storage area 39 of the article 30. This allows the same reservoir 50 to be used to refill the article at least 5 times. At least one of the one or more reservoir interfaces 46 is then configured to receive a reservoir with a volume at least 5 times greater than a volume of the article the article interface 42 is configured to receive.

The refilling device 40 illustrated in FIG. 3 also comprises one or more connectors 41, such as contact electrodes, connected via electrical wiring to the refilling control circuitry 48 and the power source (not illustrated). The connectors 41 are located proximate to or as part of the article interface 42. This facilitates communication between the refilling control circuitry 48 and the article control circuitry 38; the connectors 31 on the article 30 mate with the connectors 41 on the refilling device 40 when the article 30 is received by the article interface 42, thereby allowing power to be supplied from the refilling device 40 to the article control circuitry 38 and electrical signals to be transferred between the refilling control circuitry 48 and the article control circuitry 38. The connectors 41 may be arranged relative to the article interface 42 in a pattern and position matching/mirroring the connectors 31 on the article 30 in order to facilitate the mating of the connectors 31 on the article 30 and the connectors 41 on the refilling device 40 when the article 30 is received by the article interface 42.

In the same fashion, the refilling device 40 illustrated in FIG. 3 also comprises one or more connectors 47, such as contact electrodes, located proximate to or as part of each of the reservoir interfaces 46 and connected via electrical wiring to the refilling control circuitry 48 and the power source (not illustrated). The connectors 47 mate with the connectors 51 on the reservoir 50 when the reservoir 50 is received by the reservoir interface 46, thereby allowing power to be supplied from the refilling device 40 to the reservoir control circuitry 58 and electrical signals to be transferred between the refilling control circuitry 48 and the reservoir control circuitry 58. The connectors 47 may be arranged relative to the reservoir interface 46 in a pattern and position matching/mirroring the connectors 51 on the reservoir 50 in order to facilitate the mating of the connectors 51 on the reservoir 50 and the connectors 47 on the refilling device 40 when a reservoir 50 is received by one of the reservoir interfaces 46.

Although the connectors 31, 41, 47, 51 are described herein as physical electrical connectors between the article, the refilling device and the reservoir, in an alternative implementation one or more of the electrical connections between the respective components may be a wireless connection, such as NFC, RFID, or inductive coupling.

The refilling device 40 illustrated in FIG. 3 also comprises a refilling outlet 44 located proximate to or as part of the article interface 42, a refilling inlet 45 located proximate to or as part of each of the reservoir interfaces 46, and a duct 43 connecting each refilling inlet 45 to the refilling outlet 44. The refilling outlet 44 is configured to mate with the refilling orifice 34 on the article 30 when the article is received by the article interface 42, and each refilling inlet 45 is configured to mate with a reservoir outlet 55 when a reservoir 50 is received by the corresponding reservoir interface 46. The duct 43 is configured to facilitate the transfer of aerosol-generating material 52 from each of the refilling inlets 45 to the refilling outlet 44, thereby providing a transfer path for aerosol-generating material 52 from the reservoir 50 through the refilling device 40 and into the article 30.

Although the refilling outlet 44 is illustrated in FIG. 3 as being on the same end or surface of the article interface 42 as the connectors 41, this is not essential. The refilling outlet 44 may be located anywhere proximate to or in the article interface 42 relative to the connectors 41 in order for the refilling outlet 44 to mate with the refilling orifice 34 on the article 30 whilst the connectors 41 on the refilling device 40 mate with the connectors 31 on the article 30 when the article 30 is received by the article interface 30. Similarly, the refilling inlet 45 may be located anywhere proximate to or in each reservoir interface 46 relative to the connectors 47 in order for the refilling inlet 45 to mate with the reservoir outlet 55 on the reservoir 50 whilst the connectors 47 on the refilling device 40 mate with the connectors 51 on the reservoir 50 when a reservoir 50 is received by a reservoir interface 46.

Further, as described above, the refilling device 40 may be configured to receive different types, designs or configuration of article 30 using the same article interface 42. In this case, there may be multiple configurations of connectors 41 and/or refilling outlets 44 proximate to or in the article interface 42 in order to facilitate the same article interface 42 receiving different types, designs or configurations of article 30. Equally, there may be multiple configurations of connectors 47 and/or refilling inlets 45 proximate to or in each reservoir interface 46 in order to facilitate the same reservoir interface 46 receiving different types, designs or configurations of reservoir 50. Alternatively or in addition, the configuration of connectors 47 and/or refilling inlets 45 proximate to or in the one or more of the reservoir interfaces 46 may be different such that different reservoir types are received by different reservoir interfaces 46 of the same refilling device 40.

One or more of the refilling outlet 44, the refilling inlets 45, the reservoir outlet 55 and the duct 43 may also include a means of controlling the rate and/or direction of transfer of the aerosol-generating material 52, for example a ball valve, needle valve or diaphragm to control the rate of transfer and/or a one way valve such as a check valve or non-return valve to control the direction of transfer. For example, a one way valve may be located at or proximate to each of the refilling outlet 44, the refilling inlets 45 and the reservoir outlets 55 to ensure that aerosol-generating material 52 can only be transferred from the reservoir 50 to the refilling device 40 and from the refilling device 40 to the article 30, whilst a single ball valve or diaphragm may be located on or in the duct 43 of the refilling device 40 in order to control the flow rate of aerosol-generating material 52 from the reservoir 50 through the refilling device 40 and into the article 30. Equally, a ball valve or diaphragm may be located proximate to each refilling inlet 45 in order to independently control the rate of transfer of aerosol-generating material 52 into each of the refilling inlets 45 or from each of the refilling inlets 45 into the duct 43. For example, this allows the refilling control circuitry 48 to prevent a first aerosol-generating material 52 being transferred from a first reservoir 50 whilst a second aerosol-generating material 52 is being transferred from a second reservoir 50 to the article 30. This also allows the refilling control circuitry 48 to facilitate the transfer the first aerosol-generating material 52 from the first reservoir 50 and the second aerosol-generating material 52 from the second reservoir 50 simultaneously to the article 30, but at different transfer rates, thereby creating an aerosol-generating material 32 in the article 30 containing a mixture of the first aerosol-generating material 52 and the second aerosol-generating material 52 at different concentrations.

The refilling device 40 illustrated in FIG. 3 also comprises a device interface 49 configured to receive the aerosol provision device 20. As described above, the article interface 42 is configured to receive the article 30 when the article 30 is separated from the aerosol provision device 20, such that the aerosol provision device 20 is not received by the article interface 42. The aerosol provision device 20 can then be received by a separate device interface 49 as illustrated in FIG. 3. This allows the device interface 49 and the article interface 42 to be located separately on the refilling device 40, for example on different sides of the refilling device 40, such that the aerosol provision device 20 can be coupled to the refilling device 40 independently of the article 30. As described above, this also means that the aerosol provision device 20 is not required in order for the article 30 to be refilled with aerosol generating material 32.

The device interface 49 can be configured to receive the aerosol provision device 20 in order to supply electrical power from the refilling device 40 to the aerosol provision device 20. This electrical power can be used, for example, to recharge the power source or battery 14 of the aerosol provision device 20 and to facilitate the transfer of electrical signals between the refilling control circuitry 48 and the device control circuitry 28. This allows the user to use the refilling device 40 as a means of charging the aerosol provision device 20 whilst the article 30 is being replenished with aerosol-generating material 32, thereby reducing the number of associated devices needed to operate and maintain the aerosol provision system 10. The device interface 49 may be a wired interface, such as using electrical connectors as described above, or a wireless interface such as inductive or capacitive coupling. The device interface 49 may also be configured to the transfer of data between the refilling control circuitry 48 and the device control circuitry 28. The refilling control circuitry 48 may be configured to read data from the aerosol provision device 20 and/or write data to the aerosol provision device 20, for example to perform a software update, thereby installing an updated version of software onto the device control circuitry 28.

As set out above, the refilling device 40 facilitates the transfer of aerosol-generating material 52 from a reservoir 50 couplable to the refilling device 40 to an article 30 couplable to the refilling device 40 in order to refill or replenish the article 30 so that it can be reused as part of the aerosol provision system 10. In particular, the refilling control circuitry 48 is configured to facilitate the transfer of aerosol-generating material 52 from the reservoir 50 to the article 30 in response to detecting that the article 30 has been received by the refilling device 40.

By way of a concrete example, when a reservoir 50 is received by one of the reservoir interfaces 47, the connectors 47 located proximate to or in the corresponding reservoir interface 46 mate with the connectors 51 on the reservoir 50 and the refilling inlet 45 located proximate to or in the corresponding reservoir interface 46 mates with the reservoir outlet 55. When an article 30 is received by the article interface 42, the connectors 41 located proximate to or in the article interface 42 mate with the connectors 31 on the article 30 and the refilling outlet 45 mates with the refilling orifice 34 on the device 30. The refilling control circuitry 48 is then configured to facilitate the transfer of aerosol-generating material 52 from the reservoir 50 to the article 30 by facilitating the transfer of aerosol-generating material 52 from the reservoir 50 into the duct 42 of the refilling device 40 via the reservoir outlet 51 and the refilling inlet 45, and from the duct 42 of the refilling device 40 into the aerosol-generating material storage area 39 of the article 30 via the refilling outlet 44, the refilling orifice 34 and the refilling tube 33.

In the examples where the refilling device 40 has a plurality of reservoir interfaces 46, the refilling control circuitry 48 is configured to selectively facilitate the transfer of aerosol-generating material 52 from a reservoir 50 received by one of the reservoir interfaces 46, for example in response to a determination that only one of the reservoir interfaces 46 has received a reservoir 50, or in response to a selection of a particular reservoir 50 from which aerosol-generating material 52 should be transferred, for example a user input or a determination based on one or more parameters of each of the reservoirs 50 stored on the respective reservoir control circuitry 58. In this case, the refilling control circuitry 48 is configured to receive, from a user of the refilling device 40, a selection of one or more reservoir interfaces 46 and selectively facilitate the transfer of aerosol-generating material 52, from each reservoir 50 connected to one of the one or more selected reservoir interfaces 46, to the article 30 when the article 30 is coupled to the refilling device. In other words, the refilling control circuitry 48 is configured to only transfer aerosol-generating material 52 from a reservoir 50 connected to a selected reservoir interface 46, and prevent aerosol-generating material 52 from being transferred from any other reservoir 50 connected to the refilling device 40.

Although not illustrated, in some examples, the refilling device 40 can comprise a tank, container or other such receptacle for storing aerosol-generating material 52 received from the reservoir 50, for example when a reservoir 50 is received by the reservoir interface 46 without an article 30 being received by the article interface 42, thereby allowing the reservoir 50 to be disconnected from the reservoir interface 46 before an article 30 is received by the article interface 42. In this case, the aerosol-generating material 52 is stored in the receptacle of the refilling device 40 until such a time that it can be transferred to an article 30 received by the article interface 42. In this case, control circuitry 48 of the refilling device 40 is configured to facilitate the transfer of aerosol-generating material 52 from the reservoir 50 to the receptacle, and subsequently and separately to facilitate the transfer of the aerosol-generating material 52 from the receptacle to the article 42.

The receptacle of the refilling device 40 can also be used to facilitate the mixing of aerosol-generating material 52 before it is transferred to the article 30. For example, if a first reservoir interface 46 receives a first reservoir 50 containing a first aerosol-generating material 52 and a second reservoir interface 46 receives a second reservoir 50 containing a second aerosol-generating material 52, then the refilling control circuitry 48 can be configured to facilitate the transfer of the first aerosol-generating material 52 from the first reservoir 50 into the receptacle, and facilitate the transfer of the second aerosol-generating material 52 from the second reservoir 50 into the receptacle. The first aerosol-generating material 52 and the second aerosol-generating material 52 can then be mixed in the receptacle, and the mixture of the first aerosol-generating material 52 and the second aerosol-generating material 52 transferred to the article 30.

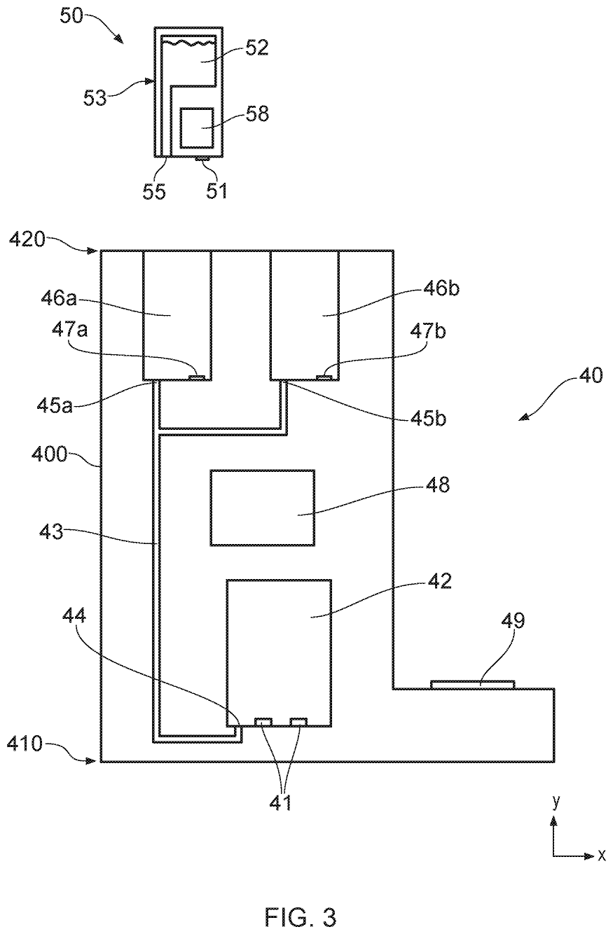

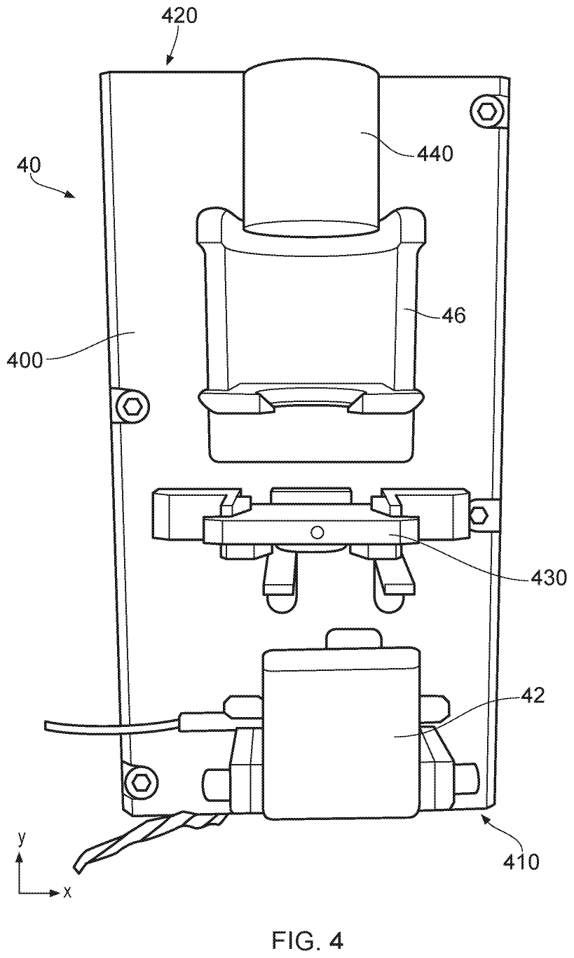

FIG. 4 is a schematic diagram of a refilling device 40 for an article of an aerosol provision system, such as the article 30 illustrated in FIG. 2, and the reservoir 50 illustrated in FIG. 3. The same reference signs have been used for like elements between the refilling device 40 illustrated in FIG. 3 and the refilling device 40 illustrated in FIG. 4. Like the refilling device 40 illustrated in FIG. 3, the refilling device 40 illustrated in FIG. 4 comprises an article interface 42 configured to receive the article 30, a reservoir interface 46 configured to receive a reservoir 50, and (not illustrated) refilling control circuitry 48 configured to control the operation of the refilling device 40.

The refilling device 40 also comprises a housing 400 which contains and encloses components of the refilling device 40. Although the article interface 42 and the reservoir interface 46 are located outside the housing 400 of the refilling device 40 in FIG. 4, this is purely for ease of illustration, and it will be appreciated that the article interface 42 and the reservoir interface 46 may be located inside the housing 400 as described above with reference to FIG. 3, with the article interface 42 and/or the reservoir interface 46 comprising a door, cover or flap which can be shut when the article 30 and reservoir 50 are respectively received by the article interface 42 and the reservoir interface 46 such that the article 30 and the reservoir 50 are fully contained within or otherwise enclosed by the housing 400 of the refilling device 40.

The refilling device 40 illustrated in FIG. 4 also comprises a nozzle block 430 located between the article interface 42 and the reservoir interface 46. In other words, the nozzle block 430 is located above the article interface 42 and the reservoir interface 46 is located above the nozzle block 43. In use, aerosol-generating material 52 from a reservoir 50 received by the reservoir interface 46 to the article 30 received by the article interface 42 via the nozzle block 430. This is achieved by the nozzle block 430 engaging with the article 30 and the reservoir 50. For example, a portion of the nozzle block 430 can be configured to engage with the refilling orifice 34 on the article 30 whilst another portion of the nozzle block 430 is configured to engage with the reservoir outlet 55 on the reservoir 50.

The nozzle block 430 is configured to be removable from the refilling device 40. In other words, the nozzle block 430 can be removed and a new nozzle block inserted into the refilling device 40, for example if the nozzle block 430 becomes damaged or has reached the end of its usable life. Equally, this allows the nozzle block to be removed and cleaned, for example if the user wishes to refill the article 30 with a different flavor or type of aerosol generating material or if the nozzle block 430 becomes blocked thereby preventing the transfer of aerosol generating material from the reservoir 50 to the article 30. The refilling control circuitry 48 can be control to only facilitate the transfer of aerosol generating material from the reservoir 50 to the article 30 in response to detecting that a nozzle block 430 is fitted to the refilling device 40. For example, the refilling device 40 can comprise a nozzle block interface configured to receive the nozzle block 430, and the refilling control circuitry 48 can be configured to detect when the nozzle block 430 has been received by the nozzle block interface, for example using a sensor or contact switch.

The refilling device 40 illustrated in FIG. 4 also comprises a plunger 440. The plunger 440 is located above the reservoir interface 46 and is configured to engage with the reservoir 50 when the reservoir 50 is located in the reservoir interface 46 in order to facilitate the transfer of aerosol-generating material 52 from the reservoir 50 to the article 30. For example, the plunger 440 may be configured to engage with a surface the reservoir 50 and displace the surface of the reservoir 50. This displacement of the surface of the reservoir 50 reduces the volume of the portion of the reservoir 50 containing the aerosol generating material 52, thereby pushing aerosol-generating material 52 out of the reservoir 50 through the reservoir outlet 55 and into the article 30 via the nozzle block 430 and the refilling orifice 34.

The plunger 440 can be configured to be integrated with the reservoir interface 46. In other words, the plunger 440 forms part of the reservoir interface 46 such that the reservoir interface 46 comprises the plunger. In this case, the plunger 440 moves with the reservoir interface 46, although one or more portions of the plunger can be configured to be separately movable or actuated in order to engage with the reservoir 50 and displace a surface of the reservoir and facilitate the transfer of aerosol-generating material 52 from the reservoir 50 to the article 30 as described above.

Although not illustrated in FIG. 4, the nozzle block 430 can comprise a syringe, needle or other device to facilitate the transfer of aerosol-generating material 52 from the reservoir 50 to the article 30 via the nozzle block 430. In other words, in use, the syringe is located between the article interface 42 and reservoir interface 46, such that the motion of the plunger 440 pushes aerosol-generating material 52 out of the reservoir 50 through the reservoir outlet 55 into the syringe, then out of the syringe and into the article 30 via the refilling orifice 34. The nozzle block 430 can also comprise a three-way check valve to control the transfer of aerosol-generating material 52 into and out of the syringe, and one or more needles to facilitate the transfer of aerosol generating material 52 from the reservoir 50 to the article 30, for example a needle configured to engage with the reservoir outlet 55 on the reservoir and/or a needle configured to engage with the refilling orifice 34 on the article 30.

The nozzle block 430 can be configured to be integrated with either the article interface 42 or the reservoir interface 46. In other words, the nozzle block 430 forms part of the article interface 42 such that the article interface 42 comprises the nozzle block 430, or the nozzle block 430 forms part of the reservoir interface 46 such that the reservoir interface 46 comprises the nozzle block 430. In this case, the nozzle block 430 moves with the article interface 42 or the reservoir interface 46, although one or more portions of the nozzle block 430, such as syringe or needle can be configured to be separately movable or actuated in order to engage with the reservoir 50 and the article 30 in order to facilitate the transfer of aerosol-generating material 52 from the reservoir 50 to the article 30 via the nozzle block 430.

Although not illustrated in FIG. 4, the refilling device 40 also comprises a motor and a cam mechanism. The cam mechanism is coupled to each of the article interface 42, the reservoir interface 46 and the plunger 440. The motor is configured to drive the cam mechanism such that, in use, the article 30, the reservoir 50 and the plunger 440 move in a coordinated manner such that aerosol-generating material 52 is transferred from the reservoir 50 to the article 30. In other words, when the reservoir 50 is received by the reservoir interface 46 and the article 30 is received by the article interface 42, the motor drives the cam mechanism, which is in turn coupled to the article interface 42 and the reservoir interface 46, and therefore the reservoir 50 moves with and/or in the reservoir interface 46 and the article 30 moves with and/or in the article interface 42. The refilling control circuitry 48 can be configured to operate or otherwise control the motor. In other words, the refilling control circuitry 48 may be configured to control the motor to facilitate the transfer of aerosol-generating material 52 from the reservoir 50 to the article 30 as described herein.

As illustrated in FIG. 4, the article interface 42, the reservoir interface 46 and the plunger 440 are separated from each other. In other words, there is a gap between each of the article interface 42, the reservoir interface 46 and the plunger 440. This allows clearance for the user to access the article interface 42 and the reservoir interface 46, thereby allowing the user to place, load or otherwise locate the article 30 into/onto the article interface 42 and to place, load or otherwise locate the reservoir 50 into/onto the reservoir interface 46. The motor is then configured to drive the cam mechanism to move the article 30, the reservoir 50 and the plunger 440 in a co-ordinated fashion. For example, the reservoir interface 46 and/or the article interface 42 may be moved by cam mechanism to close the gap between the reservoir interface 46 and the article interface 42 such that the article 30 and the reservoir 50 are proximate to each other. For example, the reservoir interface 46 may be moved by the cam mechanism towards the article interface 42 with the article interface 42 remaining stationary, the article interface 42 may be moved by the cam mechanism towards the reservoir interface 46 with the reservoir interface 46 remaining stationary, or both the reservoir interface 46 and the article interface 42 may be moved by the cam mechanism.

As described above, the plunger 440 may then be moved by the cam mechanism towards the reservoir interface 46, such that the plunger 440 engages with a surface the reservoir 50 and displaces the surface of the reservoir 50, thereby pushing aerosol-generating material 52 out of the reservoir and into the article 30.

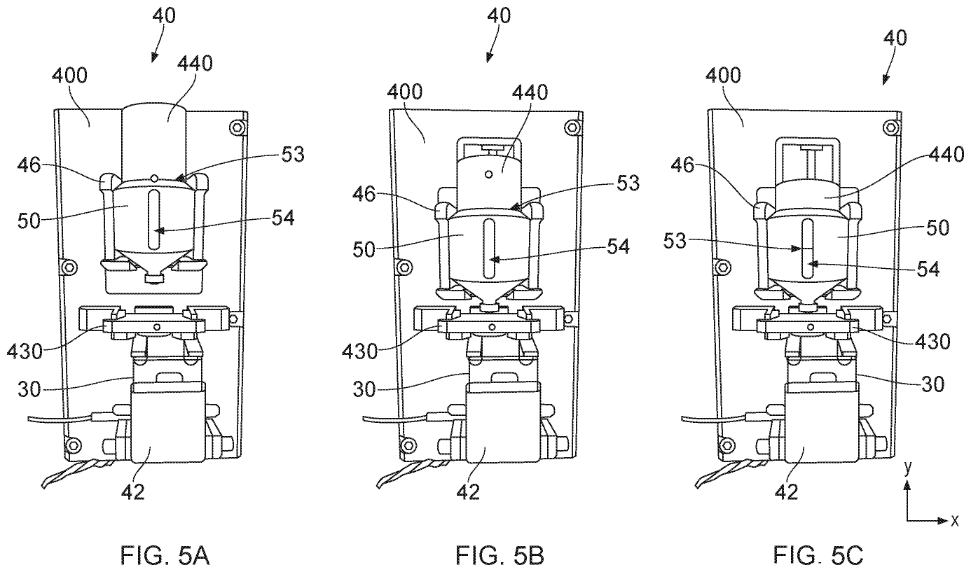

FIGS. 5A to 5C are schematic diagrams of the refilling device 40 illustrated in FIG. 4 but with the components of the refilling device at different locations to illustrate the coordinated manner in which the article 30, the reservoir 50 and the plunger 440 move. The same reference signs have been used for like elements between the refilling device 40 illustrated in FIG. 4 and the refilling device 40 illustrated in FIGS. 5A to 5C.

As illustrated in FIG. 5A, an article 30 has been received by the article interface 42 and a reservoir 50 has been received by the reservoir interface 46. The refilling control circuitry 48 can be configured to control the motor in response to the article 30 being received by the article interface 42 and in response to the reservoir 50 being received by the reservoir interface 46. The refilling control circuitry 48 may detect that article 30 and the reservoir 50 have been received, respectively, by the article interface 42 and the reservoir interface 46 using one or more sensors or contact switches. For example, a sensor or a contact switch may be located in, on or proximate to each of the article interface 42 and the reservoir interface 46. The refilling control circuitry 48 is then configured to only operate the motor in response to detecting that both an article 30 has been by the article interface 42 and a reservoir 50 has been received by the reservoir interface 46. Alternatively, the refilling control circuitry 48 can be configured to control the motor in response to a user input. The user input can be on an input device on the refilling device 40, such as a button, switch or touch screen, or the user input can be on a device communicatively coupled to refilling device 40, such a mobile computing device connected to the refilling device 40 using Bluetooth, Wi-Fi or other form of wireless communications. In response to receiving the user input, the refilling control circuitry 48 can be configured to determine whether an article 30 has been by the article interface 42 and a reservoir 50 has been received by a reservoir interface 46, for example using the one or more sensors or contact switches as described above. If it is determined that both an article 30 has been received by the article interface 42 and a reservoir 50 has been received by a reservoir interface 46, the refilling control circuitry 48 is then configured to control the motor. If an article 30 has not been by the article interface 42 and/or a reservoir 50 has not been received by a reservoir interface 46, the refilling control circuitry 48 is then configured to prevent the motor from operating. The refilling control circuitry 48 may also be configured to provide a notification to the user indicating that one or both of an article 30 and a reservoir 50 needs to be loaded into the refilling device 40 before the refilling operation can begin (in other words, before the motor will operate). The notification may be provided on the refilling device 40 or a device communicatively coupled to refilling device 40. The notification can be provided by illuminating a light or LED, playing a sound through a speaker, displaying a message on a display screen or by a haptic means.

As described above, the refilling control circuitry 48 is configured to operate the motor, which is configured to drive a cam mechanism coupled to each of the article interface 42, the reservoir interface 46 and the plunger 440 such that the article 30, the reservoir 50 and the plunger 440 move in a coordinated manner. For example, the cam mechanism may be configured such that the article interface 42 is moved towards a nozzle block 430 and the reservoir interface 46 is moved towards the nozzle block 430. This is illustrated in FIG. 5B, which illustrates the refilling device 40 after the article interface 42 and the reservoir interface 46 have been moved towards the nozzle block 430. Since the article 30 is received by the article interface 42 and the reservoir 50 is received by the reservoir interface 46, the article 30 and the reservoir 50 are moved towards the nozzle block 430 as the article interface 42 and the reservoir interface 46 are respectively moved towards the nozzle block 430. By comparing FIG. 5B with FIG. 5A, it can be seen that the article 30 has been moved towards the nozzle block 42 by moving the article interface 42 upwards (in the positive y-direction) towards the nozzle block 430 whilst the reservoir 50 has been moved towards the nozzle block 42 by moving the reservoir interface 46 downwards (in the negative y-direction) towards the nozzle block 430. In other words, the article interface 42 and the reservoir interface 46 have been moved in opposite directions. It also be seen that the plunger 440 has been moved towards the nozzle block 430, but that the separation between the plunger 440 and the reservoir 50 and reservoir interface 46 has not changed. In other words, the plunger 440 and the reservoir interface 46 have been moved towards the nozzle block 430 simultaneously and at the same speed.

The cam mechanism is then configured to move the plunger 440 to engage the plunger 440 with a surface 53 of the reservoir 50, for example the surface 53 of the reservoir 50 proximate to the plunger 440. The cam mechanism is then configured to further move the plunger 440, resulting in the plunger 440 pushing on and displacing the surface 53 of the reservoir 50. As described above, this displacement of the surface 53 of the reservoir 50 reduces the volume of the portion 54 of the reservoir 50 containing the aerosol generating material 52, thereby pushing aerosol-generating material 52 out of the reservoir 50 through the reservoir outlet 55 and into the article via the nozzle block 430 and the refilling orifice 34 on the article 30. This movement of the plunger is illustrated in FIG. 5C. By comparing FIG. 5C with FIG. 5B, it can be seen that the article interface 42 and reservoir interface 46 have remained in the same place (in other words, the article interface 42 and the reservoir interface 46 have not moved), whilst the plunger 440 has been moved towards the nozzle block 430 by moving the plunger 440 downwards (in the negative y-direction) towards the nozzle block 430. This results in the surface 53 of the reservoir 50 being moved towards the nozzle block 430 as well. This relative movement of the surface 53 of the reservoir 50 compared to the remainder of the reservoir 50 reduces the volume of the portion 54 of the reservoir 50 containing the aerosol generating material 52.

The coordinated manner in which the article interface 42, the reservoir interface 46 and the plunger 440 move as described above with respective to FIGS. 5A to 5C can be sequential. In other words, the cam mechanism can be configured to first move the article interface 42 towards the nozzle block 430. Then, secondly, the cam mechanism is configured to move the reservoir interface 46 towards the nozzle block 430. Then, thirdly, the cam mechanism is configured to move the plunger 440 such that the plunger engages with and pushes on the surface 53 of the reservoir 50. Alternatively, as described above in relation to FIG. 5B, the cam mechanism may be configured to move the plunger 440 with the reservoir interface 46 towards the nozzles block, then the cam mechanism is configured to stop the reservoir interface 42 (in other words, the reservoir interface 56 remains stationary) whilst the cam mechanism moves the plunger 440 such that the plunger engages with and pushes on the surface 53 of the reservoir 50. This configuration of the cam mechanism allows a single motor to be used to drive the motion of at least three separate components (the article interface 42, the reservoir interface 46 and the plunger 440) in a coordinated manner.

The coordinated manner in which the each of the article interface 42, the reservoir interface 46 and the plunger 440 move as illustrated in FIGS. 5A to 5C can be reversed. For example, once the surface 53 of the reservoir 50 has been pushed and displaced by the plunger 440, the direction of the motor can be reserved. This then drives the cam mechanism, which is turn causes the article interface 42, the reservoir interface 46 and the plunger 440 to move in the opposite direction to that described above with respect to FIGS. 5A to 5C. In other words, once the surface 53 of the reservoir 50 has been pushed and displaced by the plunger 440, the plunger 440 is moved away from the reservoir interface 46 and the nozzle block 430 such that a gap is created between the plunger 440 and the reservoir 50. In this case, the surface 53 of the reservoir 50 does not move with the plunger 440, and therefore remains stationary. The reservoir interface 46 is then moved away from the nozzle block 430, and the article interface 42 moved away from the nozzle block 430 such that there is a gap between the article 30 and the nozzle block 430, and a gap between the reservoir 50 and the nozzle block 430, as illustrated in FIG. 5A.

In other words, the cam mechanism can be configured to move the plunger 440 in a reciprocating motion. This reciprocating motion comprises a first direction where the plunger 440 moves towards the nozzle block 430 (in the negative y-direction in FIGS. 5A to 5C), and a second direction where the plunger 440 moves away from the nozzle block 430 (in the positive y-direction in FIGS. 5A to 5C). The second direction is therefore opposite the first direction. As described above, when the plunger 440 is moved in the first direction, the plunger 440 engages with and pushes on the surface 53 of the reservoir 50, such that the surface 53 of the reservoir 50 moves in the first direction whilst the remainder of the reservoir 50 remains stationary, thereby causing aerosol-generating material 52 to be transferred from the reservoir 50 to the nozzle block 430, for example into the syringe as described above. When the plunger 440 is moved in the second direction, the reservoir 50 including the surface 53 of the reservoir 50 remains stationary such that the plunger 440 moves away from the nozzle block 430 and the reservoir interface 46, and therefore the reservoir 50 as well. The cam mechanism can be configured such that aerosol generating material 52 is transferred from the syringe of the nozzle block 430 to the article 30 when the plunger is moved in the second direction. In other words, aerosol generating material 52 is transferred from the reservoir 50 into the syringe when the plunger 440 moves in the first direction, then aerosol generating material 52 is transferred from the syringe into the article 30 when the plunger 440 moves in the second direction. As described above, the nozzle block 430 can also comprise a three-way check valve to control the transfer of aerosol-generating material 52 into and out of the syringe. The three-way check valve can be controlled by the refilling control circuitry 48. For example, the refilling control circuitry 48 can be configured to cause the three-way check valve to actuate such that aerosol-generating material 52 is allowed to flow from the reservoir 50 into the syringe whilst preventing aerosol-generating material 52 from being transferred to the article 30 when the plunger 440 moves in the first direction. In response to, or in anticipation of the plunger 440 changing direction, the refilling control circuitry 48 can be configured to cause the three-way check valve to actuate such that aerosol-generating material 52 is allowed to flow from the syringe to the article 30 whilst preventing aerosol-generating material 52 from being transferred from the reservoir 50 when the plunger 440 moves in the second direction.

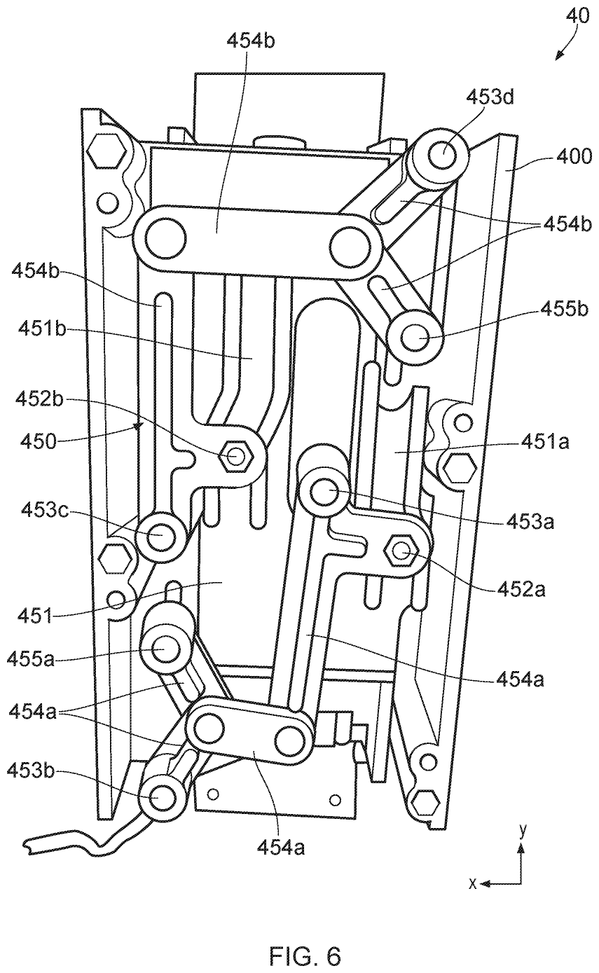

FIG. 6 is a further schematic diagram of the refilling device 40 illustrated in FIG. 4 but with a portion of the housing 400 removed for ease of illustration The same reference signs have been used for like elements between the refilling device 40 illustrated in FIG. 4 and the refilling device 40 illustrated in FIG. 6.

As described above, the refilling device 40 comprises a cam mechanism 450 coupled to each of the article interface 42, the reservoir interface 46 and the plunger 440. The cam mechanism 450 illustrated in FIG. 6 comprises a cam plate 451. The motor is connected to the cam plate 451 by a lead screw (not illustrated), such that rotation of the motor causes the cam plate 451 to move along the axis of the lead screw (which corresponds to the y-axis in FIG. 6). The plunger 440 is fixed to the cam plate 451 such that the plunger 440 moves with the cam plate 451. In other words, the plunger moves in the same direction and at the same speed as the cam plate 451 along the axis of the lead screw (which corresponds to the y-axis in FIG. 6). As described above, the cam mechanism can be configured to move the plunger 440 in a reciprocating motion, with a first direction where the plunger 440 moves towards the nozzle block 430 (in the negative y-direction in FIG. 6), and a second direction where the plunger 440 moves away from the nozzle block 430 (in the positive y-direction in FIG. 6). In other words, the motor is configured to rotate in a first direction, which rotates the lead screen in a first direction, causing the cam plate 451 and the plunger 440 to move in the first direction (in the negative y-direction in FIG. 6). When the motor then rotates in a second direction opposite the first direction, the lead screw is rotates in a second direction, causing the cam plate 451 and the plunger 440 to move in the second direction (in the positive y-direction in FIG. 6).

The reservoir interface 46 and the article interface 42 are respectively coupled to the cam plate 451 by pins and linkages, such that movement of the cam plate along the axis of the lead screw causes the reservoir interface 46 and the article interface 42 to move as described above with reference to FIGS. 5A to 5C. The cam plate 451 illustrated in FIG. 6 comprises two S-shaped tracks 451a, 451b. A first track pin 452a is located in the first S-shape track 451a and a second track pin 452b is located in the second S-shape track 452b. The first track pin 452a is connected to pivot points 453a, 453b and a first interface pin 455a by a first set of linkages 454, and the second track pin 452b is connected to pivot points 453c, 453d and a second interface pin 455b by a second set of linkages 454b. The first interface pin 455a is connected to the article interface 42, such that displacement of the first track pin 452a in the first S-shape track 451a causes the article interface 42 to move as described above with reference to FIGS. 5A to 5C. Equally, the second interface pin 455b is connected to the reservoir interface 46, such that displacement of the second track pin 452b in the first S-shape track 451b causes the reservoir interface 46 to move as described above with reference to FIGS. 5A to 5C.

FIG. 7 is a schematic diagram of the cam plate 451 illustrated in FIG. 6. As described above, the cam plate 451 comprises two S-shaped tracks 451a, 451b. As the cam plate 451 is moved by the motor along the axis of the lead screw (which corresponds to the y-axis in FIG. 7), the S-shaped tracks 451a, 451b move with the cam plate 451 relative to the track pins 452a, 452b such that the S-shaped tracks 451a, 451b slide past or around (i.e. either side of) the track pins 452a, 452b.

The cam plate 451 and the track pins 452a, 452b are configured such that the cam plate 451 can move whilst the reservoir interface 46 and article interface 42 are both stationary. The portions of the first S-shaped track 451a denoted by the letters D and F in FIG. 7, and the portions of the second S-shaped track 451b denoted by the letters A and C in FIG. 7 are parallel with and aligned with the direction of movement of the cam plate 451 (i.e. the y-axis in FIG. 7). When these portions of the S-shaped tracks 451a, 451b slide past the track pins 452a, 452b, no force is applied to the track pins 452a, 452b, and therefore the track pins 452a, 452b remain stationary. Due to the linkages between the track pins 452a, 452b and the article interface 42 and the reservoir interface 46, this results in the article interface 42 and the reservoir interface 46 also remaining stationary. In other words, when the portions of the S-shaped tracks 451a, 451b that align with the direction of movement of the cam plate 451 (i.e. the y-axis in FIG. 7) slide past the track pins 452a, 452b, the plunger 440 moves with the cam plate 451 whilst the article interface 42 and the reservoir interface 46 remain stationary.

When the curved portions of the S-shaped tracks 451a, 451b (denoted by the letters B and E in FIG. 7) slide past the track pins 452a, 452b, a force is applied to the track pins 452a, 452b, causing the track pins 452a, 452b to move in a direction perpendicular to the direction of movement of the cam plate 451 (i.e. in a direction corresponding to the x-axis in FIG. 7). As can be seem in FIG. 7, the first S-shaped track 451a and the second S-shaped track 451b curve in opposite directions. This results in the first track pin 452a and the second track pin 452b moving in opposite directions. In other words, as the curved portion of the first S-shaped track 451a (letter E) slides past the first track pins 452a, a force is applied to the first track pin 452a, causing the first track pin 452a to move in a direction corresponding to the positive x-direction. Equally, as the curved portion of the second S-shaped track 451b (letter B) slides past the second track pin 452b, a force is applied to the second track pin 452b, causing the second track pin 452b to move in a direction corresponding to the negative x-direction.

As the track pins 452a, 452b are moved, a force is transferred to the sets of linkages 454a, 454b, causing the linkages 454a, 454b to also move. The pivot points 453a-d remained fixed in place, such that the linkages 454 pivot about the pivot points 453a-d, thereby causing the interface pins 455a, 455b to move in the direction of movement of the cam plate 451 (i.e. the y-axis in FIG. 7). Since the first track pin 452a and the second track pin 452b move in opposite directions, this is translated to the interface pins 455a, 455b, such that the first interface pin 455a and the second interface pin 455b move in opposite directions. This results in the first interface pin 455a moving in a direction opposite the direction of movement of the cam plate 451 (i.e. corresponding to the positive y-direction) and the second interface pin 455b moving in the same direction of the movement as the cam plate 451 (i.e. corresponding to the negative y-direction). As plunger 440 is fixed to the cam plate, and the article interface 42 and the reservoir interface 46 are coupled, respectively, to the first interface pin 455a and the second interface pin 455b, this results in the article interface 42 and the reservoir interface 46 moving in the opposite and same direction, respectively, as the plunger 440 as also described above with reference to FIGS. 5A to 5C.

The relative lengths of the portions of the first S-shaped track 451a and the second S-shaped track 451b determine the timing of the movement of the article interface 42 and the reservoir interface 46. For example, if the track pins 452a, 452b are initially located at the bottom ends of the S-shaped tracks 451a, 451b as illustrated in FIG. 7 (the point on the S-shaped tracks 451a, 451b closest to the x-axis), then the relative lengths of the portions of the S-shaped tracks 451a, 451b labelled C and F determine when the article interface 42 and the reservoir interface 46 will move relative to one another. For example, if the section of the first S-shaped track 451a labelled F is shorter than the section of the second S-shaped track 451b labelled C, then as the cam plate 451 moves the first track pin 452a will reach the curved section (E) of the first S-shaped track 451a before the second track pin 452b reaches the curved section (B) of the second S-shaped track 451b. As a result, the article interface 42 will move towards the nozzle block 430 before the reservoir interface 46 moves towards the nozzle block 430. Equally, if the section of the second S-shaped track 451b labelled C is longer than the both the sections of the first S-shaped track 451a labelled E and F, the article interface 42 will stop moving towards the nozzle block 430 before the reservoir interface 46 begins moving towards the nozzle block 430.

It will also be appreciate that the distance that the article interface 42 moves is determined by (i.e. proportional to) the offset between the sections of the first S-shaped track 451a labelled D and F in the direction perpendicular to the direction of travel of the cam plate 451 (i.e. the offset distance in the x-axis in FIG. 7), whilst the distance that the reservoir interface 46 moves is determined by (i.e. proportional to) the horizontal offset between the sections of the second S-shaped track 451b labelled A and C in the direction perpendicular to the direction of travel of the cam plate 451 (i.e. the offset distance in the x-axis in FIG. 7). Equally, the speed at which the article interface 42 moves is determined by (i.e. proportional to) the speed at which the cam plate 451 moves and the slope of the curved portion of the first S-shaped track 451a labelled E, whilst the speed at which the reservoir interface 46 moves is determined by (i.e. proportional to) the speed at which the cam plate 451 moves and the slope of the curved portion of the second S-shaped track 451b labelled B.

The refilling control circuitry 48 can be configured to alter the speed of the motor based on the position of the plunger 440, thereby altering the speed at which the article interface 42, the reservoir interface 46 and the plunger 440 move. For example, the refilling control circuitry 48 can be configured to operate the motor at first speed when the article interface 42 and the reservoir interface 46 are moved towards the nozzle block 430, then operate the motor at a second, slower speed when the plunger is moved towards the nozzle block and the article interface 42 and the reservoir interface 46 are stationary. In other words, the plunger 440 engaging and pushing on the surface 53 of the reservoir 50 occurs at a slower speed than the article interface 42 and the reservoir interface 46 moving towards the nozzle block 430. This ensures that the transfer of aerosol generating material 52 from the reservoir to the article 30 occurs in a controlled fashion, whilst speeding up the overall process, since the components are moved to their required positions for the transfer of aerosol generating material 52 quicker.

The refilling control circuitry 48 can be configured to alter the speed of the motor from the first speed to the second speed in response to detecting that the plunger 440 has engaged with the surface 53 of the reservoir 50. For example, the force required to move the plunger 440 will increase once the plunger 440 has engaged with the surface 53 of the reservoir 50. This increase in force will change the draw current of the motor. The refilling control circuitry 48 can be configured to alter the speed of the motor from the first speed to the second speed in response to detecting this change in draw current of the motor. Alternatively, the reservoir interface 50 may be configured to receive a reservoir 50 of a particular size and shape. The distance the plunger 440 needs to move in order to engage with the surface 53 of the reservoir 50 will therefore be fixed, and therefore the control circuitry 48 can be configured to alter the speed of the motor from the first speed to the second speed in response to detecting that the plunger 440 or cam plate 451 has moved a given distance or that the motor has performed a number of rotation that corresponds to the given distance.

Once the plunger 440 has pushed down the surface 53 of the reservoir 50, the refilling control circuitry 48 can then be configured to reverse the direction of the motor and operate the motor at the first speed. Distance that the plunger 440 pushes down the surface 53 of the reservoir 50 may be fixed such that a predetermined amount of aerosol generating material 52 is transferred from the reservoir 50. In this case, the reservoir 50 may be configured to store enough aerosol generating material 52 to perform multiple refills of the article 30. The refilling control circuitry 48 can be configured to record the position of the plunger 440 (or the number of rotations of the motor performed) when the surface 53 of the reservoir 50 is at the required position, such that plunger 440 can be returned to the same position to start the next refilling operation. Alternatively, if the reservoir 50 is configured to store enough aerosol generating material 52 to a single refill of the article 30, the refilling control circuitry 48 can be configured to reserve the direction of the motor and operate the motor at the first speed in response to the plunger 440 displacing the surface 53 of the reservoir 50 a known distance, the plunger 440 reaching the end of its available travel, or in response to a further increase in draw current of the motor corresponding to the surface 53 of the reservoir 50 resisting further movement of the plunger 440.

As described above, when the direction of the motor is reversed, the plunger 440, the reservoir interface 46 and the article interface 42 moves away from the nozzle block 430 such that the components return to their original positions as illustrated in FIG. 5A.

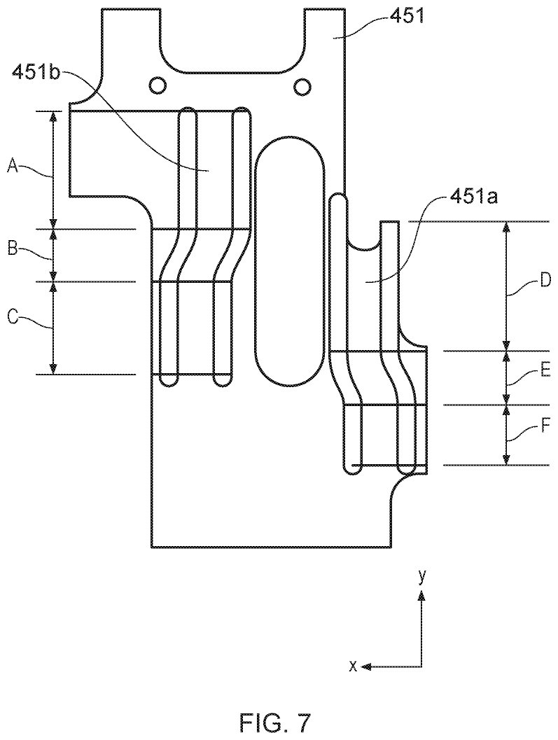

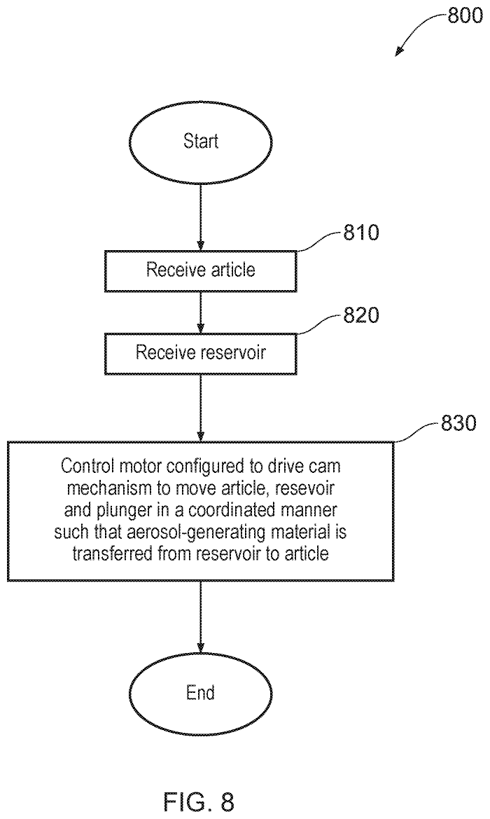

FIG. 8 is a flow chart of a method 800 of refilling an article 30, for example performed by the refilling control circuitry 48. The method begins at step 810, where an article 30 is received, for example by the article interface 42. At step 820 a reservoir 50 is received, for example by the reservoir interface 46. At step 830, a motor is controlled, where the motor is configured to drive a cam mechanism 450 to move the article 50, the reservoir 50 and a plunger 440 in a coordinated manner such that aerosol-generating material 52 is transferred from reservoir 50 to article 30. The method then ends.

The method 800 illustrated in FIG. 8 may be stored as instructions on a computer readable storage medium, such that when the instructions are executed by a processor, the method 800 described above is performed. The computer readable storage medium may be non-transitory.

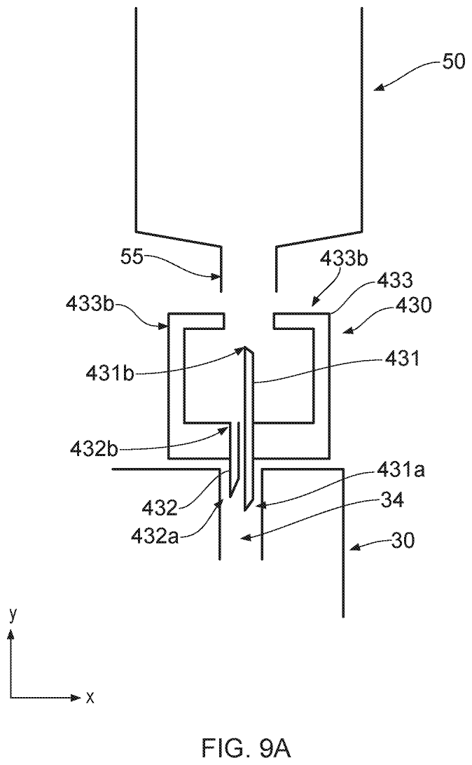

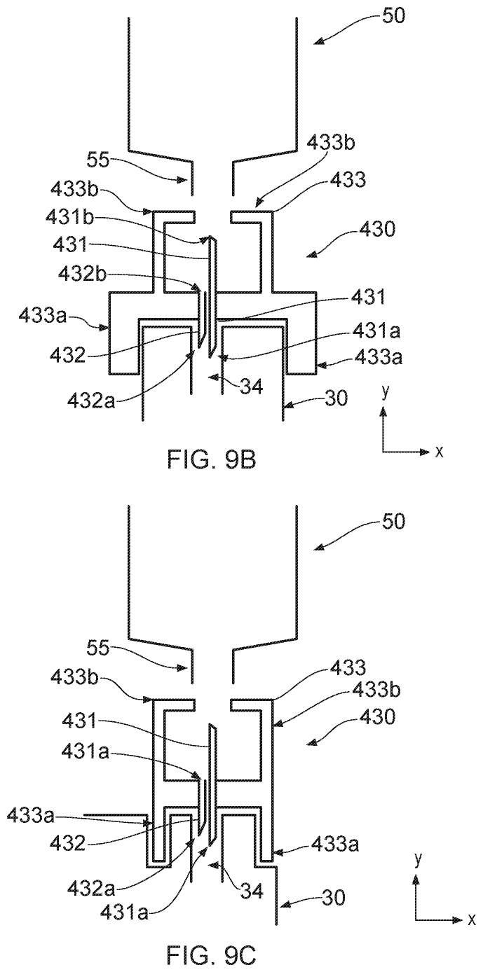

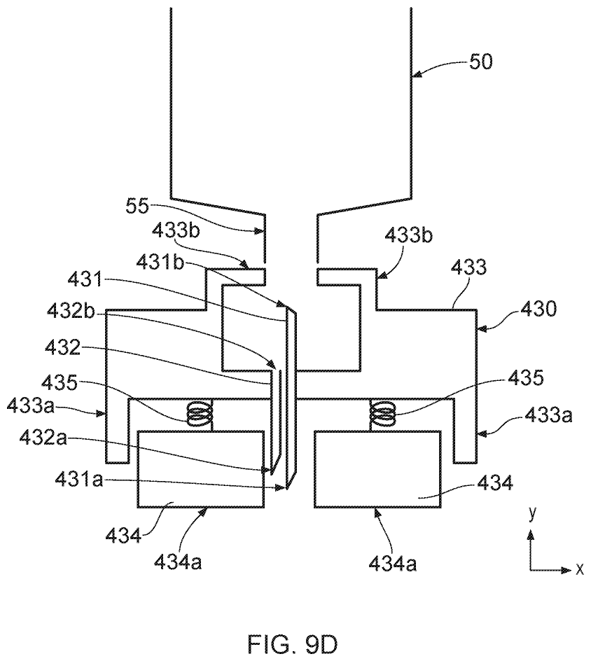

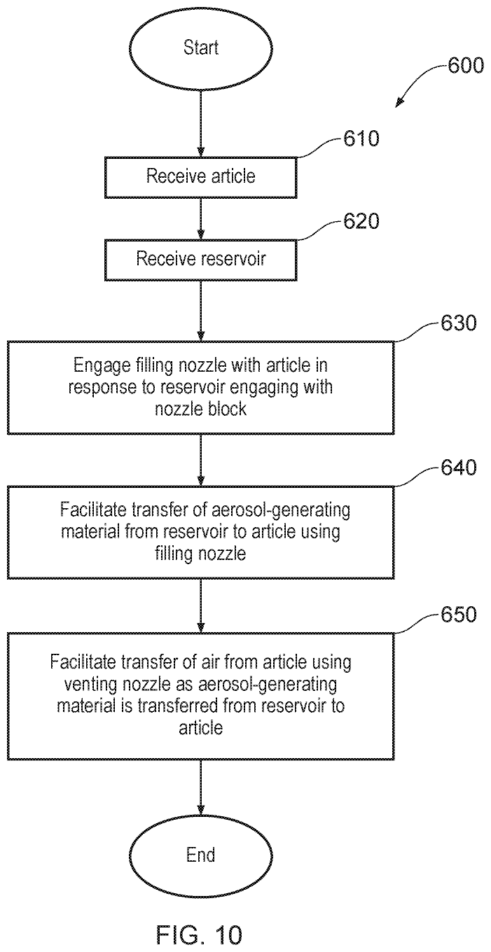

FIGS. 9A to 9D are schematic diagrams of nozzle blocks 430 of the refilling device 40 illustrated in FIG. 4. The nozzle blocks 430 illustrated in each of FIGS. 9A to 9D have a filling nozzle 431 and a venting nozzle 432. The filling nozzle 431 is configured to facilitate the transfer of aerosol-generating material 52 from the reservoir 50 to the article 30, whilst the venting nozzle 432 is configured to facilitate the transfer of air from the article 30 as aerosol-generating material 52 is transferred from the reservoir 50 to the article 30. In other words, aerosol-generating 52 is transferred from the reservoir 50 to the article 30 through the filling nozzle 431. As it will be appreciated, prior to being refilled with aerosol-generating 52, the aerosol-generating material storage area 39 of the article 30 will contain air. The aerosol-generating material storage area 39 may also contain some aerosol-generating material 32 prior to being refilled if the article 30 is not completely depleted of aerosol-generating material before it is refilled. In order to facilitate the transfer of aerosol-generating material 52 from the reservoir 50 to the article 30, the venting nozzle 432 provides a flow path for the air to flow out of the article 30 in response to the aerosol-generating material flowing into the article 30. This prevents a build-up of air pressure in the article 30 which could damage the article 30 or cause aerosol-generating material to leak out of the article 30.

As described above, the filling nozzle 430 is configured to engage with the article 30 in response to the reservoir 50 engaging with the nozzle block 430 in order to facilitate the transfer of aerosol-generating material 52 from the reservoir 50 to the article 30. In the example described above with reference to FIG. 2 where the refilling orifice 34 and/or the refilling tube 33 is be sealable, the filling nozzle 431 can be configured to engage with the seal on the refilling orifice 34 or refilling tube 33. For example, the seal can comprise a filling valve, and the filling nozzle 431 is configured to engage with the filling valve in order to facilitate the transfer of aerosol-generating material 52 from the reservoir 50 to the article 30. In other words, the filling nozzle 431 can be configured to push into the filling valve and pierce the filling valve in order to provide an opening in the valve through which aerosol-generating material can be transferred into the article 30. The nozzle block 430 and/or filling needle 431 may be configured such that the pushing into the filling valve and piercing the filling valve are separate actions. For example, in response to the article 40 being received by the article interface 42, the refilling control circuitry 48 may be configured to move the article interface 42 towards the nozzle block 430 until the filling nozzle 431 pushes into the filling valve. The refilling control circuitry 48 can be configured to detect that the filling nozzle 431 has pushed into the filling valve, for example based on a change in the resistance to movement of the article interface 42 or as a result of the article interface 42 being displayed or otherwise moved a known distance. The refilling control circuitry 48 may then be configured to move the article interface 42 further towards the nozzle block 430 as part of the process of facilitating the transfer of aerosol-generating material, thereby causing the filling needle 431 to pierce the filling valve. Alternatively, the refilling control circuitry 48 may be configured to move the nozzle block 430 and/or the filling needle towards the article interface 42 as part of the process of facilitating the transfer of aerosol-generating material, thereby causing the filling needle 431 to pierce the filling valve.

In a similar fashion, the seal on the refilling orifice 34 and/or the refilling tube 33 can comprise a venting valve, and the venting nozzle 432 configured to engage with the venting valve in order to facilitate the transfer of air from the article as aerosol-generating material is transferred from the reservoir to the article. Although described herein as separate valves, alternatively the venting valve and the filling valve may comprise two portions or openings of the same valve. When the transfer of aerosol generating material 52 from the reservoir 50 to the article 30 is complete, the filling nozzle 431 can be removed from the filling valve, and the venting nozzle 432 removed from the venting valve, causes the opening the filling valve and the venting valve to close again, thereby sealing the aerosol generating material in the article 30. This also allows the article 30 to be refilled with aerosol generating material multiple times.

The venting nozzle 432 can be configured to engage with the article 30 before the filling nozzle 431 engages with the article 30. In other words, the venting nozzle 432 is configured to engage with the article 30 in response to the reservoir 50 engaging with the nozzle block 430. For example, the venting nozzle 432 may be configured to engage with the venting nozzle before the filling nozzle 431 engages with the filling valve. This ensures that air can be transferred out of the article 30 through the venting nozzle 432 before aerosol-generating material is transferred into the article 30, thereby preventing an increase in air pressure in the article 30. In the example described above where the filling nozzle 431 is configured to push into the filling valve and then pierce the filling valve, the venting nozzle 432 can be configured to pierce the venting valve as the filling nozzle 431 pushes into the filling valve. In other words, the venting nozzle 432 pierces the venting valve, thereby creating an opening in the venting valve and allowing air to flow through the venting needle out of the article 30 whilst the filling nozzle 431 pushes into or touches the filling valve without creating an opening in the filling valve. An opening in the filling valve is only created when the filling nozzle 431 subsequently pierces the filling valve.

The venting nozzle 432 can be configured to engage with the article before the filling nozzle 431 engages with the article as a result of the venting nozzle 432 and the filling nozzle 431 being different lengths, for example the venting nozzle 432 and the filling nozzle 431 may protrude a different distance out of the nozzle block 430, or as a result of the relative location of the venting nozzle 432 and the filling nozzle 431 on the nozzle block 430. For example, the venting nozzle 432 may be located closer to the article interface 42 than the filling nozzle 431, such that the article 30 engages with the venting nozzle 432 before the filling nozzle 431 as the article interface 42 moves towards the nozzle block 430. Alternatively, or in addition, the venting nozzle 432 and the filling nozzle 431 be movable relative to each other and the nozzle block 430, such that the refilling control circuitry 48 can be configured to move the venting nozzle 432 towards the article 30 before moving the filling nozzle 431 towards the article 30, or move the venting nozzle 432 towards the article 30 at a faster speed than the filling nozzle 30, thereby causing the venting nozzle 432 to engage with the article 30 before the filling nozzle 431 engages with the article 30.

As illustrated in FIGS. 9A to 9D, the filling nozzle 431 has a first end 431a and a second end 431b, where the second end 431b is opposite the first 431a. The first end 431a of the filling nozzle 431 is configured to engage with the article 30 as described above, whilst the second end 431b of the filling nozzle 431 is configured to engage with the reservoir. For example, the second end 431b of the filling nozzle 431 can be configured to engage with the reservoir outlet 55 on the reservoir 50 in order to allow the transfer of aerosol-generating material 52 from the reservoir 50 through the reservoir outlet 55 and into the second end 431b of the filling nozzle 431. The aerosol-generating material 52 can then pass through the filling needle 431, flowing from the second end 431b to the first end 431a and into the article 30 through the refilling orifice 34.

The reservoir outlet 55 may also be sealable, and the second end 431b of the filling nozzle 431 can be configured to engage with the seal on the reservoir outlet 55. For example, the seal can comprise a valve, and the second end 431b of the filling nozzle 431 configured to engage with the valve in order to facilitate the transfer of aerosol-generating material 52 from the reservoir 50 to the article 30 in a similar fashion to the filling valve on the article 30 as described above. Such a seal on the reservoir outlet 55 allows the same reservoir to be used to refill the article 30 with aerosol-generating material multiple times. Alternatively, the seal on the reservoir outlet 55 may be a metallic, plastic or paper surface that the second end 431b of the filling nozzle 431 is configured to pierce, puncture or otherwise irreversibly break. In other words, the second end 431b of the filling nozzle 431 is configured to create an opening in the seal on the reservoir outlet 55 that allows aerosol-generating material 52 to be transferred from the reservoir 50 into the filling needle 431, but the opening in the seal on the reservoir outlet 55 remains open when the second end 431b of the filling nozzle 431 is removed from the seal on the reservoir outlet 55. This results in the reservoir 50 no longer being fluid tight, and therefore means that the reservoir 50 is a single use item since it cannot be refilled with aerosol-generating material 52.

As illustrated in FIGS. 9A to 9D, the venting nozzle 432 also has a first end 432a and a second end 432b, where the second end 432b is opposite the first 432a. The first end 432a of the venting nozzle 432 is configured to engage with the article 30 as described above, whilst the second end 432b of the venting nozzle 432 is open. In other words, the second end 432b of the venting nozzle 432 does not engage with either the article 30 or the reservoir 50. This allows the air that is transferred from the article 30 to pass through the nozzle block 430 and out of the refilling device 40, thereby providing a low resistance air path from the article to the outside of the refilling device 40. In the examples illustrated in FIGS. 9A to 9D, the second end 432b of the venting nozzle 432 is located inside the nozzle block 430, such that air passes around the outside of the reservoir 50 (for example around the outside of the reservoir outlet 55) in order to reach the outside of the refilling device 40. Alternative, the second end 432b of the venting nozzle 432 may be located on an external surface of the nozzle block 430 (and the refilling device 40) such that the venting nozzle 432 provides a direct flow path between the article 30 and the outside of the refilling device 40. As will be appreciated, however, the purpose of the venting nozzle is to provide a flow path for air to exit or otherwise escape the article 30 as aerosol-generating material 52 is transferred from the reservoir 50 to the article 30.

The nozzle block 430 illustrated in FIGS. 9A to 9D also comprises a housing 433 configured to at least partially contain the filling nozzle 431 and the venting nozzle 432. In other words, the housing 433 encloses or otherwise contains at least a portion of the filling nozzle 431 and at least a portion of the venting nozzle 432. For example, the housing 433 of the nozzle block 430 illustrated in FIGS. 9A to 9D encloses or otherwise contains the second end 431a of the filling nozzle 431 and the second end 432b of the venting nozzle 432 such that the second end 431a of the filling nozzle 431 and the second end 432b of the venting nozzle 432 are located inside the housing 433. The first end 431a of the filling nozzle 431 and the first end 432a of the venting nozzle 432 are, however, located outside of the housing 433 illustrated in FIG. 9A, such that the housing only partially contains the filling nozzle 431 and the venting nozzle 432.

The housing 433 illustrated in each of FIGS. 9B to 9D has a first flange 433a that extends in the same direction as the filling nozzle 431 and the venting nozzle 432 (the y-direction in FIGS. 9B to 9D). The first flange 433a extends beyond the first end 431a of the filling nozzle 431 and the first end 432a of the venting nozzle 432, such that the first end 431a of the filling nozzle 431 and the first end 432a of the venting nozzle 432 are contained within the housing 433. This protects the filling nozzle 431 and the venting nozzle 432, preventing damage or blockage of the filling nozzle 431 and the venting nozzle 432 when the nozzle block 430 is not in use, for example if the nozzle block is removed from the refilling device 40 as described above.

As illustrated in FIGS. 9B and 9C, the nozzle block 430 can engage with the article 30 such that a portion of the article 30, such as the refilling orifice 34, is located inside the housing 433, for example by locating at least a portion of the article 30 inside the first flange 433a of the housing 433. This allows the filling needle 431 and the venting needle 432 to engage with the article 30 as described above.

The housing 430 in each of FIGS. 9A to 9D also comprises a second flange 433b. The second flange 433b is located on a side of the housing opposite the first flange 433a. The second flange 433b extends beyond the second end 431b of the filling nozzle 431 and the second end 432b of the venting nozzle 432, such that the second end 431a of the filling nozzle 431 and the second end 432b of the venting nozzle 432 are located inside the housing 433. In this case, the filling nozzle 431 and the venting nozzle 432 are entirely contained within the housing 433. The nozzle block 430 can the engage with the reservoir 50 such that a portion of the reservoir 50, such as the reservoir outlet 55, is located inside the housing 433, for example by locating at least a portion of the reservoir 50 inside the second flange 433b of the housing 433. This allows the filling needle 431 to engage with the reservoir 50 as described above.

The nozzle block illustrated in FIG. 9D comprises a movable component 434. The moveable component 434 is configured to interact with the housing 433 to expose at least a portion of the filling nozzle 431 and at least a portion of the venting nozzle 432. As illustrated in FIG. 9D, the first end 431a of the filling nozzle 431 and the first end 432a of the venting nozzle 432 are enclosed by the moveable component 434; in other words, the first end 431a of the filling nozzle 431 and the first end 432a of the venting nozzle 432 are located inside the moveable component 434, and therefore inside the nozzle block 430. The filling nozzle 431 and the venting nozzle 432 are fixed to the housing 433 of the nozzle block 430, such that when the moveable component 434 is moved in a direction extending between the first end 431a of the filling nozzle 431 and the second end 431b of the filling nozzle 431 (corresponding to the positive y-direction in FIG. 9D), the first end 431a of the filling nozzle 431 and the first end 432a of the venting nozzle 432 are exposed. In other words, the first end 431a of the filling nozzle 431 and the first end 432a of the venting nozzle 432 are no longer located inside the moveable component 434 (or the nozzle block 430). In use, when the nozzle block 430 engages with the article 30, a surface of the article 30 can engage with a surface 434a of the moveable component 434. As the article 30 is moved towards the housing 430 of the nozzle block 430, the surface of the article 30 moves the moveable component 434 in the direction extending between the first end 431a of the filling nozzle 431 and the second end 431b of the filling nozzle 431, thereby exposing the first end 431a of the filling nozzle 431 and the first end 432a of the venting nozzle 432 and allowing the first end 431a of the filling nozzle 431 and the first end 432a of the venting nozzle 432 to engage with the article 30 as described above.

The nozzle block 430 illustrated in FIG. 9D comprises a biasing element 435. The biasing element 435 may be a spring, magnet, piston or any other form of element that can be configured to bias the movable component 434 such that a portion of the filling nozzle 431 and the portion of the venting nozzle 432 (such as the first end 431a of the filling nozzle 431 and the first end 432a of the venting nozzle 432 as described above) are enclosed by the moveable component 434 (and therefore the nozzle block 430). As described above, when the nozzle block 430 engages with the article 30, a surface of the article 30 can engage with a surface 434a of the moveable component 434. As the article 30 is moved towards the housing 430 of the nozzle block 430, the biasing force of the biasing element is overcome and the surface of the article 30 moves the moveable component 434, thereby exposing the first end 431a of the filling needle 431 and the first end 432a of the venting needle 432 as described above. When the article 30 no longer engages with the nozzle block 430, the biasing force of the basing element 435 moves the moveable component 434 back to its original position (illustrated in FIG. 9D) where a portion of the filling nozzle 431 and the portion of the venting nozzle 432 are enclosed by the moveable component 434.

Although not illustrated, the nozzle block 430 may also comprise an interlock configured to prevent the moveable component 434 being moved when the nozzle block 430 is separate from the refilling device 40. In other words, the interlock locks or otherwise fixes the moveable component 434 in position, such as the position of the moveable component 434 illustrated in FIG. 9D where a portion of the filling nozzle 431 (such as the first end 431a) and the portion of the venting nozzle 432 (such as the second end 432a) are enclosed by the moveable component 434. This prevents the first end 431a of the filling nozzle 431 and the first end 432a of the venting nozzle 432 from being exposed when the nozzle block 430 is separate or otherwise removed from the refilling device 40, thereby protecting the first end 431a of the filling nozzle 431 and the first end 432a of the venting nozzle 432 from damage or blockage. The interlock may comprise a latch, catch, hook or any other form of mechanical or magnetic fastening. The interlock can be located on the housing 430, for example the first flange 433a, such that the interlock engages with the moveable component 434 to prevent the moveable component 434 from moving. Alternatively, the interlock can be located on the moveable component 434 such that the interlock engages with housing 430 to prevent the moveable component 434 from moving, or a portion of the interlock may be located on the housing 434 and a corresponding portion of the interlock located on the moveable component.

The refilling device 40 can comprise a pin configured to engage with the interlock to allow the moveable component 434 to move. As described above, the refilling device 40 can comprise a nozzle block interface configured to receive the nozzle block 430. The pin can be located on or proximate to the nozzle block interface such that the pin engages with the interlock when the nozzle block 430 is received by the nozzle block interface. The pin interacts with the interlock to unlock the interlock, thereby allowing the moveable component 434 to move when the nozzle block 430 is located on or in the refilling device 40. For example, the pin may engage with a portion of the interlock which releases a latch, catch, or hook portion of the interlock. Alternatively, the pin may comprise a magnetic component which interacts with a magnetic component on the interlock to unlock the interlock. It will be appreciated, however, that the pin and interlock may comprise any suitable mechanical or magnetic components to perform the functionality described herein.

As illustrated in FIGS. 9A to 9D, the filling nozzle 431 is longer than the venting nozzle 432. In particular, as illustrated in FIGS. 9A and 9D, the first end 431a of the filling nozzle 431 extends further out of the housing 433 than the first end 432a of the venting nozzle 432 when at least a portion of the filling nozzle 431 and at least a portion of the venting nozzle 432 are exposed. As aerosol-generating material 52 is transferred from the reservoir 50 to the article 30, a droplet of aerosol-generating material forms at the first end 431a of the filling nozzle 431. This droplet needs to be kept clear of the venting nozzle 432 in order to ensure the droplet does not block the venting nozzle 432 and prevent air for flowing out of the article 30 and through the venting nozzle 432. Extending the first end 431a of the filling nozzle 431 further out of the housing 433 than the first end 432a of the venting nozzle 432 keeps the droplet clear of the venting nozzle 432. Having a separate filing nozzle 431 and venting nozzle 432 also means that the nozzles are separated from one another, which also mitigates the risk of the droplet blocking the venting nozzle 432.

The filling nozzle 431 illustrated in FIGS. 9A to 9D also has a larger internal diameter or cross-sectional area than the venting nozzle 432, since the aerosol-generating material 52 has a higher viscosity than air. For example, the filling nozzle 431 can be a 20 or 21 gauge needle whilst the venting nozzle 432 is a 23 gauge needle.

Although not illustrated in FIGS. 9A to 9D, the filling nozzle 431 and the venting nozzle 432 may be concentric. In other words, the filling nozzle 431 and the venting nozzle 432 share the same centerline such that one of the nozzles 431, 432 is located inside the other nozzle 431, 432. For example, the filling nozzle 431 can be located substantially inside the venting nozzle 432 such that the venting nozzle 432 surrounds the filling nozzle 431. A portion of the filling nozzle 431 can protrude from at least one of the ends of the venting nozzle 432 such that, as described above, the filling nozzle 431 is longer than the venting nozzle 432. The filling nozzle 431 and the venting nozzle 432 can be eccentric, such that one of the nozzles 431, 432 is located inside the other nozzle 431, 432, but offset from the centerline. Alternatively, as illustrated in FIGS. 9A to 9D, the filling nozzle 431 and the venting nozzle 432 may be two separate needles spaced apart from each other.

FIG. 6 is a flow chart of a method 600 of refilling an article 30, for example performed by the refilling control circuitry 48. The method begins at step 610, where the article 30 is received. At step 620 a reservoir 50 is received. At step 630, a filling nozzle 431 of a nozzle block 430 is engaged with the article 30 in response to the reservoir 50 engaging with the nozzle block 430. At step 640, the transfer of aerosol-generating material 52 from the reservoir 50 to the article 30 using the filling nozzle 431 is facilitated. At step 650, the transfer of air from the article 30 using a venting nozzle 432 of the nozzle block 430 is facilitated as aerosol-generating material 52 is transferred from the reservoir 50 to the article 30. The method then ends.

The method 600 illustrated in FIG. 6 may be stored as instructions on a computer readable storage medium, such that when the instructions are executed by a processor, the method 600 described above is performed. The computer readable storage medium may be non-transitory.

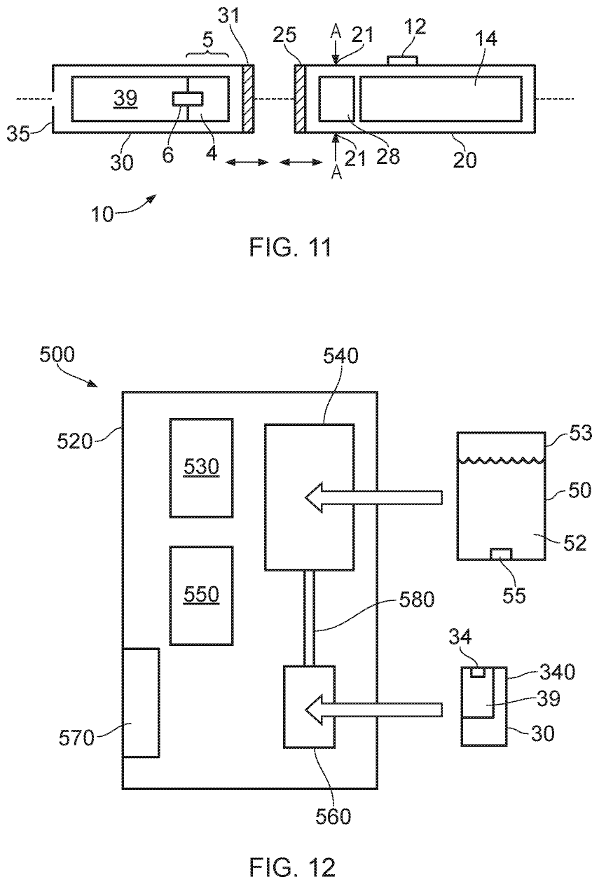

FIG. 11 is a highly schematic diagram (not to scale) of a generic example electronic aerosol/vapor provision system such as an e-cigarette 10, presented for the purpose of showing the relationship between the various parts of a typical system and explaining the general principles of operation. Note that the present disclosure is not limited to a system configured in this way, and features may be modified in accordance with the various alternatives and definitions described above and/or apparent to the skilled person. The e-cigarette 10 has a generally elongate shape in this example, extending along a longitudinal axis indicated by a dashed line, and comprises two main components, namely a device 20 (control or power component, section or unit), and an article or consumable 30 (cartridge assembly or section, sometimes referred to as a cartomiser, clearomiser or pod) carrying aerosol-generating material and operating to generate vapor/aerosol.

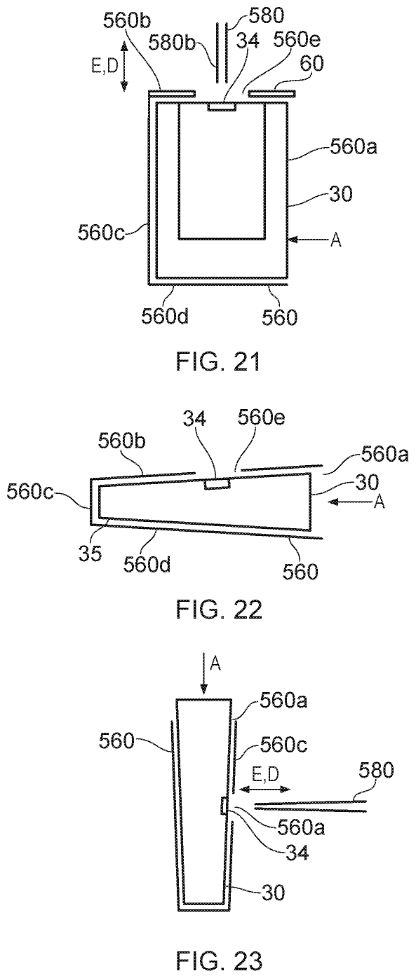

The article 30 includes a storage area such as a reservoir 39 for containing a source liquid or other aerosol-generating material comprising a formulation such as liquid or gel from which an aerosol is to be generated, for example containing nicotine. As an example, the source liquid may comprise around 1% to 3% nicotine and 50% glycerol, with the remainder comprising roughly equal measures of water and propylene glycol, and possibly also comprising other components, such as flavorings. Nicotine-free source liquid may also be used, such as to deliver flavoring. A solid substrate (not illustrated), such as a portion of tobacco or other flavor element through which vapor generated from the liquid is passed, may also be included. The reservoir 39 may have the form of a storage tank, being a container or receptacle in which source liquid can be stored such that the liquid is free to move and flow within the confines of the tank. In other examples, the storage area may comprise absorbent material (either inside a tank or similar, or positioned within the outer housing of the article) that holds the aerosol generating material. For a consumable article, the reservoir 39 may be sealed after filling during manufacture so as to be disposable after the source liquid is consumed. However, the present disclosure is relevant to refillable articles that have an inlet port, orifice or other opening (not shown in FIG. 21) through which new source liquid can be added to enable reuse of the article 30. The article 30 also comprises an aerosol generator 5, comprising in this example an aerosol generating component, which may have the form of an electrically powered heating element or heater 4 and an aerosol-generating material transfer component 6. The heater 4 is located externally of the reservoir 39 and is operable to generate the aerosol by vaporization of the source liquid by heating. The aerosol-generating material transfer component 6 is a transfer or delivery arrangement configured to deliver aerosol-generating material from the reservoir 39 to the heater 4. In some examples, it may have the form of a wick or other porous element. A wick 6 may have one or more parts located inside the reservoir 39, or otherwise be in fluid communication with liquid in the reservoir 39, so as to be able to absorb source liquid and transfer it by wicking or capillary action to other parts of the wick 6 that are adjacent or in contact with the heater 4. This liquid is thereby heated and vaporized, and replacement liquid drawn, via continuous capillary action, from the reservoir 39 for transfer to the heater 4 by the wick 6. The wick may be thought of as a conduit between the reservoir 39 and the heater 4 that delivers or transfers liquid from the reservoir to the heater. In some designs, the heater 4 and the aerosol-generating material transfer component 6 are unitary or monolithic, and formed from a same material that is able to be used for both liquid transfer and heating, such as a material which is both porous and conductive. In still other cases, the aerosol-generating material transfer component may operate other than by capillary action, such as by comprising an arrangement of one or more valves by which liquid may exit the reservoir 3 and be passed onto the heater 4.

A heater and wick (or similar) combination, referred to herein as an aerosol generator 5, may sometimes be termed an atomiser or atomiser assembly, and the reservoir with its source liquid plus the atomiser may be collectively referred to as an aerosol source. Various designs are possible, in which the parts may be differently arranged compared with the highly schematic representation of FIG. 11. For example, and as mentioned above, the wick 6 may be an entirely separate element from the heater 4, or the heater 4 may be configured to be porous and able to perform at least part of the wicking function directly (a metallic mesh, for example). In the present example, the system is an electronic system, and the heater 4 may comprise one or more electrical heating elements that operate by ohmic/resistive (Joule) heating, although inductive heating may also be used, in which case the heater comprises a susceptor in an induction heating arrangement. A heater of this type could be configured in line with the examples and embodiments described in more detail below. In general, therefore, an atomiser or aerosol generator, in the present context, can be considered as one or more elements that implement the functionality of a vapor-generating element able to generate vapor by heating source liquid (or other aerosol-generating material) delivered to it, and a liquid transport or delivery element able to deliver or transport liquid from a reservoir or similar liquid store to the vapor-generating element by a wicking action/capillary force or otherwise. An aerosol generator is typically housed in an article 30 of an aerosol generating system, as in FIG. 11, but in some examples, at least the heater part may be housed in the device 20. Embodiments of the disclosure are applicable to all and any such configurations which are consistent with the examples and description herein.

Returning to FIG. 11, the article 30 also includes a mouthpiece or mouthpiece portion 35 having an opening or air outlet through which a user may inhale the aerosol generated by the heater 4.

The device 20 includes a power source such as cell or battery 14 (referred to hereinafter as a battery, and which may or may not be re-chargeable) to provide electrical power for electrical components of the e-cigarette 10, in particular to operate the heater 4. Additionally, there is a controller (device control circuitry) 28 such as a printed circuit board and/or other electronics or circuitry for generally controlling the e-cigarette. The controller may include a processor programmed with software, which may be modifiable by a user of the system. The control electronics/circuitry 28 operates the heater 4 using power from the battery 14 when vapor is required. At this time, the user inhales on the system 10 via the mouthpiece 35, and air A enters through one or more air inlets 21 in the wall of the device 20 (air inlets may alternatively or additionally be located in the article 30). When the heater 4 is operated, it vaporizes source liquid delivered from the reservoir 39 by the aerosol-generating material transfer component 6 to generate the aerosol by entrainment of the vapor into the air flowing through the system, and this is then inhaled by the user through the opening in the mouthpiece 35. The aerosol is carried from the aerosol generator 5 to the mouthpiece 35 along one or more air channels (not shown) that connect the air inlets 21 to the aerosol generator 5 to the air outlet when a user inhales on the mouthpiece 35.

More generally, the controller 28 is suitably configured/programmed to control the operation of the aerosol provision system to provide functionality in accordance with embodiments and examples of the disclosure as described further herein, as well as for providing conventional operating functions of the aerosol provision system in line with established techniques for controlling such devices. The controller 28 may be considered to logically comprise various sub-units/circuitry elements associated with different aspects of the aerosol provision system's operation in accordance with the principles described herein and other conventional operating aspects of aerosol provision systems, such as display driving circuitry for systems that may include a user display (such as an screen or indicator) and user input detections via one or more user actuable controls 12. It will be appreciated that the functionality of the controller 28 can be provided in various different ways, for example using one or more suitably programmed programmable computers and/or one or more suitably configured application-specific integrated circuits/circuitry/chips/chipsets configured to provide the desired functionality.

The device 20 and the article 30 are separate connectable parts detachable from one another by separation in a direction parallel to the longitudinal axis, as indicated by the double-headed arrows in FIG. 11. The components 20, 30 are joined together when the system 10 is in use by cooperating engagement elements 25, 31 (for example, a screw or bayonet fitting) which provide mechanical and in some cases electrical connectivity between the device 20 and the article 30. Electrical connectivity is required if the heater 4 operates by ohmic heating, so that current can be passed through the heater 4 when it is connected to the battery 5. In systems that use inductive heating, electrical connectivity can be omitted if no parts requiring electrical power are located in the article 30. An inductive work coil can be housed in the device 20 and supplied with power from the battery 14, and the article 30 and the device 20 shaped so that when they are connected, there is an appropriate exposure of the heater 4 to flux generated by the coil for the purpose of generating current flow in the material of the heater. The FIG. 11 design is merely an example arrangement, and the various parts and features may be differently distributed between the device 20 and the article 30, and other components and elements may be included. The two sections may connect together end-to-end in a longitudinal configuration as in FIG. 11, or in a different configuration such as a parallel, side-by-side arrangement. The system may or may not be generally cylindrical and/or have a generally longitudinal shape. Either or both sections or components may be intended to be disposed of and replaced when exhausted, or be intended for multiple uses enabled by actions such as refilling the reservoir and recharging the battery. In other examples, the system 10 may be unitary, in that the parts of the device 20 and the article 30 are comprised in a single housing and cannot be separated. Embodiments and examples of the present disclosure are applicable to any of these configurations and other configurations of which the skilled person will be aware.

The present disclosure relates to the refilling of a storage area for aerosol generating material in an aerosol provision system, whereby a user is enabled to conveniently provide a system with fresh aerosol generating material when a previous stored quantity has been used up. It is proposed that this be done automatically, by provision of apparatus which is termed herein a refilling device, refilling unit, refilling station, or simply dock. The refilling device is configured to receive an aerosol provision system, or more conveniently, the article from an aerosol provision system having a storage area which is empty or only partly full, plus a larger reservoir holding aerosol generating material. A fluid communication flow path is established between the reservoir and the storage area, and a controller in the refilling device controls a transfer mechanism or arrangement operable to move aerosol generating material along the flow path from the reservoir to the storage area. The transfer mechanism can be activated in response to user input of a refill request to the refilling device, or activation may be automatic in response to a particular state or condition of the refilling device detected by the controller. For example, if both an article and a reservoir are correctly positioned inside the refilling unit, refilling may be carried out. Once the storage area is replenished with a desired quantity of aerosol generating material (the storage area is filled or a user specified quantity of material has been transferred to the article, for example), the transfer mechanism is deactivated, and transfer ceases. Alternatively, the transfer mechanism may be configured to automatically dispense a fixed quantity of aerosol generating material in response to activation by the controller, such as the fixed quantity matching the capacity of the storage area.

FIG. 12 shows a highly schematic representation of an example refilling device. The refilling device is shown in a simplified form only, to illustrate various elements and their relationship to one another. More particular features of one or more of the elements with which the present disclosure is concerned will be described in more detail below.

The refilling device 500 will be referred to hereinafter for convenience as a “dock”. This term is applicable since a reservoir and an article are received or “docked” in the refilling device during use. The dock 500 comprises an outer housing 520. The dock 500 is expected to be useful for refilling of articles in the home or workplace (rather than being a portable device or a commercial device, although these options are not excluded). Therefore, the outer housing, made for example from metal, plastics or glass, may be designed to have an pleasing outward appearance such as to make it suitable for permanent and convenient access, such as on a shelf, desk, table or counter. It may be any size suitable for accommodating the various elements described herein, such as having dimensions between about 10 cm and 20 cm, although smaller or larger sizes may be preferred. Inside the housing 500 are defined two cavities or ports 540, 560. A first port 540 is shaped and dimensioned to receive and interface with a reservoir 50. The first or reservoir port 540 is configured to enable an interface between the reservoir 50 and the dock 500, so might alternatively be termed a reservoir interface. Primarily, the reservoir interface is for moving aerosol generating material out of the reservoir 50, but in some cases the interface may enable additional functions, such as electrical contacts and sensing capabilities for communication between the reservoir 50 and the dock 500 and determining characteristics and features of the reservoir 50.

The reservoir 50 comprises a wall or housing 53 that defines a storage space for holding aerosol generating material 52. The volume of the storage space is large enough to accommodate many or several times the storage area of an article intended to be refilled in the dock 500. A user can therefore purchase a filled reservoir of their preferred aerosol generating material (flavor, strength, brand, etc.), and use it to refill an article multiple times. A user could acquire several reservoirs 50 of different aerosol generating materials, so as to have a convenient choice available when refilling an article. The reservoir 50 includes an outlet orifice or opening 55 by which the aerosol generating material 52 can pass out of the reservoir 50. In the current context, the aerosol generating material 52 has a liquid form or a gel form, so may be considered as aerosol generating fluid. The term “fluid” may be used herein for convenience to refer to either a liquid or a gel material; where the term “liquid” is used herein, it should be similarly understood as referring to a liquid or a gel material, unless the context makes it clear that only liquid is intended.

A second port 560 defined inside the housing is shaped and dimensioned to receive and interface with an article 30. The second or article port 560 is configured to enable an interface between the article 30 and the dock 500, so might alternatively be termed an article interface. Primarily, the article interface 560 is for receiving aerosol generating material into the article 30, but in some cases the interface may enable additional functions, such as electrical contacts and sensing capabilities for communication between the article 30 and the dock 500 and determining characteristics and features of the reservoir 30.

The article 30 itself comprises a wall or housing 340 that has within it (but possibly not occupying all the space within the wall 340) a storage area 39 for holding aerosol generating material. The volume of the storage area 39 is many or several times smaller than the volume of the reservoir 50, so that the article 30 can be refilled multiple times from a single reservoir 50. The article 30 also includes an inlet orifice or opening 34 by which aerosol generating material can enter the storage area 39. Various other elements may be included within the article 30, as discussed above with regard to FIG. 11. For convenience, the article 30 may be referred to hereinafter as a pod 30.

The housing 520 of the dock 500 also accommodates a fluid conduit 580, defining a fluid passage or fluid flow path by which the reservoir 50 and the storage area 39 of the article 30 are placed in fluid communication, so that aerosol generating material can move from the reservoir 50 to the article 30 when both the reservoir 50 and the article 30 are correctly positioned in the dock 500. Placement of the reservoir 50 and the article 30 into the dock 500 locates and engages them such that the fluid conduit 580 is connected between the outlet orifice 55 of the reservoir 50 and the inlet orifice 34 of the article 30. Note that in some examples, all or part of the fluid conduit 580 may be formed by parts of the reservoir 50 and/or the article 30, so that the fluid conduit 580 is created and defined only when the reservoir 50 and/or the article 30 are placed in the dock 500. In other cases, the fluid conduit 580 may be a fluid flow path defined within a body of the dock 520, to each end of which the respective orifices are engaged.

Access to the reservoir port 540 and the article port 560 can be by any convenient means. Apertures may be provided in the housing 520 of the dock 500, through which the reservoir 50 and the article 30 can be placed or pushed. Doors or the like may be included to cover the apertures, which might be required to be placed in a closed state to allow refilling to take place. Doors, hatches and other hinged coverings, or sliding access elements such as drawers or trays, might include shaped tracks, slots or recesses to receive and hold the reservoir 50 or the article 30, which bring the reservoir 50 or the article 30 into proper alignment inside the housing when the door etc. is closed. These and other alternatives will be apparent to the skilled person, and do not affect the scope of the present disclosure.

The dock 500 also includes an aerosol generating material (“liquid” or “fluid”) transfer mechanism, arrangement, apparatus or means 530, operable to move or cause the movement of fluid out of the reservoir 50, along the conduit 580 and into the article 30. Various options are contemplated for the transfer mechanism 530.

A controller 550 is also included in the dock 500, which is operable to control components of the dock 500, in particular to generate and send control signals to operate the transfer mechanism 530. As noted, this may be in response to a user input, such as actuation of a button or switch (not shown) on the housing 520, or automatically in response to both the reservoir 50 and the article 30 being detected as present inside their respective ports 540, 560. The controller 550 may therefore be communication with contacts and/or sensors (not shown) at the ports 540, 560 in order to obtain data from the ports and/or the reservoir 50 and article 30 that can be used in the generation of control signals for operating the transfer mechanism 530. The controller 550 may comprise a microcontroller, a microprocessor, or any configuration of circuitry, hardware, firmware or software as preferred; various options will be apparent to the skilled person.

Finally, the dock 500 includes a power source 570 to provide electrical power for the controller 550, and any other electrical components that may be included in the dock, such as sensors, user inputs such as switches, buttons or touch panels, and display elements such as light emitting diodes and display screens to convey information about the dock's operation and status to the user. Also, the transfer mechanism 530 may be electrically powered. Since the dock may be for permanent location in a house or office, the power source 570 may comprise a socket for connection of an electrical mains cable to the dock 500, so that the dock 500 may be “plugged in”. Alternatively, the power source may comprise one or more batteries, which might be replicable or rechargeable, in which case a socket connection for a charging cable can be included.

Further details relating to the article interface or article port will now be described.

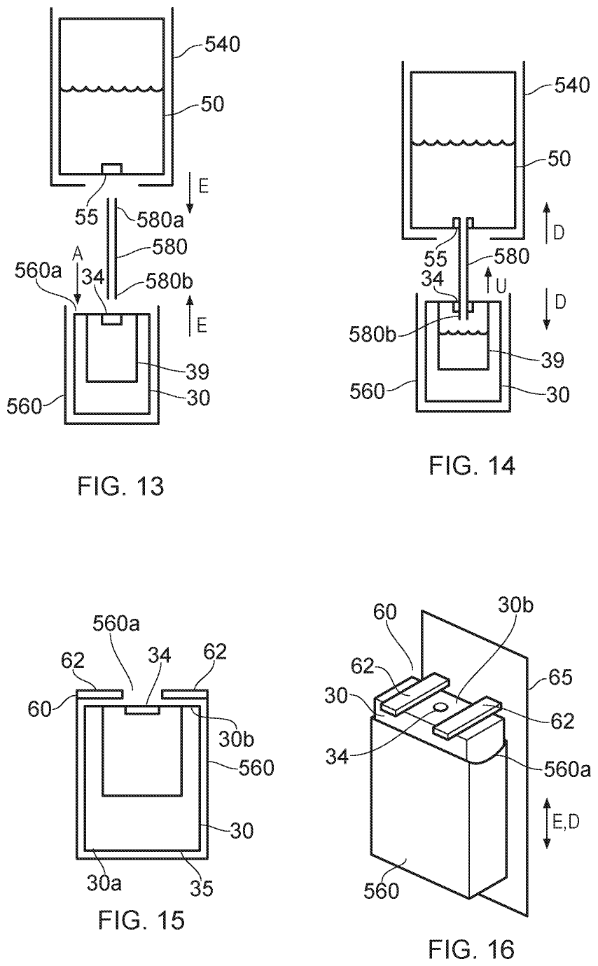

FIG. 13 shows a highly schematic and not to scale representation of part of the interior of a refilling device such as the example in FIG. 12. A reservoir 50 is received in the reservoir interface 540 of the refilling device. An article 30 is received in the article interface 560 of the refilling device, by being inserted through an opening 560a (in this example an open top side) in the article interface along an insertion direction A (which is in this example is vertical). In this example, the reservoir 50 is arranged above the article 30, so that gravity can aid movement of fluid from the reservoir 50 to the article 30, but this is not essential. A fluid conduit 580 defining a fluid flow path is arranged between the outlet orifice 55 of the reservoir 50 and the inlet orifice 34 of the article 30. In this example the fluid conduit 580 comprises a nozzle or needle mounted, held or located inside the refilling device. The fluid conduit 580 is substantially straight and arranged vertically in this example, by which is meant that the longitudinal axis and longitudinal extent of the fluid conduit lies along the vertical direction, and the direction of fluid flow through the fluid conduit will be along the vertical direction, in this case in a downward direction since the reservoir 50 is above the article 30. The fluid conduit 580 comprises a first end 580a which in this example is the upper end, and which is configured to engage with the outlet orifice 55 of the reservoir 50, so is an inlet or intake end of the fluid conduit 58 by which fluid goes into the fluid conduit 580. At the lower end of the fluid conduit 580 is its second end 580b, which is configured to engage with the inlet orifice 34 of the article 30 so is an outlet or delivery end of the fluid conduit 580 by which fluid leaves the fluid conduit 580 and is delivered into the storage area 39 of the article 30.

When both the reservoir 50 and the article 30 are installed, inserted into or otherwise received in their respective interfaces 540, 560, relative movement or relative motion between the reservoir interface 50 and the article interface 30 is caused in order to connect or engage the fluid conduit 580 with the reservoir outlet orifice 55 and the article inlet orifice 34 to create a continuous fluid flow path for refilling. The relative movement is produced by operation of the refilling device by any convenient technique, which is outside the scope of the present disclosure. In this example, the relative movement is along the direction(s) of the arrows E, aligned with the longitudinal axis of the fluid conduit 580 and hence vertical. The relative movement may comprise any or all of movement of the article interface 560 to take the article 30 closer to the fluid conduit 580, movement of the fluid conduit 580 to take the fluid conduit closer to the article 30, movement of the fluid conduit 580 to take the fluid conduit 580 closer to the reservoir 50 and movement of the reservoir interface 540 to take the reservoir closer to the fluid conduit 580. The relative movement acts to engage the fluid conduit 580 with the reservoir 50 and the article 30. The inlet end 580a of the fluid conduit 55 is coupled to the outlet orifice 55 of the reservoir 50 by any suitable approach (outside the scope of the present disclosure). The outlet end 580b of the fluid conduit 580 is engaged with the inlet orifice 34 of the article 30, in this example by penetrating the inlet orifice 34 to reach into the interior of the storage area 39. The outlet end 580b enters through the inlet orifice 34 along the direction of the relative movement E, being in this case along the longitudinal axis of the fluid conduit 580 at at least the outlet end 580b.

Note that in other examples, the fluid conduit 580 may be provided as an integral part of the reservoir 50, so the relative movement is only for the purpose of inserting the outlet end 580b of the fluid conduit 580 into the inlet orifice 34 of the article 30, coupling of the inlet end 580a and the reservoir outlet orifice 55 not being required, as already existing in situ.

FIG. 14 shows the components of FIG. 13 in an engaged or coupled condition following relative movement along the direction E to connect the reservoir 50, the fluid conduit 580 and the article 30 and define the fluid flow path. Once engaged, the refilling device operates the fluid transfer mechanism 530 (see FIG. 2) to perform a refilling action by which fluid is transferred from the reservoir 50 to the storage area 39 of the article 30 by being moved along the fluid flow path. The details of the refilling action are outside the scope of the present disclosure. When the transfer of fluid is complete, in that a required quantity of fluid has been delivered into the storage volume, the refilling action is concluded by the engaging relative movement(s) E between the reservoir interface 540 and the article interface 560 (possible also including movement of the fluid conduit 580) being reversed along an opposite direction or directions D, which are therefore also vertical, in order to decouple, disengage or disconnect the components. Once the components are restored to their uncoupled arrangement as in FIG. 23, the article 30 can be removed from the article interface 560 ready for reuse in an aerosol provision system.

In particular, the disconnecting relative movement D includes the withdrawal of the outlet end 580 of the fluid conduit 580 from the inlet orifice 34 of the article 30, by moving the article interface 560 and the fluid conduit 580 apart from one another to carry the article 30 away from the outlet end 580b. This may be by movement of either or both the article interface 560 and the fluid conduit 580, to disengage the article 30 and the fluid conduit 580. Note that in this example, the coupling movement E and decoupling movement D are parallel to the insertion direction A.

While the inlet orifice 34 of the article 30 can be configured in any suitable way to enable coupling with the outlet end 580a of the fluid conduit in a way that creates fluid communication to define the fluid flow path, in some configurations the outer surface of the outlet end 580a will be in contact with the inlet orifice 34. For example, the outlet end 580b, which may be configured as a relatively fine or narrow nozzle or hollow needle, may pierce or otherwise penetrate a valve or membrane that otherwise closes the inlet orifice 34 to seal the storage area and prevent leaks when the article 30 is not being refilled in the refilling device. The contact between the outlet end 580a and the inlet orifice 34 may have some frictional force associated with it, that needs to be overcome when withdrawing the outlet end 580b out from the inlet orifice 34 and/or pulling the inlet orifice 34 off the outlet end 580b (depending on the nature of the relative movement D). It may be that the mass of the filled article 30, newly replenished with fluid, is sufficient to overcome the friction, since in the depicted orientation, gravity acts along the same downward direction as the relative movement D that takes the article away from the fluid conduit. In such a case, the outlet end 580a is smoothly withdrawn from the inlet orifice 34 during the relative movement D. In other cases, however, gravity may be insufficient to overcome friction at the inlet orifice (or the relative movement may not be along the vertical direction with the article lowermost). If this is the situation, it may be that the inlet orifice 34 remains gripped around the outlet end 580b so that article 30 stays coupled to the fluid conduit 580 and leaves its seat in the article interface 560. Depending on the nature of the relative movement, the fluid conduit 580 may pull or draw the article 30 out of the article interface 560 (in an upward direction, in the depicted orientation) since in this example the coupling/decoupling direction E, D are parallel to the insertion direction A, or the article interface 560 may fail to carry the article 30 with it away from the fluid conduit 580, leaving the article 30 in the connected state. In either case, there is relative movement of the article 30 out of its article interface 560, which in the depicted orientation is effectively in the upward direction U.

This failure to decouple or disconnect may happen only briefly or momentarily, so that the article 30 does then decouple. In the depicted orientation, the article 30 will then drop under gravity back into the article interface 560, which could cause damage. In a different orientation, the article 30 may remain partially out of the article interface 560 which may interfere with removal of the refilled article 30 from the refilling device by the user. The failure to decouple alternatively may be permanent, which will entirely prevent removal of the refilled article 30 from the refilling device, and may cause damage to the fluid conduit 580 in the attempt.

Accordingly, it is proposed to include a retainer or retainer means or retaining means in the refilling device which engages with an article received in the article interface so as to retain the article in its received position in the article interface during at least a part of the refilling action. With regard to the issue noted above, of friction impeding disconnection of the article from the fluid conduit, the part of the refilling action comprises the decoupling relative movement that separates or disengages the article from the fluid conduit by moving the article interface and the fluid conduit apart from one another. Other examples are discussed later.

In refilling docks in which the article interface moves to wholly or partly achieve the required relative movement to make and break the fluid flow path, the retainer may be comprised in or as part of the article interface so as to move together with the article interface in fixed relative positions. A similar effect may be achieved by mounting both the article interface and the retainer on a common moveable mount, such as a bracket or carriage, whereby the moveable mount is moved to provide the relative movement. In other configurations, the retainer may be affixed otherwise in the interior of the refilling device so as to cooperate with the article interface in a manner that provides engagement with a received article. This may be convenient if the article interface does not move during the relative movement, so that the retainer need not move either to maintain its position relative to the article interface. Alternatively, movement of both the article interface and retainer may be achieved via mounting of these components on different moving parts of the refilling device. Other arrangements are not excluded, however.

FIG. 15 shows a highly schematic representation of an article interface according to an example. The article interface 560 (which is comprised in a refilling device, not shown) defines and provides a space into which an article 30 can be received for refilling. The article interface 560 has a generally open side 560a, in this example being its top or upper side, through which the article 30 is inserted in order to be received in the article interface 560. The article interface 560 has associated with it a retainer 60, comprising a pair (or one or more than two) of retaining elements 62. When the article 30 is in the article interface, the retainer 60 acts to engage with the article 30 to retain it. This is achieved by the retainer 60 extending over at least part of the open side (or more generally, an opening in a side of the article interface) of the article interface 560, over the article 30, so as to prevent the article 30 being withdrawn from the article interface 560. So, in this example, the article 30 is placed in the article interface 560 by a first end 30a of the article 30 being inserted through the opening so the article 30 can be pushed or slid into the article interface 560 until in the received position (note that all of the article 30 may be contained in the article interface 560 as in FIG. 15, or just part of the article 30). A second end 30b of the article 30 opposite to the first end 30a is engaged by the retainer 60, blocking movement of the article 30 back out of the article interface 560 via the open side 560a. In this example, the first end of the article 30a is lowermost or at the bottom, and the second end 30b is uppermost or at the top. Comparison with FIG. 14 shows that the retainer 60 will prevent or at least inhibit any movement of the article 30 out of the article interface 560 in the direction U. The retainer 60 abuts the article 30 and can overcome any frictional force arising between the article's inlet orifice 32 and the inserted fluid conduit first end 580a, allowing the fluid conduit 580 to be pulled out of the inlet orifice 32 to separate the article 30 from the fluid flow channel. The retainer 60 exerts a force on the article 30 that acts downwardly into the article interface 560 and opposite to the direction U, out of the article interface, in which the article would otherwise be able to move. Options for positioning the retainer 60 in an engaging relationship with the article 30, in this and other configurations, are described further below.

The article 30 may be configured with its inlet orifice for refilling located in any desired or preferred position. However, if the mouthpiece 35 of the article (see FIG. 11) is located at the first end 30a of the article, a convenient configuration is for the opposite second end 30b to define a refilling end in which or at which the inlet orifice 34 is located. For example the inlet orifice 34 may be formed in an end wall of the article 30 at the refilling end 30b. When the article 30 is coupled with a device component to form an aerosol provision system, the end wall will be covered by the device component, and the inlet orifice 34 is protected, such as from tampering and ingress of foreign particles or moisture, for example. Hence, in the depicted example, the article interface 560 is configured to receive the article 30 by the mouthpiece or mouthpiece end 35 of the article 30 being inserted first so as to end up at the bottom of the article interface 560 when the article 30 is received, while the inlet orifice 32 in the opposite refilling end 30b of the article 30 becomes uppermost, and exposed via the opening or open side 560a. Typically, an article 30 may have, as depicted, a generally elongate overall exterior shape with a longitudinal axis, the mouthpiece 35 being at one end. So, in this example, the inlet orifice 34 is at the opposite end of the article 30 as defined by the longitudinal axis, and the article 30 is received in the article interface 560 with its elongate axis substantially vertical (or near-vertical). The retainer 60 engages the article 30 over the refilling end 30b, leaving the inlet orifice 34 accessible for connection to the fluid conduit 580. In this example, this is achieved by one retaining element 62 at each side of the article interface 560, with the centrally located inlet orifice 34 between the retaining elements 62. This provides a symmetrical arrangement in which the retainer 60 can overcome friction at the inlet orifice in a balanced manner, avoiding or reducing sideways forces that could damage the fluid conduit. Other relative configurations between the inlet orifice 34, and the article 30 more generally, and the retainer 60 are possible however, and will be apparent to the skilled person.

FIG. 16 shows a highly schematic and simplified perspective view of an example article interface with a cooperating retainer. The article interface 560 is a cavity formed by side walls, with an opening 560a at its top end through which an article 30 can be inserted so as to be received in a generally vertical orientation, as already described. The article 30 is inserted with its refilling end 30b uppermost, as before. The article interface 560 extends outwardly from a vertically oriented supporting plate or mount 65, which is assembled inside a refilling device (not shown) for relative movement E, D of the article interface 560 to bring an inlet orifice 34 on the refilling end 30b to and from a fluid conduit 580 (not shown). A retainer 60 is provided, which in this example comprises two retaining elements 62 in the form of protruding arms which also extend or protrude from the supporting plate 65, at a location above the article interface 560 so as to engage over the refilling end 30b of the article 30 when the article 30 is received in the article interface. The arms 62, which are parallel in this example, are located one at each side of the article interface 560 so as to be also one at each side of the inlet orifice 32 of the received article 30.

The supporting plate or mount 65 may be considered as a separate component on which the article interface 560 and the arms 62 are fixed in position. Movement of the mount 65 also causes movement of the article interface 560 and the arms 62 so they retain their positions relative to each other to retain the article 30 during refilling. The form of the mount 65 and the method by which it is moved is outside the scope of the disclosure. Alternatively, the arms 62 may be considered as being a part of the article interface 560, and could be fixed directly onto the article interface, or via the mount 65 where this can also be considered as part of the article interface in some examples.

In order to engage the retainer appropriately with the article in configurations such as those of FIGS. 15 and 16 where the retainer is associated with the open side of the article interface through which the article is inserted, some movement may be provided in one or both of the article interface and the retainer in order to facilitate insertion of the article into the article interface through the open side. In a simple example, the retainer may comprise one or more arms which are attached to the article interface by a rotatable or swivelling junction or connection by which they can be manually moved by the user between a position in which the opening in the article interface is not obstructed and the article can be inserted, and a position which engages the retainer over the article to retain the article in the article interface. However, an arrangement such as this, which requires user operation, also requires the user to remember to engage the retainer after inserted the article, and the action may be omitted by accident, or deliberately, for example to save time.

Accordingly, it is alternatively proposed that the engagement is achieved by configuring the article interface to be moveable between a first position in which the article can be inserted into the article interface, and a second position in which the retainer acts to retain the article in the article interface. Movement from the first position to the second position bring the article and the retainer into engagement, and locates the article and the article interface for coupling to the fluid conduit and the fluid flow path thereby formed. After the refilling action, the article is no longer coupled to the fluid conduit, and movement of the article interface from the second position back the first position disengages the article from the retainer, and frees the article ready for removal from the article interface.

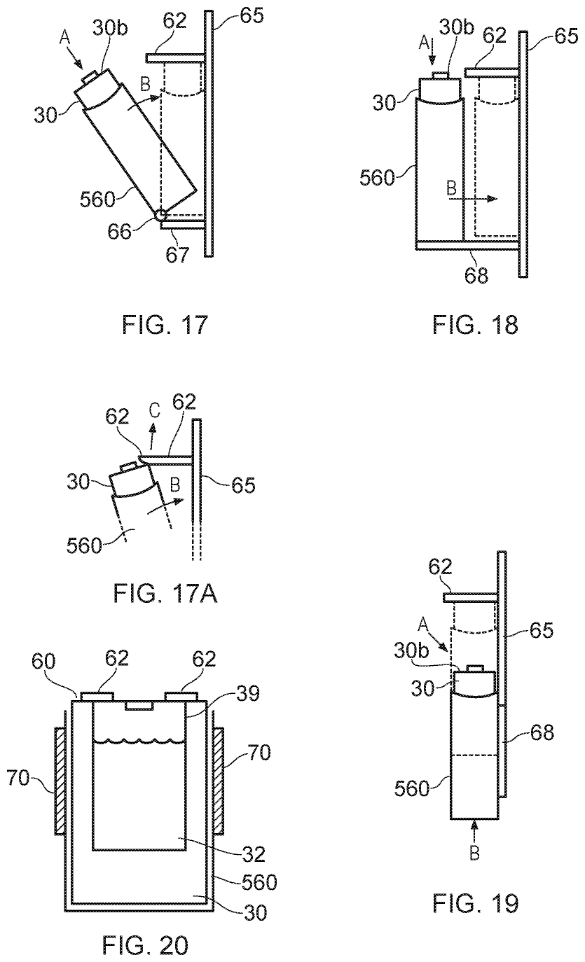

FIG. 17 shows a simplified schematic side view of an article interface according to one example that provides movement for engagement and disengagement. The article interface 56 is again fixed to a planar upright supporting plate or mount 65, as in FIG. 16. The retainer in the form of one or more arms 62 extends from the mount 65 above the article interface 560, as before. The article interface 560 is attached at its lower end to the mount 65 by a pivot or hinge 66 at an outer edge (away from the mount 65) of a shelf or base element 67 which extends from the mount 65 under the article interface 560. A first position of the article interface 560 is shown in solid lines, in which the article interface is rotated or pivoted outwardly away from the mount 65 and the arms 62. In the first position, the opening 560a at the upper end of the article interface 560 is exposed, and the article 30 can be inserted by the user into the article interface 560 in the direction A. Once the article 30 is received, the article interface 560 can be moved, for example by a rearwards pushing action from the user, in a pivoting motion in the direction B, by rotating about the pivot 66 towards the mount 65 to place the article interface in a vertical position against the mount 65. This is the second position, shown by dashed lines. In so doing, the exposed refilling end 30b of the article 30 passes under the protruding arms 62 so that the arms 62 become engaged across the end 30b of the article 30. Pulling the article interface 560 forwards reverses the pivoting motion and returns the article interface to the first position from which the article 30 can be removed.

The arms 62, or other shape or form of retainer, may be configured to facilitate the article sliding beneath the arms into the second position. As an example, the arms 62 may be rigidly fixed on the mount 65, but may be designed to allow some flexing in an upward direction under pressure from below. Hence, when the article 30 contacts the arms 62 during movement to the second position, the article 30 pushes somewhat upwardly on the underside of the arms 62, which can yield and provide a small displacement to give clearance for the article to pass underneath and into the second position. The arms 62 can be described as being resiliently flexible, in that they have sufficient rigidity to maintain their shape when not pressured, but flex and bend when pressed, returning to their original shape and position when the pressure is removed. This can also allow the arms 62 to actively press down upon the article 30 in the article interface 560 in the second position, if the arms are appropriately located. The article 30 is thereby very securely retained in the article interface 560. The resilient flexibility can be provided by forming the arms from a suitable material such as a plastics or rubber or rubberised material, or metal. The arms 62 may be shaped to provide or enhance the properties, such as suitable thin metal. The outer ends 62 of the arms 62, remote from the mount 65, may be slightly upwardly curved or chamfered to provide a larger clearance for the leading edge of the inwardly pivoting article 30 to pass under the arms 62 and make the required contact for upward displacement C of the arms 62. This is depicted in FIG. 17A. In another example, the arms 62 may be rigid themselves, but made resilient flexible by non-rigid attachment to the mount 62, by a sprung or spring-loaded hinge or similar mounting that gives the required upward displacement when pressed from the underside but is biased in the downward direction, towards the article when in the article interface in the second position. More generally, these examples and others which may be apparent to the skilled person provide arms which are resilient flexible so as to have a biased displacement away from the position in which they engage with the article to enable the article to be engaged with the arms, the biasing acting to restore the displaced arms towards the engage position.

FIG. 18 shows a simplified schematic side view of an article interface according to another example that provides movement for engagement and disengagement of the article and the retainer. In this example, the pivoting motion of the FIG. 17 example is replaced with a linear sliding motion. The article interface 560 is slidably mounted on tracks 68 or similar which extend perpendicularly (horizontally as depicted) from the mount 65, the article interface 560 extending vertically upwardly from the tracks 68. The article interface 560 can be pulled along the tracks 68 away from the mount 65 along the direction of the tracks 68, to a first position shown in solid lines in which the article 30 can be inserted into the article interface 560 in the direction A. The article interface 560 is then pushed along the tracks towards the mount 65 in the direction B to reach the second position (shown in dashed lines), the upper surface of the refilling end 30b sliding under the arms 62 forming the retainer.

FIG. 19 shows a simplified schematic side view of an article interface according to further example that provides movement for engagement and disengagement of the article and the retainer. As in the FIG. 18 example, the movement between the first and second positions is provided by a linear sliding motion. Again, the article interface 560 is slidably mounted on tracks 68 or similar along which the article interface can slide. In this example, however, the tracks extend in or parallel to the plane of the mount 65, to support the article interface for 560 for movement parallel to the plane of the mount, towards and away from the underside of the arms 62, the underside being the surface of the arms which engages with the article. The article interface 560 can be pulled downwardly along the tracks 68 away from the arms 62, to a first position shown in solid lines in which the article 30 can be inserted into the article interface 56 in the direction A. To avoid the need for a large movement away from the arms to achieve enough clearance for insertion of the article 30, some or all of the front wall (the side remote from the mount 65) of the article interface 560 may be absent to provide a larger insertion opening for insertion along an angle to the sliding direction. The article interface 560 is then pushed upwards along the tracks 68 towards the arms 62 in the direction B to reach the second position (shown in dashed lines), the upper surface of the refilling end 30b being brought into contact or near-contact with the underside of the arms 62 forming the retainer.

FIGS. 17-19 are examples only; other arrangements for engaging an article received in an article interface with a retainer may alternatively be used.

As noted above, the retainer may be configured such that the article is actively pushed into the article interface, or otherwise retained sufficiently securely that close contact is made between at least some of the outer surface of the article and the inner surface of the article interface. This can allow the retention to be utilized during other parts of a refilling action, other than the decoupling from the fluid flow path described above. As mentioned with regard to FIG. 12, the article interface may include one or more sensors or detectors by which properties or characteristics of the article may be measured, detected or monitored by the controller of the refilling device when the article is received in the article interface. Alternatively or additionally, the article may itself include part or all of one or more such sensors, and the article interface may include one or more electrical contacts that connect with electrical contacts on the article when the article is received in the article interface, by which the controller can interrogate the one or more sensors. Alternatively, the electrical contacts may allow the controller to electrically communicate with (sending or receiving signals for example) with components in the article. In such arrangements, the retainer can operate to push, press or securely hold the article in the article holder so as to make good, close or secure contact between relevant parts of the article and sensors parts or electrical contacts arranged in the article interface. More generally, the action of the retainer may be to locate the article within the article interface such that the sensor or connection can properly function or be operated.

FIG. 20 shows a simplified schematic representation of an example article interface configured in this way. As before, the article interface 560 receives an article 30 with a storage area 39, and a retainer 60 comprised in or otherwise associated with the article interface 560 retains the article 30 inside the article interface. A gap is shown between the article and the article interface; this is for clarity since in reality an aim of the retainer may be to ensure good contact between the article and the article interface. The article interface 56 has components of a sensor 70 on its inner surface, located so as to be operable to measure or determine characteristics of the article 30. The sensor 70 is under the control of the controller in the refilling device, via suitable electrical connections (none of which are shown). As an example, the sensor 70 may comprises a pair of capacitor plates comprised in a capacitive sensor operable to detect fluid 32 in the storage area 39, by which the presence or absence of fluid 32 can be determined, or the level or amount of fluid 32 may be determined. The results of these determinations can be used by the controller to control the fluid transfer mechanism so that an appropriate amount of fluid is delivered into the storage area 39. A more accurate capacitance reading may be obtained if gaps between the article 30 and the capacitor plates are reduced or eliminated; this can be achieved by the retainer 60. Capacitance measurements can also be carried out by the controller to determine when an article is present in the article interface 560, again for use in controlling the fluid transfer mechanism. Similar measurements can also be achieved using other types of sensor or detector.

In the examples described thus far, the retainer has been located so as to extend over at least part of the opening of the article interface through which the article is inserted in order to be received in the article interface, once the article has been duly inserted. The retainer therefore acts to prevent the article from being removed from the article interface via the opening. In arrangements where the inlet orifice is located on a side or face of the article housing which is exposed through (or protrudes from) the opening, the retainer is therefore placed to act against any outward movement of the article when the fluid conduit is being decoupled from the inlet orifice, so that the article is retained in the article interface and decoupling is achieved smoothly. In such arrangements, the opening is used both for the article to access the article interface, and for the fluid conduit to access the inlet orifice. As has been described, however, one or more movable or flexible parts are generally required in order for the retainer to be displaced to allow access for the article into the article interface through the opening.

However, alternative configurations are possible. For example, the opening may be provided only for insertion of the article into the article interface and removal of the article from the article interface after a refilling action is complete. A dedicated aperture in a wall of the article interface is additionally provided through which the fluid conduit can be engaged or coupled with the inlet orifice. The aperture is separate from the opening. The wall around the aperture acts as the retainer, and prevents the article from being pulled out of the article interface during decoupling of the fluid conduit and the article interface, in the event of friction preventing a smooth withdrawal.

FIG. 21 shows a simplified schematic cross-sectional view of an article interface configured in this way. The article interface 560 is defined by various walls to form a space that receives the article 30. In particular, there are one or more side walls 560c, a base or lower wall 560d and a top or upper wall 560b. On one side there is no side wall, in order to provide an opening 560a through which the article 30 can be inserted along an insertion direction A (and removed along the opposite direction after a refilling action has been completed). In this example, the insertion direction A is horizontal. However, in contrast with previous examples, the article interface 560 is shaped to receive the article 30 in an orientation in which the inlet orifice 34 is not on the face of the article which is exposed through the opening 560a. Rather, the inlet orifice 34 is on a different face of the article, in this example the face which is uppermost when the article is inserted. Accordingly, to allow engagement with the fluid conduit 580, the top wall 560b of the article interface 560 has an aperture 560e formed therein, located such that the inlet orifice 34 is accessible through the aperture 560e when the article 30 is fully inserted and correctly located in the article interface 560. Relative movement between the article interface 560 and the fluid conduit 580 can then be performed as previously described, in order to couple the inlet orifice 34 and the fluid conduit 580 along an engagement direction E and decouple them along the opposite disengagement direction D. In this example, these directions are substantially vertical, and more generally are non-parallel to the horizontal insertion direction A. Accordingly, the upper wall 560b of the article interface 560 acts to retain the article 30 inside the article interface 560 during decoupling of the fluid conduit 580 and the inlet orifice 34; the wall prevents any movement of the article along the decoupling direction, and allows the fluid conduit 58 to be withdrawn from the inlet orifice 34. Hence, in this configuration, the retainer 60 comprises the wall 560b of the article interface 560 in which an access aperture 560e for the inlet orifice 34 is defined.

In many designs of aerosol provision system, the article will have an elongated shape, in that one of its dimensions (length) will be a longest dimension greater than (typically appreciably greater than) the two orthogonal dimensions (width and breadth). Hence, the article can be said to have a longitudinal axis, extending along this longest dimension, and defining two ends of the article, at opposite ends of the longest dimension. Typically, the mouthpiece of the article will be at one of these ends, and the opposite end will be where the article is connected to a device to form the complete aerosol provision system.

In the examples described so far, the article interface has been configured to receive the article in an orientation where the longitudinal axis of the article is vertical. The article may be inserted into the article interface mouthpiece end first, and the inlet orifice may be located at the opposite end face of the article, facing upwards for coupling with the fluid conduit via a vertical relative movement.

However, in other examples, the article interface may be configured to receive the article in an orientation in which the longitudinal axis of the article is horizontal.

FIG. 22 shows a simplified schematic cross-sectional view of an article interface configured in this way. As in the FIG. 21 example, the article interface 560 has side walls 560c, a base wall 560d and a top wall 560b, plus an opening 560a at one side for insertion of the article 30 along a horizontal insertion direction A. However, the article interface is shaped to hold the article 30 with its longitudinal axis horizontal; for example, the mouthpiece end 35 of the article 30 may pass through the opening 560a first during insertion, as shown (or may pass through last). In order to enable refilling along a vertical direction as in the previous examples, the inlet orifice 34 is located on a side face of the article 30, rather than an end face opposite to the mouthpiece 35. The aperture 560e for accessing the inlet aperture 34 to couple with the fluid conduit (not shown) is therefore formed in the top wall 560b of the article interface 560, as in the FIG. 21 example.

Note that a horizontal orientation for the article may be used in combination with the features of the various vertically oriented examples of FIGS. 13-20.

The examples thus far have employed a substantially vertical orientation for the refilling conduit and the coupling/decoupling directions of movement for engaging and disengaging the fluid conduit and the inlet interface, in which the fluid is moved from the reservoir to the storage area of the article along a downward direction. This may be considered useful in that gravity can assist the movement of the fluid. However, the design of the refilling device is not limited in this way. An opposite arrangement may be adopted, for example, keeping the vertical direction for the coupling/decoupling directions, but placing the article above the reservoir so that the refilling action moves fluid in an upward direction into the storage area.

More generally, the refilling direction (orientation of the fluid conduit, direction of fluid movement, direction of coupling and decoupling) may be non-vertical, for example horizontal or any angle between vertical and horizontal (where angles near to vertical or horizontal may be considered to be vertical and horizontal for practical purposes).

FIG. 23 shows a simplified schematic cross-sectional view of an article interface configured for non-vertical refilling. The article interface 560 is configured similarly to the FIG. 22 example, but is oriented differently, in order to hold the article 30 vertically (its longitudinal axis being vertical), via insertion along a vertical insertion direction A through an opening 560a at the top face of the article interface 560. The inlet orifice 34 of the article 30 can therefore be accessed through an aperture 560e in a side wall 560c of the article interface so as to be coupled to and decoupled from the fluid conduit 580 along the directions E, D which are horizontal.

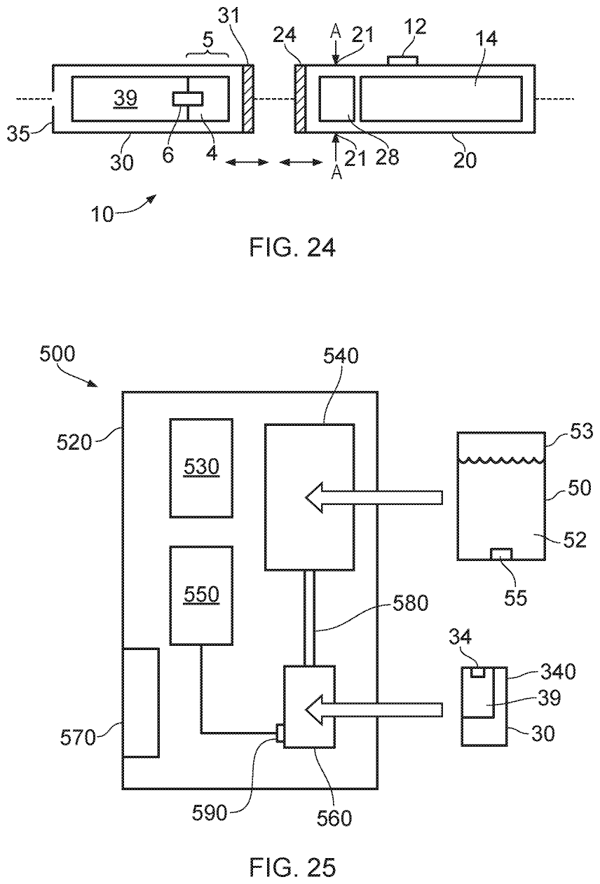

FIG. 24 is a highly schematic diagram (not to scale) of a generic example electronic aerosol/vapor provision system such as an e-cigarette 10, presented for the purpose of showing the relationship between the various parts of a typical system and explaining the general principles of operation. Note that the present disclosure is not limited to a system configured in this way, and features may be modified in accordance with the various alternatives and definitions described above and/or apparent to the skilled person. The e-cigarette 10 has a generally elongate shape in this example, extending along a longitudinal axis indicated by a dashed line, and comprises two main components, namely a device 20 (control or power component, section or unit), and an article or consumable 30 (cartridge assembly or section, sometimes referred to as a cartomiser, clearomiser or pod) carrying aerosol-generating material and operating to generate vapor/aerosol.

The article 30 includes a storage area such as a reservoir 39 for containing a source liquid or other aerosol-generating material comprising a formulation such as liquid or gel from which an aerosol is to be generated, for example containing nicotine. As an example, the source liquid may comprise around 1% to 3% nicotine and 50% glycerol, with the remainder comprising roughly equal measures of water and propylene glycol, and possibly also comprising other components, such as flavorings. Nicotine-free source liquid may also be used, such as to deliver flavoring. A solid substrate (not illustrated), such as a portion of tobacco or other flavor element through which vapor generated from the liquid is passed, may also be included. The reservoir 39 may have the form of a storage tank, being a container or receptacle in which source liquid can be stored such that the liquid is free to move and flow within the confines of the tank. In other examples, the storage area may comprise absorbent material (either inside a tank or similar, or positioned within the outer housing of the article) that holds the aerosol generating material. For a consumable article, the reservoir 3 may be sealed after filling during manufacture so as to be disposable after the source liquid is consumed. However, the present disclosure is relevant to refillable articles that have an inlet port, orifice or other opening (not shown in FIG. 24) through which new source liquid can be added to enable reuse of the article 30. The article 30 also comprises an aerosol generator 5, comprising in this example an aerosol generating component, which may have the form of an electrically powered heating element or heater 4 and an aerosol-generating material transfer component 6. The heater 4 is located externally of the reservoir 39 and is operable to generate the aerosol by vaporization of the source liquid by heating. The aerosol-generating material transfer component 6 is a transfer or delivery arrangement configured to deliver aerosol-generating material from the reservoir 39 to the heater 4. In some examples, it may have the form of a wick or other porous element. A wick 6 may have one or more parts located inside the reservoir 39, or otherwise be in fluid communication with liquid in the reservoir 39, so as to be able to absorb source liquid and transfer it by wicking or capillary action to other parts of the wick 6 that are adjacent or in contact with the heater 4. This liquid is thereby heated and vaporized, and replacement liquid drawn, via continuous capillary action, from the reservoir 39 for transfer to the heater 4 by the wick 6. The wick may be thought of as a conduit between the reservoir 39 and the heater 4 that delivers or transfers liquid from the reservoir to the heater. In some designs, the heater 4 and the aerosol-generating material transfer component 6 are unitary or monolithic, and formed from a same material that is able to be used for both liquid transfer and heating, such as a material which is both porous and conductive. In still other cases, the aerosol-generating material transfer component may operate other than by capillary action, such as by comprising an arrangement of one or more valves by which liquid may exit the reservoir 39 and be passed onto the heater 4.

A heater and wick (or similar) combination, referred to herein as an aerosol generator 5, may sometimes be termed an atomiser or atomiser assembly, and the reservoir with its source liquid plus the atomiser may be collectively referred to as an aerosol source. Various designs are possible, in which the parts may be differently arranged compared with the highly schematic representation of FIG. 24. For example, and as mentioned above, the wick 6 may be an entirely separate element from the heater 4, or the heater 4 may be configured to be porous and able to perform at least part of the wicking function directly (a metallic mesh, for example). In the present example, the system is an electronic system, and the heater 4 may comprise one or more electrical heating elements that operate by ohmic/resistive (Joule) heating, although inductive heating may also be used, in which case the heater comprises a susceptor in an induction heating arrangement. A heater of this type could be configured in line with the examples and embodiments described in more detail below. In general, therefore, an atomiser or aerosol generator, in the present context, can be considered as one or more elements that implement the functionality of a vapor-generating element able to generate vapor by heating source liquid (or other aerosol-generating material) delivered to it, and a liquid transport or delivery element able to deliver or transport liquid from a reservoir or similar liquid store to the vapor-generating element by a wicking action/capillary force or otherwise. An aerosol generator is typically housed in an article 30 of an aerosol generating system, as in FIG. 24, but in some examples, at least the heater part may be housed in the device 20. Embodiments of the disclosure are applicable to all and any such configurations which are consistent with the examples and description herein.

Returning to FIG. 24, the article 30 also includes a mouthpiece or mouthpiece portion 35 having an opening or air outlet through which a user may inhale the aerosol generated by the heater 4.

The device 20 includes a power source such as cell or battery 14 (referred to hereinafter as a battery, and which may or may not be re-chargeable) to provide electrical power for electrical components of the e-cigarette 10, in particular to operate the heater 4. Additionally, there is a controller 28 such as a printed circuit board and/or other electronics or circuitry for generally controlling the e-cigarette. The controller may include a processor programmed with software, which may be modifiable by a user of the system. The control electronics/circuitry 28 operates the heater 4 using power from the battery 14 when vapor is required. At this time, the user inhales on the system 10 via the mouthpiece 35, and air A enters through one or more air inlets 21 in the wall of the device 20 (air inlets may alternatively or additionally be located in the article 30). When the heater 4 is operated, it vaporizes source liquid delivered from the reservoir 39 by the aerosol-generating material transfer component 6 to generate the aerosol by entrainment of the vapor into the air flowing through the system, and this is then inhaled by the user through the opening in the mouthpiece 35. The aerosol is carried from the aerosol generator 5 to the mouthpiece 35 along one or more air channels (not shown) that connect the air inlets 21 to the aerosol generator 5 to the air outlet when a user inhales on the mouthpiece 35.

More generally, the controller 28 is suitably configured/programmed to control the operation of the aerosol provision system to provide functionality in accordance with embodiments and examples of the disclosure as described further herein, as well as for providing conventional operating functions of the aerosol provision system in line with established techniques for controlling such devices. The controller 28 may be considered to logically comprise various sub-units/circuitry elements associated with different aspects of the aerosol provision system's operation in accordance with the principles described herein and other conventional operating aspects of aerosol provision systems, such as display driving circuitry for systems that may include a user display (such as an screen or indicator) and user input detections via one or more user actuable controls 12. It will be appreciated that the functionality of the controller 28 can be provided in various different ways, for example using one or more suitably programmed programmable computers and/or one or more suitably configured application-specific integrated circuits/circuitry/chips/chipsets configured to provide the desired functionality.

The device 20 and the article 30 are separate connectable parts detachable from one another by separation in a direction parallel to the longitudinal axis, as indicated by the double-headed arrows in FIG. 24. The components 20, 30 are joined together when the system 10 is in use by cooperating engagement elements 24, 31 (for example, a screw or bayonet fitting) which provide mechanical and in some cases electrical connectivity between the device 20 and the article 30. Electrical connectivity is required if the heater 4 operates by ohmic heating, so that current can be passed through the heater 4 when it is connected to the battery 14. In systems that use inductive heating, electrical connectivity can be omitted if no parts requiring electrical power are located in the article 30. An inductive work coil can be housed in the device 20 and supplied with power from the battery 14, and the article 30 and the device 20 shaped so that when they are connected, there is an appropriate exposure of the heater 4 to flux generated by the coil for the purpose of generating current flow in the material of the heater. The FIG. 24 design is merely an example arrangement, and the various parts and features may be differently distributed between the device 20 and the article 30, and other components and elements may be included, such as illustrated in FIG. 1. The two sections may connect together end-to-end in a longitudinal configuration as in FIG. 24, or in a different configuration such as a parallel, side-by-side arrangement. The system may or may not be generally cylindrical and/or have a generally longitudinal shape. Either or both sections or components may be intended to be disposed of and replaced when exhausted, or be intended for multiple uses enabled by actions such as refilling the reservoir and recharging the battery. In other examples, the system 10 may be unitary, in that the parts of the device 20 and the article 30 are comprised in a single housing and cannot be separated. Embodiments and examples of the present disclosure are applicable to any of these configurations and other configurations of which the skilled person will be aware, but are most generally concerned with configurations comprising an article with a refillable storage area.

The present disclosure relates to the refilling of a storage area for aerosol generating material in an aerosol provision system, whereby a user is enabled to conveniently provide a system with fresh aerosol generating material when a previous stored quantity has been used up. It is proposed that this be done automatically, by provision of apparatus which is termed herein a refilling device, refilling unit, refilling station, or simply dock. The refilling device is configured to receive an aerosol provision system, or more conveniently, the article from an aerosol provision system, having a storage area which is empty or only partly full, plus a larger reservoir holding aerosol generating material. A fluid communication flow path is established between the reservoir and the storage area, and a controller in the refilling device controls a transfer mechanism or arrangement operable to move aerosol generating material along the flow path from the reservoir to the storage area. The transfer mechanism can be activated in response to user input of a refill request to the refilling device, or activation may be automatic in response to a particular state or condition of the refilling device detected by the controller. For example, if both an article and a reservoir are correctly positioned inside the refilling unit, refilling may be carried out. Once the storage area is replenished with a desired quantity of aerosol generating material (the storage area is filled or a user specified quantity of material has been transferred to the article, for example), the transfer mechanism is deactivated, and transfer ceases. Alternatively, the transfer mechanism may be configured to automatically dispense a fixed quantity of aerosol generating material in response to activation by the controller, such as a fixed quantity matching the capacity of the storage area.

FIG. 25 shows a highly schematic representation of an example refilling device. The refilling device is shown in a simplified form only, to illustrate various elements and their relationship to one another. More particular features of one or more of the elements with which the present disclosure is concerned will be described in more detail below.

The refilling device 500 may be referred to hereinafter for convenience as a “dock”. This term is applicable since a reservoir and an article are received or “docked” in the refilling device during use. The dock 500 comprises an outer housing 520. The dock 500 is expected to be useful for refilling of articles in the home or workplace (rather than being a portable device or a commercial device, although these options are not excluded). Therefore, the outer housing, made for example from metal, plastics or glass, may be designed to have an pleasing outward appearance such as to make it suitable for permanent and convenient access, such as on a shelf, desk, table or counter. It may be any size suitable for accommodating the various elements described herein, such as having dimensions between about 10 cm and 20 cm, although smaller or larger sizes may be preferred. Inside the housing 500 are defined two cavities or ports 540, 560. A first port 540 is shaped and dimensioned to receive and interface with a reservoir 50. The first or reservoir port 540 is configured to enable an interface between the reservoir 50 and the dock 500, so might alternatively be termed a reservoir interface. Primarily, the reservoir interface is for moving aerosol generating material out of the reservoir 50, but in some cases the interface may enable additional functions, such as electrical contacts and sensing capabilities for communication between the reservoir 50 and the dock 500 and determining characteristics and features of the reservoir 50.

The reservoir 50 comprises a wall or housing 41 that defines a storage space for holding aerosol generating material 52. The volume of the storage space is large enough to accommodate many or several times the storage area of an article intended to be refilled in the dock 50. A user can therefore purchase a filled reservoir of their preferred aerosol generating material (flavor, strength, brand, etc.), and use it to refill an article multiple times. A user could acquire several reservoirs 50 of different aerosol generating materials, so as to have a convenient choice available when refilling an article. The reservoir 50 includes an outlet orifice or opening 55 by which the aerosol generating material 52 can pass out of the reservoir 50. In the current context, the aerosol generating material 52 has a liquid form or a gel form, so may be considered as aerosol generating fluid. The term “fluid” may be used herein for convenience to refer to either a liquid or a gel material; where the term “liquid” is used herein, it should be similarly understood as referring to a liquid or a gel material, unless the context makes it clear that only liquid is intended.

A second port 560 defined inside the housing is shaped and dimensioned to receive and interface with an article 30. The second or article port 540 is configured to enable an interface between the article 30 and the dock 500, so might alternatively be termed an article interface. The article interface 560 is for receiving aerosol generating material into the article 30, and according to present example, the article interface enables additional functions, such as electrical contacts and sensing capabilities for communication between the article 30 and the dock 500 and determining characteristics and features of the article 30. In particular, the article interface 560 has associated with it one or more capacitive sensors 590 which may be interrogated by a controller 550 in the refilling dock 500 in order to obtain capacitance measurements related to the article 30 when received in the article interface 560 from which characteristics of the article can be ascertained.

The article 30 itself comprises a wall or housing 340 that has within it (but possibly not occupying all the space within the wall 340) a storage area 39 for holding aerosol generating material. The volume of the storage area 39 is many or several times smaller than the volume of the reservoir 50, so that the article 30 can be refilled multiple times from a single reservoir 50. The article also includes an inlet orifice or opening 34 by which aerosol generating material can enter the storage area 39. Various other elements may be included in the article, as discussed above with regard to FIG. 1. For convenience, the article 30 may be referred to hereinafter as a pod 30.

The housing 520 of the dock also accommodates a fluid conduit 580, being a passage or flow path by which the reservoir 50 and the storage area 39 of the article 30 are placed in fluid communication, so that aerosol generating material can move from the reservoir 50 to the article 30 when both the reservoir 50 and the article 30 are correctly positioned in the dock 500. Placement of the reservoir 50 and the article 30 into the dock 500 locates and engages them such that the fluid conduit 580 is connected between the outlet orifice 55 of the reservoir 50 and the inlet orifice 34 of the article 30. Note that in some examples, all or part of the fluid conduit 580 may be formed by parts of the reservoir 50 and the article 30, so that the fluid conduit is created and defined only when the reservoir 50 and/or the article 30 are placed in the dock 30. In other cases, the fluid conduit 580 may be a flow path defined within a body of the dock 520, to each end of which the respective orifices are engaged.

Access to the reservoir port 540 and the article port 560 can be by any convenient means. Apertures may be provided in the housing 520 of the dock 500, through which the reservoir 50 and the article 30 can be placed or pushed. Doors or the like may be included to cover the apertures, which might be required to be placed in a closed state to allow refilling to take place. Doors, hatches and other hinged coverings, or sliding access elements such as drawers or trays might include shaped tracks, slots or recesses to receive and hold the reservoir 50 or the article 30, which bring the reservoir 50 or the article 30 into proper alignment inside the housing when the door etc. is closed. These and other alternatives will be apparent to the skilled person, and do not affect the scope of the present disclosure.

The dock 500 also includes an aerosol generating material (“liquid” or “fluid”) transfer mechanism, arrangement, apparatus or means 530, operable to move or cause the movement of fluid out of the reservoir 50, along the conduit 580 and into the article 30. Various options are contemplated for the transfer mechanism 530.

As already noted, a controller 550 is also included in the dock 500. This is operable to control components of the dock 500, in particular to generate and send control signals to operate the transfer mechanism. As noted, this may be in response to a user input, such as actuation of a button or switch (not shown) on the housing 520, or automatically in response to both the reservoir 50 and the article 30 being detected as present inside their respective ports 540, 560. The controller 550 may therefore be communication with contacts and/or sensors (such as the sensors 590 but otherwise not shown) at the ports 540, 560 in order to obtain data from the ports and/or the reservoir 50 and article 30 that can be used in the generation of control signals for operating the transfer mechanism 530. The controller 550 may comprise a microcontroller, a microprocessor, or any configuration of circuitry, hardware, firmware or software as preferred; various options will be apparent to the skilled person.

Finally, the dock 500 includes a power source 570 to provide electrical power for the controller 530, and any other electrical components that may be included in the dock, such as sensors, user inputs such as switches, buttons or touch panels, and display elements such as light emitting diodes and display screens to convey information about the dock's operation and status to the user. Also, the transfer mechanism may be electrically powered. Since the dock may be for permanent location in a house or office, the power source 570 may comprise a socket for connection of an electrical mains cable to the dock 500, so that the dock 500 may be “plugged in”. Alternatively, the power source may comprise one or more batteries, which might be replaceable or rechargeable, in which case a socket connection for a charging cable can be included.

Further details relating to the control of the refilling will now be described.

As noted above, the refilling process is governed by the controller of the refilling device, and includes the generation and sending of control signals to the transfer mechanism to cause it to start the movement of fluid from the reservoir into the article. This can be performed so as to dispense a fixed amount of fluid that corresponds to the known capacity of the article's storage area, after which operation of the transfer mechanism ceases. More usefully, cessation of the fluid dispensing can be implemented in response to detection of a fluid level or amount in the article. The controller is configured to recognize when the storage area has become full, or otherwise filled to a required level, and to cause the transfer mechanism to stop transferring fluid in response. This allows an article to be refilled safely without spilling or pressure build-up in the storage area, regardless of an amount of fluid present in the article at the start of the refilling process. Articles can hence be topped up as well as completely or partially refilled from empty.

In the present disclosure, it is proposed to use one or more capacitive sensors to obtain capacitance measurements from which characteristics and properties of an article received in a refilling device can be determined. Characteristics may include a level of fluid in a storage area of the article, and the presence or absence of the article in the refilling device. The amount or type of a material between or in close proximity to a pair of capacitor plates determines the capacitance between the plates, so measurement of the capacitance can reveal properties of an item proximate to a capacitive sensor. In the current case, the item is the article, and the capacitance will be different when the article is present in the refilling device and proximate the capacitive sensor from the capacitance when the article is not present in the refilling device. Hence, the presence or absence of the article can be determined. Similarly, the volume of fluid in the storage device of the article affects the amount of material proximate the capacitive sensor when the article is in the refilling device, so the fluid amount or level can be determined from capacitance measurements.

It is proposed that the capacitance measurements be obtained using one or more capacitive sensors incorporated in the article interface of the refilling device, or otherwise associated with the article interface so as to be positioned to interact with an article in the article interface (as shown in FIG. 25). This arrangement reduces the complexity and cost of articles, and does not require any electrical connection to be made between the article and the refilling dock. However, locating the capacitive sensor externally from the article necessarily means that there may be parts of the article intervening between the capacitor plates and the storage area that could modify the capacitance measurements. While this may be a constant for all readings made on a particular article, and can be accounted for, it will reduce the sensitivity of the capacitance measurements. According to the proposed arrangement, this is addressed by a capacitive sensor configured for positioning at least one plate of the capacitive sensor in contact with the outer surface of the article and also in conformity with the shape of the outer surface where the contact is made. This reduces or removes any air gaps that might otherwise be present between the capacitor plate and the article received in the article interface and which would contribute to the capacitance measurements, reducing sensitivity to changes in the amount of fluid in the article's storage area.

To further enhance this effect, it is proposed that the conformity between the capacitor plate and the shape of the outer surface of the article be achieved by configuring the capacitor plate to be elastically deformable, and positioned such that it encroaches or extends into a volume or space in the article interface which is occupied by the article when received in the article interface. In this way, the article in the article interface presses or pushes against and into the capacitor plate, deforming and compressing it according to the shape of the article. Hence the capacitor plate is brought into contact with the outer surface of the article and is formed into a reversed surface shape that touches the article at all points. In this way, gaps and spaces between the capacitor plate and the article's outer surface can be eliminated, to improve the capacitance measurements and increase sensitivity.

A further effect of this configuration is that the same design and arrangement of article interface can be used to accommodate articles of different outer shape. The capacitor plate will be brought into close and conforming surface contact with a variety of article shapes, so the refilling device can be used with different designs of article without any need to reconfigure or replace the capacitive sensor. Similarly, slight changes in the outer shape of articles arising from manufacturing tolerances or defects have no detrimental effect on the capacitance measurements, since the deformable capacitor plates will conform to the article surface in all cases.

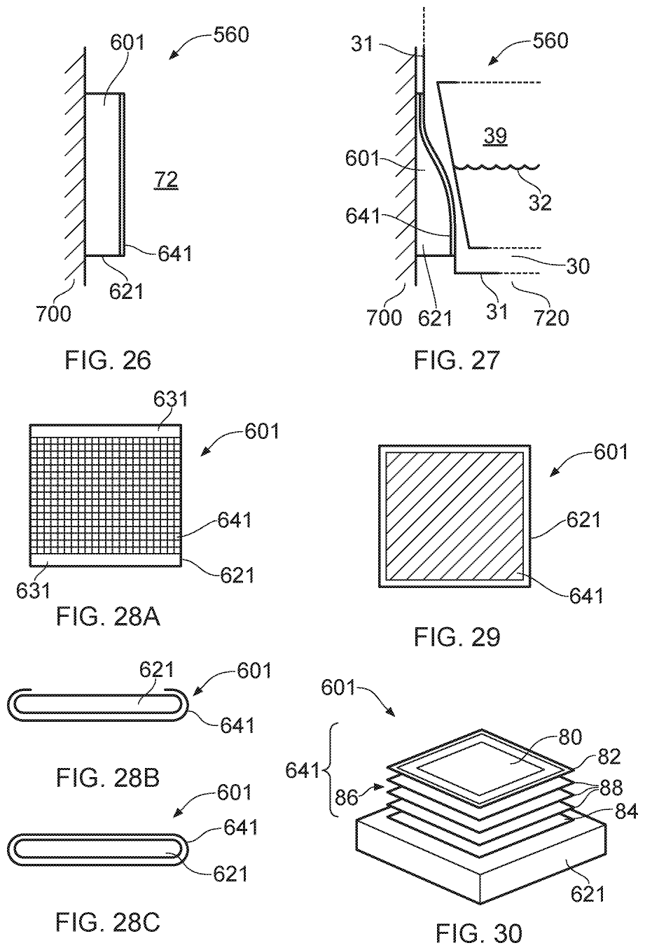

FIG. 26 shows a highly schematic side view of a capacitor plate of a capacitive sensor (not to scale) according to an example of the disclosure. The capacitor plate 601 is comprised in a capacitive sensor (other parts of which are omitted for clarity) arranged and located to make capacitance measurements on an article which is inserted or received in an article interface 560 in a refilling device. The capacitor plate 601 can therefore be considered to be associated with the article interface 560. In this example, the association is made by mounting or otherwise supporting the capacitor plate 601 on an inwardly facing wall 700 of the article interface 560. In designs where the article interface 560 is open on one or more sides, the capacitor plate may be held or mounted on a different interior part of the refilling device, to access a received article through an open part of the article interface 560. In any arrangement, the capacitor plate 601 is sized and positioned so that it reaches or extends into a space or volume 72 in the article interface 560 which is intended to be occupied by an article inserted into the article interface 560. This encroachment of the capacitor plate 601 into the space reserved for an article means that any article inserted into the volume 72 will come into contact with the capacitor plate 601, and then deform the capacitor plate 601 by crushing, squashing, squeezing or compressing it.

This compression is enabled by the construction of the capacitor plate 601. It comprises an electrically conductive layer 641 on a surface of a supporting element or substrate 621, arranged so that the electrically conductive layer 641 faces in towards the volume 72 and therefore makes contact with the outer surface of an inserted article. The conductive layer 641 provides the electrical properties required of a capacitor plate. In order to provide the compression, the supporting element 621 is made from a compressible or deformable material, formed as a pad or similar. The compressible material is preferably elastically compressible, so that the capacitor plate 601 can resume its uncompressed size and shape after a compressing article is removed from the volume 72, in order to be in a state ready for compression during future article insertions. This allows repeated accurate surface contact with multiple articles. However, a plastically deformable material may be used, which conforms to the shape of the article which is first received in the article interface 560, and retains that shape for surface contact when the same article is received in the future. The compressible element 621 may be made from, for example a sponge or foam material, which may be natural or synthetic, such as natural sponge or polyurethane foam. Natural rubber or synthetic rubber may also be used. Other elastic or plastic deformable or compressible materials are not excluded, however. For ease of electrical operation of the capacitive sensor, the compressible element 621 is also preferably an electrically insulating material.

The electrically conductive layer 641 is a thin and flexible layer, such that it can be deformed in conjunction with the supporting compressible element 621, and restored to its original shape and configuration after an article is removed according to the return of the supporting element 621 to its original shape and configuration; the supporting element 621 carries the electrically conductive surface layer 641 with it as it deforms firstly by compression and then by extension to its original shape. In order to function as part of a capacitive sensor, the conductive layer 641 is provided with an electrical connection (not shown) directly or indirectly to a controller of the refilling device, by which the capacitive sensor can be operated and interrogated as required by the controller.

FIG. 27 shows a highly schematic side view of the capacitor plate 601 of FIG. 26, after an article 30 has been inserted into the article interface 560 so as to occupy the volume 72. The presence of the article 30 has compressed the capacitor plate 601 such as is made possible by the compressible nature of the supporting element 621. The conductive surface layer 641 is similarly deformed, and now conforms to the shape of the outer surface of the housing 31 of the article 30. The presence of the article 30 will modify the capacitance measurable by the controller interrogating the capacitive sensor, so the controller is able to determine when the article 30 is placed in the article interface 560. This can be used to determine that a refilling action to transfer fluid into a storage area 39 in the article 30 may safely be commenced, for example. In this example, the storage area 39 is also interposed in the range of capacitor plate 601, and any fluid 32 in the storage area 39 will modify the measurable capacitance according to how much fluid 32 is present. In this way, the amount, volume or level of fluid in the storage area 39 can be determined, and also monitored during a refilling action. Hence, the controller can determine when a required amount of fluid 32 has been delivered to the storage area 39, and cease the refilling action.

Note that in FIG. 26, the supporting element 621 is shown as having a constant thickness in its uncompressed state and presents a planar surface, on which the conductive layer 641 is present, to the volume 72. In the example of FIG. 27, the article 30 does not have a planar surface, so that when the article 30 is present in the volume 72, the supporting element 621 is compressed more in some places than others, according to the shape of the article 30. In an alternative, the supporting element 621 may be provided with a surface on which the conductive layer is present which is shaped to at least approximately match or correspond to the contacting outer surface of the article, which still intruding into the volume 72 so as to be compressed by the article. This can allow more equal amounts of compression across the supporting element 621, which may ease insertion of the article 30 into the volume 72 and retention of the article 30 in the inserted position. Also, smaller amounts of compressible material may be required for the supporting element 621.

Regardless of any surface shaping of the supporting element 621, or if it is planar, its thickness will typically of the order of a few or several millimetres, where thickness may be an average thickness for a shaped supporting element. The thickness used will depend on the design of the refilling device and the article, and is may be chosen as appropriate. For example, the thickness may be 10 mm or less, such as about 8 mm, about 5 mm or about 3 mm. Other thicknesses are not excluded.

FIG. 28A shows a schematic front plan view of a further example capacitor plate 601. The capacitor plate 601 comprises, as already discussed, a compressible supporting element or substrate 621 with a flexible conductive layer 641 arranged on its surface so as to extend over and across the supporting element 621. The flexible conductive layer 641 may or may not reach to the edges of the relevant surface of the supporting element 621. A border 631 of the supporting element 621 that extends beyond the conductive layer 641 on one or more sides may be useful in providing electrical isolation of the conductive layer 641 (other than its connection as part of the capacitive sensor, which as before is not shown). The supporting element 621 in this example is approximately square, and comprises a relatively thin layer or pad of the chosen deformable material, in that its thickness in a direction perpendicular to the surface having the conductive layer 641 is less than or considerably less than the dimensions of that surface. However other sizes, shapes and thicknesses of supporting element 621, and size of the conductive layer 641 relative to the supporting element, may be used instead, according to the dimensions and design of the refilling device, the article interface, the article, and the portion or portions of the article for which capacitance measurements are desired.

In this example, the conductive layer 641 comprises a conductive mesh, web or grill, such as may be formed by weaving, interlacing, interlocking or sintering metal fibres. A mesh structure can be sufficiently fine and thin (for example by being made from fine metal fibres with a small thickness) to provide the required flexibility to allow the conductive layer to easily bend or otherwise deform in order to conform to the surface of a contacting and pressing article and assume its shape. A similar effect may be obtained from a sheet of metal in which an array of holes, openings or apertures is formed, such as by stamping or otherwise puncturing through the sheet. As an example, the conductive layer may comprise a mesh made from stainless steel. This provides a suitable level of conductivity for a capacitive sensor employed for the described purpose, and also resists corrosion in the event of any fluid spills or leaks within the refilling device. Other metals may be used as preferred, and are not excluded. For example, copper may be used.

The conductive layer 641 may be secured to the supporting element 621 by adhesive, or an adhesive tape, for example. This may aid in insulating the conductive layer from stray electrical contact. This approach is useful if the conductive layer is a flat portion of mesh or similar intended to overlie the relevant surface of the supporting element 621.

FIG. 28B shows, as a side or top view of the capacitor plate 601, an alternative approach in which the conductive layer 641 is large enough to extend around the edges of the supporting element 621 to its rear surface, for example by folding the outer parts of the conductive layer over to grip the edges of the supporting element 621, or otherwise be secured to the supporting element. Note that the depicted gap between the supporting element 621 and the conductive layer 641 is included for clarity only, and may or may not be present.

FIG. 28C shows, as a side or top view of the capacitor plate 601, a further alternative approach in which the conductive layer 641 entirely surrounds the supporting element 621. For example, the conductive layer 641 may be formed as a tube, in which the supporting element 621 is inserted, thereby removing the requirement for any securing material such as adhesive or tape. Alternatively, the conductive layer 641 may be a sheet which is then wrapped around the supporting element 621.

FIG. 29 shows a schematic front plan view of a yet further example capacitor plate 601. The capacitor plate 601 comprises, as before, a compressible supporting element or substrate 621 with a flexible conductive layer 641 arranged on its surface so as to extend over and across the supporting element 621. As before, these parts may have any convenient and suitable size and shape. In this example, the flexible conductive layer 641 comprises a continuous layer of a conductive material such as a metal which is sufficiently thin to provide appropriate flexibility. For example, the conductive layer may comprise a metal foil or a metal film. A foil may be secured, mounted or attached to the supporting element 621 with adhesive or adhesive tape, similarly to the mounting of a metal mesh described above. A metallic thin film might be deposited on a thin flexible substrate layer which is itself secured to the relevant surface of the supporting element. Alternatively, a metallic thin film may be deposited directly onto the supporting element, or onto compressible material from which the supporting element is to be divided or otherwise formed. Any suitable deposition technique for creating thin films might be used, such as chemical or physical vapor deposition techniques. As an example, the conductive layer may have the form of a foil or film of copper. Other metals may be used as preferred, and are not excluded. For example, stainless steel may be used.

To improve electrical performance of the capacitive sensor, the flexible conductive layer may have a more complex construction so as to provide electrical shielding. This protects the capacitive sensor from stray electrical fields that may interfere with the capacitance measurements and lead to inaccurate determinations by the controller.

FIG. 30 shows an example of a perspective slightly exploded view of a capacitor plate 601 configured in this way. As before, the conductive layer 641 is mounted or supported on a compressible element 621, comprising foam, for example. The conductive layer 641 comprises the actual capacitor plate 801, facing outwardly from the supporting element 621 and comprising metallic mesh or foil as described above (such as copper), which is surrounded by, but spaced apart from, a metallic/conductive shielding frame 82 to provide active electromagnetic shielding. The shielding frame 82 is electrically coupled (such as by soldering) to a metallic/conductive shielding plate 84 (formed from copper, for example) at the rear of the conductive layer 641, in other words, between the sensor plate 80 and the supporting element 82. Between sensor plate 80 and the shielding plate 84 are arranged one or more insulating layers 88, of non-conductive material such as electrical tape or similar to insulate the sensor plate 80 from the shielding. The overall thickness of such a structure, comprising multiple layers as described, can usefully be less than 1 mm, or less than 0.5 mm, or less than 0.1 mm, or between 1 mm and 0.1 mm, or between 0.5 mm and 0.1 mm, for example, although other thicknesses may be used which are able to provide the required flexibility and deformability, and ability to elastically restore the shape of the conductive layer if required.

As known, a capacitive sensor comprises a pair of capacitor plates. According to the disclosure, one or both of the plates may be configured to be deformable to contact and conform to an article surface as described. Regardless of this, the plates may be arranged in various configurations in order to be operable to detect and measure capacitance of the article in the article interface.

In a first example arrangement, the two plates of the capacitive sensor are positioned on opposite sides receiving volume in the article interface, so that an article received in the article interface lies between the plates, and modifies the capacitance. If the aim is simply to detect the presence of an article, any part of the article that produces a detectable change in capacitance can be located between the plates. If the aim is alternatively or additionally to monitor, measure or detect an amount of fluid in the storage area, at least a part of the storage area should be located between the plates.

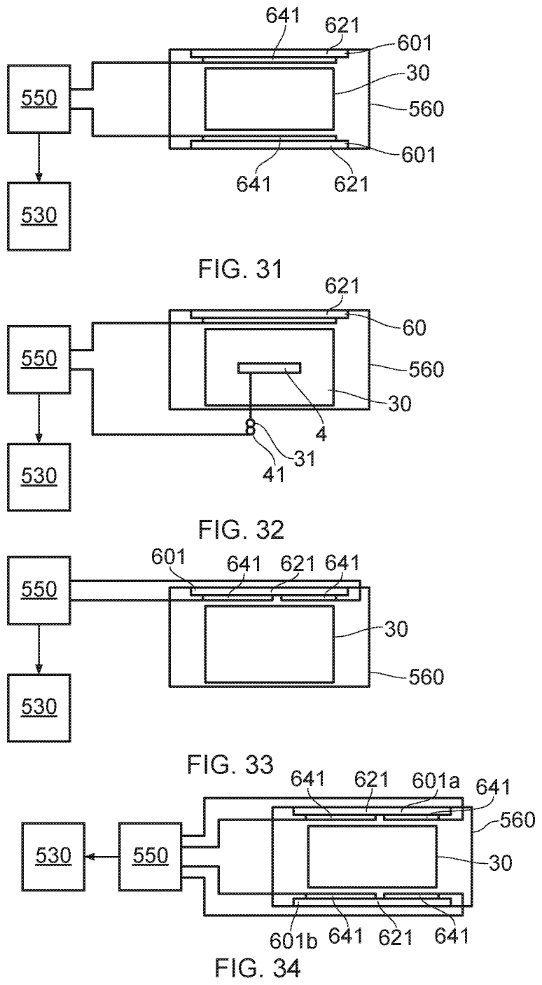

FIG. 31 shows a simplified schematic top view of an example capacitive sensor of this type in a refilling device. The capacitive sensor comprises two deformable capacitor plates 601, one on each side of the article interface 560, and each comprising a conductive layer 641 on a supporting element or substrate 621, as previously described. Hence, the sensor is arranged so that the space between its capacitor plates 601 is occupied by an article 30 received in the article interface 560 (a gap is shown between the article 30 and the conductive layers 641 for the clarity; in reality the article 30 is in contact with the conductive layers as described above). When the storage area of the article (not shown) is empty of aerosol-generating material, a value of capacitance for each sensor exists, depending (in the usual way for a capacitor) on parameters including the area of the plates, the distance between the plates, and the dielectric value of the air occupying the empty storage area plus intervening parts of the article. When the storage area is filled with aerosol-generating material, the space between the capacitor plates becomes partly occupied by the material, which has a different dielectric constant from air. Hence the capacitance of the sensor is different for a full storage area and an empty storage area, and indeed for the storage area at intermediate fill levels, and for the article 30 being present in or absent from the article interface. Each of the conductive layers 641 is connected to the controller 550 of the refilling device to define a capacitance sensing circuit, where the controller 550 is configured to operate and interrogate the capacitive sensor to obtain capacitance values from it. One of the conductive layers 641 acts as an earth or ground, in the usual manner of configuring a capacitive sensor. Application of an oscillating voltage across the pair of capacitor plates produces a current flow through the sensor, which can be detected externally by the controller in the known manner, and measured so that the controller can deduce information about the capacitance at the time of measurement, and from this, determine characteristics of the article 30. The controller 550 is further configured to use the capacitance measurements (directly or converted into data reflecting the article characteristics) to control filling actions to move fluid into the article using the fluid transfer mechanism 530.

FIG. 32 shows a simplified schematic top view of a further example capacitive sensor in a refilling device. In this example, the capacitive sensor, operated by the controller 550 as before, comprises as a first plate a deformable capacitor plate 601 arranged on an inner surface of the wall of the article interface 560 and electrically connected to the controller 550. The article 30 comprises a heating element 4 (see FIG. 24), and this is utilized as a second plate for the capacitive sensor. The article 30 has an electrical contact 31 connected to the heating element 4, which may be, for example, the electrical contact used to supply power to the heating element 4 when the article 30 is coupled to a device to form an aerosol provision system. The electrical contact 31 connects with a second electrical contact 41 in the refilling device in order to connect with the controller 550 and complete the capacitive sensing circuit. This arrangement simplifies the refilling device by making use of an existing component of the article 30, namely its heating element 4 for a second purpose.

FIG. 33 shows a simplified schematic top view of a further example capacitive sensor in a refilling device. In this example, the capacitive sensor is configured such that both capacitor plates 601 are disposed on the same side of an article 30 received in the article interface 560. The deformable capacitor plate 601 described previously is configured to additionally comprise a second flexible conductive layer 641 on the compressible supporting element 621. The earth or ground plate of the capacitive sensor can be considered to be integrated or “built in”. The two conductive layers 641 are shown as being side by side in FIG. 33, but this is for clarity only, and they may be differently arranged, in particular being stacked on one another with appropriate electrical isolation from each other. The article 30 modifies the electrical field lines between the two plates when the capacitive sensor is operated, thereby changing the capacitance to allow detection and measurement as before. This arrangement can allow simpler installation of the capacitive sensor in the article interface 560 since only one physical item needs to be installed, in a single location. Also, the capacitive sensor may then be able to occupy less space within the article interface 560. Use of a single compressible element 621 to support both conductive layers 641 may also be more convenient, although a separate compressible element 621 may be used for each conductive layer 641 instead.

FIG. 34 show a simplified schematic top view of a still further example capacitive sensor in a refilling device. In this example, a second capacitive sensor is provided, connected to the controller 550 for interrogation independently from the first capacitive sensor. This provides a degree of redundancy and allows the second capacitive sensor to be used as a fail-safe if the first capacitive sensor malfunctions or fails. The controller 550 might be configured to utilize the second capacitive sensor only in the event of a problem with the first capacitive sensor, or may be configured to interrogate it regularly and use its output as a check against that of the first capacitive sensor to identify possible problems, or use the outputs of both sensors to determine average capacitance measurements. FIG. 34 shows the first capacitive sensor arranged at one side of the article interface 560, as a single “capacitor plate” 601a as in the FIG. 33 example (both conductive layers 641 on a single supporting element 621), and the second capacitive sensor arranged on the opposite side of the article interface 560, as a second single “capacitor plate” 601b. Of course, in an alternative, the four conductive layers may be differently connected so as to make two capacitive sensors which each receive the article 30 between the capacitor plates, as in FIG. 31.

As described above, the present disclosure relates to (but it not limited to) a refilling device 40 for refilling an article 30 from a reservoir 50. The refilling device 40 comprises an article interface 42 configured to receive the article 30, a reservoir interface 46 configured to receive the reservoir 50, a plunger 440 configured, in use, to engage with the reservoir 50, and a motor configured to drive a cam mechanism 450 coupled to each of the article interface 42, the reservoir interface 46 and the plunger 440 such that, in use, the article 30, the reservoir 50 and the plunger 440 move in a coordinated manner such that aerosol-generating material 52 is transferred from the reservoir 50 to the article 30.

As described above, the present disclosure also relates to (but it not limited to) a refilling device for refilling an article of an aerosol provision system comprises an article interface configured to receive the article, a reservoir interface configured to receive the reservoir and a nozzle block located between the article interface and the reservoir interface. The nozzle block comprises a filling nozzle configured to facilitate the transfer of aerosol-generating material from the reservoir to the article, and a venting nozzle configured to facilitate the transfer of air from the article as aerosol-generating material is transferred from the reservoir to the article. The nozzle block is configured such that, in use, the filling nozzle engages with the article in response to the reservoir engaging with the nozzle block.

Thus, there has been described a refilling device for an article of an aerosol provision system and a method of refilling an article of an aerosol provision system. There has also been described a refilling device for an article of an aerosol provision system and a method of refilling an article of an aerosol provision system.

The various embodiments described herein are presented only to assist in understanding and teaching the claimed features. These embodiments are provided as a representative sample of embodiments only, and are not exhaustive and/or exclusive. It is to be understood that advantages, embodiments, examples, functions, features, structures, and/or other aspects described herein are not to be considered limitations on the scope of the invention as defined by the claims or limitations on equivalents to the claims, and that other embodiments may be utilized and modifications may be made without departing from the scope of the claimed invention. Various embodiments of the invention may suitably comprise, consist of, or consist essentially of, appropriate combinations of the disclosed elements, components, features, parts, steps, means, etc., other than those specifically described herein. In addition, this disclosure may include other inventions not presently claimed, but which may be claimed in future.

Aspects of the subject matter described herein are set out in the following numbered clauses:

1. A refilling device for refilling an article from a reservoir, comprising:
an article interface configured to receive the article;
a reservoir interface configured to receive the reservoir;
a plunger configured, in use, to engage with the reservoir; and
a motor configured to drive a cam mechanism coupled to each of the article interface, the reservoir interface and the plunger such that, in use, the article, the reservoir and the plunger move in a coordinated manner such that aerosol-generating material is transferred from the reservoir to the article.

2. The refilling device of clause 1, further comprising a nozzle block between the article interface and the reservoir interface.

3. The refilling device of clause 2, wherein the coordinated manner comprises:
(1) the article interface moving towards the nozzle block;
(2) the reservoir interface moving towards the nozzle block; and
(3) the plunger engaging and pushing on a surface of the reservoir.

4. The refilling device of clause 3, wherein the step (1) happens before step (2) and step (2) happens before step (3).

5. The refilling device of clause 2, wherein the nozzle block is integrated with one of the article interface or the reservoir interface.

6. The refilling device of any one of clauses 2 to 5, wherein the nozzle block comprises a syringe configured to facilitate the transfer of aerosol-generating material from the reservoir to the article via the nozzle block.

7. The refilling device 6, wherein the cam mechanism is configured to move the plunger in a reciprocating motion comprising a first direction and a second direction opposite the first direction, wherein the plunger moves in the first direction towards the nozzle block to cause aerosol-generating material to be transferred from the reservoir to the syringe, and the plunger moves in the second direction away from the nozzle block to cause aerosol-generating material to be transferred from the syringe to the article.

8. The refilling device of clause 6 or clause 7, wherein the nozzle block further comprises a three-way check value to control the transfer of aerosol-generating material into and out of the syringe.

9. The refilling device of any one of clauses 1 to 8, wherein the cam mechanism comprises a cam plate.

10. The refilling device of clause 8, wherein the motor is connected to the cam plate by a lead screw.

11. The refilling device of clause 9 or clause 10, wherein the plunger is fixed to the cam plate such at that the plunger moves with the cam plate.

12. The refilling device of any one of clauses 9 to 11, wherein the reservoir interface and article interface are respectively coupled to the cam plate by pins and linkages.

13 The refilling device of clause 12, wherein the cam plate and the pins are configured such that the cam plate can move whilst the reservoir interface and article interface are both stationary.

14. The refilling device of clause 12 or clause 13, wherein the cam plate and the pins and linkages are configured such that the cam plate can move whilst the reservoir interface and article interface are both stationary.

15. The refilling device of any one of clauses 1 to 11, wherein the plunger is integrated with the reservoir interface.

16. The refilling device of any one of clauses 1 to 15, further comprising refilling control circuitry configured to control the motor.

17 The refilling device of clause 16, wherein the refilling control circuitry is configured to control the motor in response to detecting the article has been received by the article interface and detecting the reservoir has been received by the reservoir interface.

18. The refilling device of clause 16 or clause 17, wherein the refilling control circuitry is configured to alter a speed of the motor based on the position of the plunger.

19. A method of refilling an article of an aerosol provision device comprising:
receiving the article;
receiving a reservoir;
controlling a motor configured to drive a cam mechanism to move the article, the reservoir and a plunger in a coordinated manner such that aerosol-generating material is transferred from the reservoir to the article.

20. A computer readable storage medium comprising instructions which, when executed by a processor, performs a method of refilling an article of an aerosol provision system comprising:
receiving the article;
receiving a reservoir;
controlling a motor configured to drive a cam mechanism to move the article, the reservoir and a plunger in a coordinated manner such that aerosol-generating material is transferred from the reservoir to the article.

21. A refilling device for refilling an article of an aerosol provision system, comprising:
an article interface configured to receive the article;
a reservoir interface configured to receive the reservoir;
a nozzle block located between the article interface and the reservoir interface, comprising:
   a filling nozzle configured to facilitate the transfer of aerosol-generating material from the reservoir to the article, and
   a venting nozzle configured to facilitate the transfer of air from the article as aerosol-generating material is transferred from the reservoir to the article;
   wherein the nozzle block is configured such that, in use, the filling nozzle engages with the article in response to the reservoir engaging with the nozzle block.

22. The refilling device of clause 21, wherein the nozzle block is configured to be removable from the refilling device.

23. The refilling device of clause 22, wherein the refilling device further comprises a nozzle block interface configured to receive the nozzle block.

24 The refilling device of any one of clauses 21 to 23, wherein to facilitate the transfer of aerosol-generating material from the reservoir to the article, the filling nozzle is configured to engage with a filling valve on the article.

25. The refilling device of clause 24, wherein the filling nozzle is configured to engage with the filling by:
pushing into the filling valve; and
piecing the filling valve.

26. The refilling device of any one of clauses 21 to 25, wherein a first end of the filling nozzle is configured to engage with the article, and a second end of the filling nozzle opposite the first end is configured to engage with the reservoir.

27. The refilling device of any one of clauses 21 to 26, wherein the venting nozzle is configured to engage with the article in response to the reservoir engaging with the nozzle block.

28. The refilling device of clause 27, wherein the venting nozzle is configured to engage with a venting valve on the article.

29. The refilling device of any one of clauses 21 to 28, wherein a first end of the venting nozzle is configured to engage with the article, and a second end of the venting nozzle opposite the first end is open.

30. The refilling device of any one of clauses 21 to 29, wherein the nozzle block further comprises a housing configured to at least partially contain the filling nozzle and the venting nozzle.

31. The refilling device of clause 30, wherein the housing comprises a flange configured to extend beyond a first end of the filling nozzle and a first end of the venting nozzle such that first end of the filling nozzle and the first end of the venting nozzle are located inside the housing.

32. The refilling device of clause 31, wherein the housing comprises a second flange configured to extend beyond a second end of the filling nozzle and a second end of the venting nozzle such that second end of the filling nozzle and the second end of the venting nozzle are located inside the housing.

33. The refilling device of any one of clauses 30 to 32, wherein the nozzle block further comprises a moveable component configured to interact with the housing to expose at least a portion of the filling nozzle and at least a portion of the venting nozzle.

34. The refilling device of clause 33, wherein the nozzle block further comprises a biasing element configured to bias the movable component such that the portion of the filling nozzle and the portion of the venting nozzle are enclosed by the moveable component.

35. The refilling device of clause 33 or clause 34, wherein the nozzle block comprises an interlock configured to prevent the moveable component being moved when the nozzle block is separate from the refilling device.

36. The refilling device of clause 35, further comprising a pin configured to engage with interlock to allow the moveable component to move.

37. The refilling device of any one of clauses 21 to 36, wherein the venting nozzle is configured to engage with the article before the filling nozzle engages with the article.

38. The refilling device of any one of clauses 21 to 37, wherein the filling nozzle has a larger cross-sectional area than the venting nozzle.

39 The refilling device of any one of clauses 21 to 38, wherein the filling nozzle is longer than the venting nozzle.

40 The refilling device of any one of clauses 21 to 39, wherein the filling nozzle and the venting nozzle are concentric.

41. A method of refilling an article of an aerosol provision device comprising:
receiving the article;
receiving a reservoir;
engaging a filling nozzle of a nozzle block with the article in response to the reservoir engaging with the nozzle block;
facilitating the transfer of aerosol-generating material from the reservoir to the article using the filling nozzle; and
facilitating the transfer of air from the article using a venting nozzle of the nozzle block as aerosol-generating material is transferred from the reservoir to the article.

42. A computer readable storage medium comprising instructions which, when executed by a processor, performs a method of refilling an article of an aerosol provision system comprising:
receiving the article;
receiving a reservoir;
engaging a filling nozzle of a nozzle block with the article in response to the reservoir engaging with the nozzle block;
facilitating the transfer of aerosol-generating material from the reservoir to the article using the filling nozzle; and
facilitating the transfer of air from the article using a venting nozzle of the nozzle block as aerosol-generating material is transferred from the reservoir to the article.

43. A refilling device for refilling an article from a reservoir, the refilling device configured to perform a refilling action for moving fluid along a fluid conduit from the reservoir to a storage area in the article, and comprising:
an article interface for receiving an article of an aerosol provision system for coupling with the fluid conduit, the article having a storage area for fluid; and
a retainer configured to engage with an article received in the article interface to retain the article in the article interface during at least part of the refilling action.

44. A refilling device according to clause 43, wherein the part of the refilling action comprises decoupling of the article from the fluid conduit.

45. A refilling device according to clause 43 or clause 44, wherein the article interface comprises an opening through which the article is inserted to be received in the article interface

46. A refilling device according to clause 45, wherein the retainer comprises a wall of the article interface, the wall having an aperture through which the article is engaged with the fluid conduit, and the aperture being separate from the opening.

47. A refilling device according to clause 46, wherein the article interface receives the article by a first end of the article being inserted through the aperture and into the article interface along an insertion direction, and the aperture is located for coupling of the article with the fluid conduit along a direction non-parallel to the insertion direction.

48. A refilling device according to clause 45, wherein the retainer, when engaged with the article received in the article interface, extends over the opening to prevent removal of the article from the article interface through the opening.

49. A refilling device according to clause 48, wherein the article interface receives the article by a first end of the article being inserted into the article interface, and the retainer engages over a second end of the article opposite to the first end.

50. A refilling device according to clause 48, wherein the first end of the article is a mouthpiece end and the second end of the article is a refilling end comprising an inlet orifice for coupling to the fluid conduit to enable the refilling action.

51. A refilling device according to any one of clauses 48 to 50, wherein the article interface is moveable between a first position in which the article can be inserted into or removed from the article interface, and a second position in which the article is located for engagement with the fluid conduit, and wherein movement from the first position to the second position brings the article into engagement with the retainer.

52. A refilling device according to clause 51, wherein movement of the article interface from the second position to the first position disengages the article from the retainer.

53. A refilling device according to clause 51 or clause 52, wherein the article interface is configured to pivot between the first position and the second position.

54. A refilling device according to clause 51 or clause 52, wherein the article interface is configured to slide between the first position and the second position.

55. A refilling device according to any one of clauses 48 to 54, wherein the retainer comprises a one or more arms that engage with the article by extending at least partially across the article when the article is received in the article interface and located for coupling with the fluid conduit.

56. A refilling device according to clause 55, wherein the one or more arms are resiliently flexible to allow a biased displacement away from an engage position in which the arms engage the article while the article is being engaged with the arms, the biasing acting to restore the one or more arms to or towards the engage position when the article is engaged with the arms.

57. A refilling device according to clause 56, wherein the one or more arms are formed so as to be inherently resiliently flexible by virtue of the material and/or shape of the one or more arms.

58. A refilling device according to clause 56, wherein the one or more arms have a sprung mounting that provides resilient flexibility.

59. A refilling device according to any one of clauses 48 to 58, wherein the article interface is held on a moveable mount operable to move the article interface when an article has been received in the article interface so as to couple the article with the fluid conduit.

60. A refilling device according to clause 59, wherein the retainer is held on the moveable mount for movement with the article interface.

61. A refilling device according to any one of clauses 43 to 60, wherein the refilling device is configured to cause relative movement between the article interface and the fluid conduit when an article has been received in the article interface in order to couple the article to the fluid conduit for enabling the refilling action, and decouple the article from the fluid flow path after fluid has been moved to the storage area.

62. A refilling device according to clause 61, wherein the retainer is configured to the retain the article in the article interface by exerting a force on the article along a direction opposite to a direction of the relative movement during decoupling of the article and the fluid conduit, the force sufficient to overcome friction between the article and the fluid conduit and achieve the decoupling.

63. A refilling device according to any one of clauses 43 to 62, wherein the article interface is shaped such that a longitudinal axis of an article received in the article interface is substantially horizontal.

64. A refilling device according to any one of clauses 43 to 62, wherein the article interface is shaped such that a longitudinal axis of an article received in the article interface is substantially vertical.

65. A refilling device according to any one of clauses 43 to 64, wherein the article interface comprises a sensor for measuring or detecting a characteristic of an article received in the article interface, and the retainer is configured to retain the article in the article interface in an appropriate location for operation of the sensor.

66. A refilling device according to clause 65, wherein the sensor is a capacitive sensor, and the retainer pushes the article against one or more capacitor plates of the capacitive sensor.

67. A refilling device according to clause 65 or clause 66, wherein the characteristic of the article is the presence of the article in the article interface and/or an amount of fluid in the storage area of the article.

68. A refilling device for refilling an article from a reservoir, comprising:
an article interface for receiving an article of an aerosol provision system, the article having a storage area for fluid; and
a capacitive sensor configured to measure a capacitance of at least part of the article when the article is received in the article interface;
wherein the capacitive sensor comprises at least one capacitor plate comprising an elastically compressible element and a flexible conductive layer on a surface of the elastically compressible element.

69. A refilling device according to clause 68, where in the capacitive sensor is configured to measure a capacitance of the storage area of the article.

70. A refilling device according to clause 68 or clause 69, wherein the capacitive sensor is positioned within the article interface such that when the article is received in the article interface, the article compresses the capacitor plate allowing the flexible conductive layer to contact an outer surface of the article and conform to a shape of the outer surface of the article.

71. A refilling device according to any one of clauses 68 to 70, wherein the elastically compressible element comprises a pad of natural or synthetic sponge or foam material.

72. A refilling device according to any one of clauses 68 to 70, wherein the elastically compressible element comprises a pad of natural or synthetic rubber.

73. A refilling device according to any one of clauses 68 to 72, wherein the surface of the elastically compressible element having the flexible conductive layer is shaped to correspond with a shape of an outer surface of the article.

74. A refilling device according to any one of clauses 68 to 73, wherein the flexible conductive layer comprises a mesh of metallic material.

75. A refilling device according to any one of clauses 68 to 73, wherein the flexible conductive layer comprises a foil or film of metallic material.

76. A refilling device according to clause 74 or clause 75, wherein the metallic material is copper or stainless steel.

77. A refilling device according to any one of clauses 68 to 76, wherein the capacitive sensor comprises a pair of capacitor plates arranged in the article interface such that at least part of the storage area is disposed between the pair of capacitor plates when the article is received in the article interface.

78. A refilling device according to any one of clauses 69 to 76, wherein the capacitive sensor comprises a single capacitor plate and is configured to utilize a conductive element in the article as a second capacitor plate.

79. A refilling device according to any one of clauses 68 to 76, in which the capacitive sensor is configured to measure capacitance from one side of the article only, and arranged in the article interface so as to be disposed at one side of the storage area only when the article is received in the article interface.

80. A refilling device according to clause 79, further comprising a second capacitive sensor arranged in the article interface to as to be disposed at an opposite side of the storage area when the article is received in the article interface.

81. A refilling device according to any one of clauses 68 to 80, further comprising a controller configured to obtain one or more capacitance measurements from the capacitive sensor when the article is received in the article interface.

82. A refilling device according to clause 81, wherein the controller is further configured to control a refilling action of the refilling device in which fluid is moved along a fluid flow path from a reservoir received in a reservoir interface in the refilling device to the storage area of the article received in the article interface, and utilize the one or more capacitance measurements to control the refilling action.

83. A refilling device according to clause 82, wherein the controller is configured to determine a presence of the article in the article interface from the one or more capacitance measurements, and initiate the refilling action in response to determining the presence of the article in the article interface.

84. A refilling device according to clause 82 or clause 83, wherein the controller is configured to determine an amount level of fluid in the storage area from the one or more capacitance measurements and control the refilling action to move fluid into the storage area until a required amount of fluid is present in the storage area.

85. A refilling device for refilling an article from a reservoir, comprising:
an article interface for receiving an article of an aerosol provision system, the article having a storage area for fluid; and
a capacitive sensor configured to measure a capacitance of at least part of the article when the article is received in the article interface;
wherein the capacitive sensor comprises at least one deformable capacitor plate associated with the article interface in order that the deformable capacitor plate is deformed by the article when received in the article interface such that the deformable capacitor plate conforms to a shape of the outer surface of the article.

1. A refilling device for refilling an article from a reservoir, comprising:
an article interface configured to receive the article;
a reservoir interface configured to receive the reservoir;
a plunger configured, in use, to engage with the reservoir; and
a motor configured to drive a cam mechanism coupled to each of the article interface, the reservoir interface and the plunger such that, in use, the article, the reservoir and the plunger move in a coordinated manner such that aerosol-generating material is transferred from the reservoir to the article.

2. The refilling device of claim 1, further comprising a nozzle block between the article interface and the reservoir interface.

3. The refilling device of claim 2, wherein the coordinated manner comprises:
(1) the article interface moving towards the nozzle block;
(2) the reservoir interface moving towards the nozzle block; and
(3) the plunger engaging and pushing on a surface of the reservoir.

4. The refilling device of claim 3, wherein the step (1) happens before step (2) and step (2) happens before step (3).

5. The refilling device of claim 2, wherein the nozzle block is integrated with one of the article interface or the reservoir interface.

6. The refilling device of claim 2, wherein the nozzle block comprises a syringe configured to facilitate the transfer of aerosol-generating material from the reservoir to the article via the nozzle block.

7. The refilling device 6, wherein the cam mechanism is configured to move the plunger in a reciprocating motion comprising a first direction and a second direction opposite the first direction, wherein the plunger moves in the first direction towards the nozzle block to cause aerosol-generating material to be transferred from the reservoir to the syringe, and the plunger moves in the second direction away from the nozzle block to cause aerosol-generating material to be transferred from the syringe to the article.

8. The refilling device of claim 6, wherein the nozzle block further comprises a three-way check value to control the transfer of aerosol-generating material into and out of the syringe.

9. The refilling device of claim 1, wherein the cam mechanism comprises a cam plate.

10. The refilling device of claim 8, wherein the motor is connected to the cam plate by a lead screw.

11. The refilling device of claim 9, wherein the plunger is fixed to the cam plate such at that the plunger moves with the cam plate.

12. The refilling device of claim 9, wherein the reservoir interface and article interface are respectively coupled to the cam plate by pins and linkages.

13. The refilling device of claim 12, wherein the cam plate and the pins are configured such that the cam plate can move whilst the reservoir interface and article interface are both stationary.

14. The refilling device of claim 12, wherein the cam plate and the pins and linkages are configured such that the cam plate can move whilst the reservoir interface and article interface are both stationary.

15. The refilling device of claim 1, wherein the plunger is integrated with the reservoir interface.

16. The refilling device of claim 1, further comprising refilling control circuitry configured to control the motor.

17. The refilling device of claim 16, wherein the refilling control circuitry is configured to control the motor in response to detecting the article has been received by the article interface and detecting the reservoir has been received by the reservoir interface.

18. The refilling device of claim 16, wherein the refilling control circuitry is configured to alter a speed of the motor based on the position of the plunger.

19. A method of refilling an article of an aerosol provision device comprising:
receiving the article;
receiving a reservoir;
controlling a motor configured to drive a cam mechanism to move the article, the reservoir and a plunger in a coordinated manner such that aerosol-generating material is transferred from the reservoir to the article.

20. A computer readable storage medium comprising instructions which, when executed by a processor, performs a method of refilling an article of an aerosol provision system comprising:
receiving the article;
receiving a reservoir;
controlling a motor configured to drive a cam mechanism to move the article, the reservoir and a plunger in a coordinated manner such that aerosol-generating material is transferred from the reservoir to the article.

21-85. (canceled)
